(19) United States
(12) Patent Application Publication
(10) Pub. No.: US 2008/0134727 A1
(43) Pub. Date: Jun. 12, 2008

(54) Position Sensor and Washing Machine

(76) Inventor: Lutz May, Gelting/Geretsried (DE)

Correspondence Address: FAY KAPLUN & MARCIN, LLP, 150 BROADWAY, SUITE 702, NEW YORK, NY, 10038, US

(21) Appl. No.: 11/814,106

(22) PCT Filed: Feb. 1, 2006
(86) PCT No.: PCT/EP06/00894

§ 371 Date: Nov. 29, 2007

Related U.S. Application Data
(60) Provisional application No. 60/648,953, filed on Feb. 1, 2005.

(30) Foreign Application Priority Data
Feb. 1, 2005 (EP) 05002034.6

(51) Int. Cl. G01D 5/12; H01F 41/02; G01B 7/00; D06F 33/00; D06F 33/02

(52) U.S. Cl. 68/12.02; 324/207.11; 29/607; 324/207.13; 68/12.27

(57) ABSTRACT

Described is a position sensor device for determining a position of a movable object. The position sensor device includes (a) a magnetic field source fixed on a movable object, (b) a first magnetic field detector located at a first position and detecting a first magnetic field signal characteristic for a magnetic field generated by the magnetic field source at the first position, (c) a second magnetic field detector located at a second position and detecting a second magnetic field signal characteristic for a magnetic field generated by the magnetic field source at the second position, and (d) a position determining unit determining a position of the magnetic field source based on a comparison of the first magnetic field signal and the second magnetic field signal.

### FIELD OF THE INVENTION

The present invention relates to sensors. In particular, the invention relates to a position sensor device for determining a position of a movable object, to a position sensor array, to a washing machine, to a method for determining a position of a movable object, and to a sensor arrangement.

### DESCRIPTION OF THE RELATED ART

For many applications, it is desirable to accurately measure the position of a moving object. For instance, it is advantageous to know the position of a reciprocating, rotating or linearly moving object to accurately control the reciprocation, rotation or linear motion in an efficient manner.

According to the prior art, an optical marker can be provided on a movable object, and an optical measurement can be performed to estimate the position of the optical marker and thus a position of the movable object. However, under critical circumstances, the optical marker may be covered by material and may become “invisible” for an optical detecting means.

Further, an optical marker can be abrased by friction between a moving or rotating object and physical or chemical particles in the environment of the object.

Alternatively, a mechanical marker, such as an engraving, can be used as a marker to detect the position or velocity of a moving, rotating or reciprocating object. However, such an engraving structure may be filled or covered with material and is thus not appropriate to be implemented under critical conditions. A mechanical marker (engravings) may also present a challenge to maintain sealing.

When linear position sensors are needed, in most cases the industry is using one-dimensional measuring sensing devices (sensitive to changes along one axis, e.g. an X-axis). To determine the accurate position in two-dimensional directions (sensitive to changes along two axis, e.g. an X-axis and an Y-axis), two independent operating, one-dimensional measuring devices are used. Cost and required space literately double in such case. The same is true for a three-dimensional (sensitive to changes along three axis, e.g. an X-axis, a Y-axis and a Z-axis) measuring sensing device.

Washing machines are particularly available in two main configurations: “top loading” and “front loading”. The “top loading” design places the clothes in a vertically-mounted cylinder, with a propeller-like agitator in the center of the bottom of the cylinder. Clothes are loaded at the top of the machine, which may be covered with a hinged door. The “front loading” design instead mounts the cylinder horizontally, with loading through a glass door at the front of the machine. The cylinder is also called the drum. Agitation is supplied by the back-and-forth rotation of the cylinder, and by gravity. The items of laundry are lifted up by paddles in the drum then drop down to the bottom of the drum. This motion forces water and detergent solution through the fabric. There is also a variant of the horizontal axis design that is loaded from the top, through a flap in the circumference of the drum. These machines usually have a shorter cylinder and are therefore smaller.

It is a shortcoming of washing machines and other devices having a movable object that there is a lack of an accurate and cheap means of determining the position of such a movable object, which is needed to control or regulate such a washing machine and other device.

### SUMMARY OF THE INVENTION

It is an object of the present invention to provide an accurate and cheap possibility of determining the position of a movable object.

This object is achieved by providing a position sensor device for determining a position of a movable object, a position sensor array, a washing machine, and a method for determining a position of a movable object and a sensor arrangement according to the independent claims.

According to an exemplary embodiment of the invention, a position sensor device for determining a position of a movable object is provided, wherein the position sensor device comprises a magnetic field source adapted to be fixed on a movable object, a first magnetic field detector located at a first position and adapted to detect a first magnetic field signal characteristic for a magnetic field generated by the magnetic field source at the first position, a second magnetic field detector located at a second position and adapted to detect a second magnetic field signal characteristic for a magnetic field generated by the magnetic field source at the second position, and a position determining unit adapted to determine a position of the magnetic field source based on a comparison of the first magnetic field signal and the second magnetic field signal.

According to another exemplary embodiment of the invention, a position sensor array is provided, comprising a position sensor device having the above mentioned features, and a movable object on which the magnetic field source of the position sensor device is fixed, wherein the position sensor device is adapted to determine the position of the movable object.

According to still another exemplary embodiment of the invention, a washing machine is provided, comprising a static support, a rotatable drum adapted to rotate with respect to the static support and adapted to receive content to be washed, a position sensor device for determining a position of the rotatable drum, wherein the position sensor device comprises a magnetic field source, a magnetic field detector adapted to detect a magnetic field signal characteristic for a magnetic field generated by the magnetic field source, a position determining unit adapted to determine a position of the rotatable drum based on the magnetic field signal, wherein one of the magnetic field source and the magnetic field detector is fixed on the static support and the other one of the magnetic field source and the magnetic field detector is fixed on the rotatable drum.

According to still another exemplary embodiment of the invention, a washing machine is provided, comprising a static support, a rotatable drum adapted to rotate with respect to the static support and adapted to receive content to be washed, and a position sensor device for determining a position of the rotatable drum, wherein the position sensor device comprises a magnetic field source for generating a magnetic field, a magnetic field sink, a magnetic field detector adapted to detect a magnetic field signal characteristic for a magnetic field generated by the magnetic field source and modified by the magnetic field sink, and a position determining unit adapted to determine a position of the rotatable drum based on the magnetic field signal, wherein one of the magnetic field sink and the magnetic field detector is fixed on the static support and the other one of the magnetic field sink and the magnetic field detector is fixed on the rotatable drum.

According to yet another exemplary embodiment of the invention, a method for determining a position of a movable object is provided, wherein the method comprises the steps of detecting a first magnetic field signal characteristic for a magnetic field at a first position generated by a magnetic field source to be fixed on the movable object, detecting a second magnetic field signal characteristic for a magnetic field at a second position generated by the magnetic field source, determining a position of the magnetic field source based on a comparison of the first magnetic field signal and the second magnetic field signal.

According to still another exemplary embodiment of the invention, a sensor arrangement is provided, comprising a substrate and a plurality of position sensor devices having the above mentioned features arranged on the substrate.

In the following, the above mentioned independent aspects of the invention will be described in more detail.

One idea of the invention can be seen in the fact that a position sensor device is provided in which a comparison of at least two different magnetic field signals detected by different magnetic field detectors and originating from a magnetic field source attached to a movable object is performed to estimate a position of the magnetic field source attached to the movable object. Thus, a ratio or difference between two magnetic field signals is used as a basis for estimating at which position a movable object is presently located. In other words, the functionality of the magnetic field detectors arranged at different locations with respect to the magnetic field source is used as a source of information for determining the position at which the magnetic field source fixed on the movable or moving object is presently located.

This principle allows to construct a one-dimensional, two-dimensional or even three-dimensional position sensor, that is to say a position sensor capable of detecting a position of the movable object in one, two or three dimensions. The position sensor according to the invention can determine accurately the position of an object in a three-dimensional space, is working in a non-contact manner, and is specifically appropriate for low cost applications.

When implementing such a sensor (or a sensor of a similar type having one or more magnetic field detectors) in a washing machine to detect the accurate position of the drum filled with laundry, the measurement according to the invention provides correct information about the loading state of the washing machine, since the gravitational force of the laundry forces the drum to slightly change its position which change can be detected magnetically. This information about the drum adapted to receive content to be washed allows to determine how many kg, that is which weight, of laundry has been placed into the drum, and allows to determine if the wet drum load is placed non-symmetrically inside of the drum which could result in a “hopping” washing machine during the dry spin process. Thus, the one-, two- or three-dimensional position sensor can also provide the functions of an accelerometer, a weight sensor, and of course of a position sensor, that will result in considerable cost savings and an improved functionality of a device comprising such a position sensor device.

While working on electromagnetic principles, the system according to the invention is advantageously insensitive to any type of magnetic interferences as they might occur and placed near an electric powered motor or electric powered solenoids.

According to the invention, it is possible to carry out a non-contact measuring, therefore a very little wear out and low costs can be achieved. The system according to the invention can be used in harsh environments, and the invention is insensitive to temperature changes and component tolerances. The entire position sensor, for instance realized as a three-dimensional linear position sensor, can be manufactured with low costs, for instance for less than 2C=.

Exemplary applications of the position sensor device or the position sensor array according to the invention are washing machines, tumble dryers, automotive engine vibration systems, automotive suspension position systems (that is systems for measuring car tilting when driving across curves or over rough terrain), car-head light adjustment in relation to car loading, or for non-contact proportional controls for tools or industrial systems (for instance replacing contact base switches and electrical potentiometers with this non-contact sensor).

The sensor arrangement has a plurality of position sensor devices with the above-mentioned features arranged on a substrate. In other words, many (for instance about 140) position sensors or bending sensors can be arranged on a surface of a substrate, e.g. in a matrix-like manner. Thus, a two-dimensional array of sensors is provided allowing to detect a pressure and/or bending force distribution over an area of interest in a spatial resolving manner. Such an array can be used for a combined measurement of pressure and bending. Exemplary applications of such a sensor arrangement is a crash test for testing automobiles or a footprint weight test. In other words, the effect of magnetostriction can be used to realize a two-dimensional array of sensors (load cell) allowing to investigate fields of forces.

Detecting a position of a movable object means, in the context of a bending sensor, that the position of a bended object can be measured which directly corresponds to a bending force applied to the bending sensor.

In the following, exemplary aspects concerning the position sensor device for determining a position of a movable object according to the first independent aspect of the invention will be described. However, these embodiments also apply for the position sensor array, for the washing machine, for the method for determining a position of a movable object, and for the sensor arrangement according to the other independent aspects of the invention.

The magnetic field source of the position sensor device may be a permanent magnetic element or region. The term “permanent magnetic” refers to a magnetized material which has a remaining magnetization also in the absence of an external magnetic field. Thus, “permanent magnetic materials” include ferromagnetic materials, ferrimagnetic materials, or the like. The material of such a magnetic region may be a 3d-ferromagnetic material like iron, nickel or cobalt, or may be a rare earth material (4f-magnetism).

Alternatively, the magnetic field source may be a coil which is activatable by applying an electrical signal to the coil. In the environment of a coil through which an electric current is flowing, a magnetic field is generated which can be used as the detection signal for the first and second magnetic field detectors. Since the spatial dependence of the strength of a such a magnetic field generated by a coil is known or can be measured easily, the strength of the magnetic field at the position of the first and second magnetic field detectors is a measure for the position of the magnetic field source fixed on the movable object.

Particularly, the coil may be activatable by applying a continuous electrical signal to the coil. For instance, a direct current can be applied to the coil generating a static magnetic field which is constant over time. Thus, the signal detected by the magnetic field detectors allows to calculate back the distance of the magnetic field detectors from the magnetic field source, thus allowing to calculate the position of the movable object.

Alternatively, the coil may be activatable by applying an alternating (for instance oscillating) or pulsed electrical signal to the coil. Using a defined time dependence of the magnetizing signal generating a magnetic field of the coil allows that the magnetic field detectors may distinguish between disturbing background magnetic signals (for instance the earth magnetic field) and magnetic signals relating to the magnetic field source and encoding position information from which the current position of the movable object fixed to the magnetic field source can be calculated. For instance, an alternating current applied to the coil or a pulsed signal applied to the coil allows to eliminate disturbing offset signals from the environment, thus improving the accuracy.

The magnetic field source may be a longitudinally magnetized region of the movable object. Thus, the magnetizing direction of the magnetically encoded region or the magnetic field source may be oriented along the motion direction of the movable object. A method of manufacturing such a longitudinally magnetized region on a magnetizable material from which the moving object should be manufactured according to the described embodiment, is disclosed, in a different context, in WO 2002/063262 A1.

Alternatively, the magnetic field source may be a circumferentially magnetized region of the movable object. Such a circumferentially magnetized region may particularly be adapted such that the magnetic field source (which may also be denoted as a magnetically encoded region) is formed by a first magnetic flow region oriented in a first direction and by a second magnetic flow region oriented in a second direction, wherein the first direction is opposite to the second direction.

In a cross-sectional view of the movable object, there may be a first circular magnetic flow having the first direction and a first radius and the second circular magnetic flow having the second direction and a second radius, wherein the first radius is larger than the second radius. Particularly, the magnetic field source may be manufactured in accordance with the manufacturing steps of applying a first current pulse to a magnetizable object, wherein the first current pulse is applied such that there is a first current flow in a first direction along a longitudinal axis of the magnetizable element, and wherein the first current pulse is such that the application of the current pulse generates the magnetic field source in or of the magnetizable element. Moreover, a second current pulse may be applied to the magnetizable element, wherein the second current pulse may be applied such that there is a second current flow in a second direction along the longitudinal axis of the magnetizable element.

Furthermore, the first and second current pulses may have a raising edge and a falling edge, wherein the raising edge is steeper than the falling edge (see for instance FIG. 35).

The first direction may be opposite to the second direction.

According to another embodiment of the invention, the position sensor device may be configured such that at least one of the first magnetic field detector and the second magnetic field detector comprises at least one of the group consisting of a coil, a Hall-effect probe, a Giant Magnetic Resonance magnetic field sensor and a Magnetic Resonance magnetic field sensor. The coil axis of any of the magnetic field detectors may have any desired or appropriate direction with respect to the movable or moving object and with respect to the magnetic field source, and also depending on the direction and the strength of the magnetic field generated by the magnetic field source. As an alternative to a coil in which the moving magnetic field source may induce an induction voltage by modulating the magnetic flow through the coil, a Hall-effect probe may be used as a magnetic field detector making use of the Hall effect. Alternatively, a Giant Magnetic Resonance magnetic field sensor or a Magnetic Resonance magnetic field sensor may be used as a magnetic field detector. However, any other magnetic field detector may be used to detect the distance to the magnetic field generator.

The position determining unit may be adapted to determine a position of the magnetic field source based on a ratio of the first magnetic field signal and the second magnetic field signal. In other words, the position determining unit does not process the individual signals independently, but may combine the pieces of information, so that spatial and signal amplitude information can be combined in a complementary manner. Particularly, not only the absolute values of the detection signals are used for calculating a position of the movable object/the magnetic field source. Instead of this, a ratio between the signals may be used so that the system is less prone to disturbing background offset effects, thus providing an improved accuracy.

Additionally or alternatively to an embodiment in which a ratio between the two magnetic field signals is used, the position determining unit may be adapted to determine a position of the magnetic field source based on a difference of the first magnetic field signal and the second magnetic field signal. Also according to this embodiment, the accuracy can be increased by eliminating background effects.

The magnetic field source may be arranged essentially symmetrically between the first magnetic field detector and the second magnetic field detector. According to this embodiment, it is particularly possible that the two magnetic field detectors and the magnetic field source are arranged along a linear line, wherein the magnetic field source is sandwiched between the two magnetic field detectors. In case that the magnetic field source moves along the line, the signal of one of the magnetic field detectors increases, and the other signal decreases, so that comparing the signals allows to determine the position of the magnetic field source, thus allows to calculate the position of the movable object.

According to another embodiment, the position sensor device may comprise a third magnetic field detector located at a third position and adapted to detect a third magnetic field signal characteristic for a magnetic field generated by the magnetic field source at the third position. According to this embodiment, the position determining unit may be adapted to determine the position of the magnetic field source based on the first magnetic field signal, the second magnetic field signal and the third magnetic field signal. By providing a further magnetic field detector, the calculation of the position of the movable object can be refined, particularly a triangulation method can be applied to derive the position from the three signals. Thus, partially redundant information can be obtained which increases the accuracy. Further, particularly by providing the three magnetic field detectors in a non-planar manner, it is possible to carry out a three-dimensional position determination.

The magnetic field source may be arranged essentially symmetrically and essentially in the center of gravity of the first magnetic field detector, the second magnetic field detector and the third magnetic field detector. According to this arrangement, even a slight motion of the magnetic field source out of the center of gravity is detectable by the three magnetic field detectors, because the amplitude of each of the magnetic field detectors is significantly and characteristically increased or decreased allowing to recalculate the position of the magnetic field source.

Particularly, the first magnetic field detector, the second magnetic field detector and the third magnetic field detector may be arranged in a plane which is common to a plane in which the magnetic field source is located. For instance, the first magnetic field detector, the second magnetic field detector and the third magnetic field detector may be arranged on the corners of a triangle, particularly of an equilateral triangle. According to this embodiment, any motion of the magnetic field source away from the center of gravity of the equilateral triangle can be detected with high sensitivity.

The position sensor device may further comprise a forth magnetic field detector located at a forth position and adapted to detect a forth magnetic field signal characteristic for a magnetic field generated by the magnetic field source at the forth position. The position determining unit may be adapted to determine the position of the magnetic field source based on the first magnetic field signal, the second magnetic field signal, the third magnetic field signal and the forth magnetic field signal. Implementing four magnetic field detectors allows a further refinement of the detection scheme.

Particularly, the magnetic field source may be arranged essentially symmetrically and essentially in the center of gravity of the first magnetic field detector, the second magnetic field detector, the third magnetic field detector and the forth magnetic field detector. For instance, the first magnetic field detector, the second magnetic field detector, the third magnetic field detector and the forth magnetic field detector may be arranged in a common plane, that is in a co-planar manner. Also the magnetic field source may be positioned in this plane, when it is in an equilibrium state.

For instance, the four magnetic field detectors may be arranged on the edges of a rectangle, more particularly on the edges of a square. This allows an accurate two-dimensional or three-dimensional measurement of the position of the magnetic field source.

The magnetic field detectors may be arranged in a non-planar manner, for instance on the edges of a tetrahedron, of a pentahedron, of a cube, etc. For instance, when the magnetic field source is located—in an equilibrium state—in the center of an tetrahedron, any motion of the magnetic field source away from the center of gravity can be detected by the four magnetic field detectors.

The position determining unit may be adapted to determine the position of the magnetic field source based on a difference of the magnetic field signals and based on an amplitude of the magnetic field signals. According to this embodiment, it is for instance possible to arrange a magnetic field source in an equilibrium state in the center of gravity of a triangle, wherein the magnetic field detectors are arranged on the corners of the triangle. By comparing the signals, that is by comparing the difference or the ratio between the signals, of the magnetic field detectors, the position of the magnetic field source in the plane of the triangles can be estimated. When the magnetic field source moves outside the plane of the triangle, then the signal amplitude of each of the magnetic field detectors decreases, allowing to recalculate the position of the magnetic field source in a direction perpendicular to the plane of the triangle. This concept can be applied also to other configurations of magnetic field detectors, arranged in a planar or non-planar manner.

Alternatively, the position determining unit may be adapted to determine the position of the magnetic field source only based on a difference of the magnetic field signals. Particularly when the magnetic field detectors or sensors are arranged in a three-dimensional manner, then it is possible to calculate the current position of the magnetic field source only by comparing different magnetic field signals, without using absolute values.

The position sensor device may further comprise a signal linearization unit adapted to generate a linear signal being characteristic for the position of the movable object based on a difference between the first magnetic field signal and the second magnetic field signal. For instance, by means of a comparator or by an operational amplifier, the difference between two signals may be calculated, and by providing this different signal to the signal linearization unit, a linear signal with respect to the position of the movable object may be calculated.

The position sensor device may further comprise a driver unit adapted to provide the magnetic field source with a driver signal for generating a magnetic field in accordance with the driver signal and being adapted to process (e.g. to filter) the first magnetic field signal and the second magnetic field signal in accordance with the driver signal. By using such a driver unit, the functionality of the magnetic field source and the magnetic field detectors can be synchronized. For instance, knowing which activation signal scheme is applied to the magnetic field source, this activation scheme can be used during processing the detection signals of the magnetic field detectors to clearly and reliably evaluate the signals.

The driver unit may be a microprocessor (CPU), in which the steps of operating the driver unit may be programmed by means of software components. The system according to the invention can be realized or controlled by a computer program, that is by software, or by using one or more special electronic optimization circuits, that is in hardware, or in hybrid form, that is by means of software components and hardware components.

The position sensor device may be implemented in at least one of the group consisting of a washing machine, a tumble dryer, an automotive engine vibration detecting unit, an automotive suspension position detecting unit, an automotive light adjustment device, and a bending and/or pressure measurement unit. These applications are only exemplary, and many other applications of the system according to the invention are possible.

In the following, exemplary embodiments of the washing machine will be described. However, these embodiments also hold for the position sensor device, the position sensor array, the method for determining a position of a movable object, and for the sensor arrangement according to the other independent aspects of the invention.

The washing machine may further comprise a control unit adapted to control an operation of the washing machine based on the position of the rotatable drum which is provided to the control unit by the position sensor device. In other words, the determined position information can be used to control or regulate the functionality of a washing machine. For instance, when laundry is filled in the washing machine, this may lower the drum of the washing machine due to the gravity force in response to the laundry, and this may change the distance between a magnetic field source attached to the drum and a magnetic field detector attached to a static support of the washing machine, or vice versa. Thus, position detection and weight detection can be combined.

Further, when the drum of the washing machine rotates, the position of the drum during this rotation can be measured and determined continuously, and any problems in the functionality of the washing machine (like undesired “hopping”) can be analyzed and eliminated.

The washing machine may comprise a processing means adapted to determine, based on the determined position of the rotatable drum, a loading weight of content to be washed received by the rotatable drum. In other words, the position detection can be analyzed to derive information concerning the loading state of the washing machine.

The magnetic field detector may comprise a plurality of spatially separated magnetic field detector units each adapted to detect the magnetic field signal characteristic for a magnetic field generated by the magnetic field source at a corresponding position of the respective magnetic field detector unit. By providing more than one magnetic field detector, it may be possible to obtain or calculate three-dimensional positional information of the magnetic field source, and even rotational information instead of pure translational information.

For instance, the magnetic field detector may comprise four magnetic field detector units arranged at corners of a rectangle. These four magnetic field detectors may be arranged on corners of a square. Four magnetic field detectors in such an arrangement may be able to detect, in addition to x and y and z coordinates of the magnetic field source, also tilting properties.

The magnetic field detector may comprise at least four, particularly nine, magnetic field detector units arranged in a common plane. Such a for instance matrix-like arrangement of magnetic field detectors may be preferably realized in combination with a permanent magnetic element as the magnetic field source.

However, the magnetic field detector may comprise at least one of the group consisting of a coil, a Hall effect probe, a Giant magnetic resonance magnetic field sensor and a magnetic resonance magnetic field sensor. However, other configurations of the magnetic field sensors are possible.

The magnetic field source may be a coil being activatable by applying an electrical signal to the coil. Such a signal may be a continuous electrical signal or may be an alternating or pulsed electrical signal.

However, when the magnetic field source is a permanent magnetic element, it is possible to realize the magnetic field source without cable connections and thus in a simple manner which may be installed easily.

In the following, exemplary embodiments of the washing machine comprising a magnetic field sink will be described. However, these embodiments also hold for the above-described washing machine, the position sensor device, the position sensor array, the method for determining a position of a movable object, and for the sensor arrangement according to the other independent aspects of the invention.

The term “magnetic field sink” may particularly denote any element, measure or feature which has the capability to at least partially eliminate a present magnetic field (or more generally a present electromagnetic field) by absorbing or weakening or modifying the magnetic field in a characteristic manner, as a consequence of the presence of the magnetic field sink in the vicinity of the magnetic field and/or of the magnetic field detector. Similar as in the case of an RFID tag, such a magnetic field sink (which may be an LC oscillator circuit or the like) may, when being brought in the vicinity of the magnetic field, absorb energy of the magnetic field so as to selectively weaken the magnetic field. This reduction of the magnetic field strength or, more generally, this modification of the magnetic field characteristics caused by the presence of the magnetic field sink may be detected by the magnetic field detector and may be used as a basis for determining position information of the magnetic field detector with respect to the magnetic field sink, or vice versa.

The magnetic field sink may be an LC oscillator circuit. Such an oscillator circuit may comprise a capacity, an inductivity, and may also include an ohmic resistance. By absorbing electromagnetic field contributions, particularly in special frequency intervals being sufficiently close to the resonance frequency of an LC oscillator circuit, the LC oscillator circuit being present in the environment of the magnetic field detectors may cause a characteristic signal distortion. For instance, such an LC oscillator circuit may be attached to a rotatable drum of the washing machine, and when the magnetic field sink attached to the rotatable drum of the washing machine passes a vicinity of the magnetic field detector, the magnetic field may be selectively modified by the presence of the magnetic field sink. This can be used as an information for determining the present position of the rotatable drum.

The magnetic field source may be a coil being activatable by applying an electric signal to the coil. Therefore, the magnetic field source may generate a static or time dependent magnetic field which may be selectively weakened by the presence of the magnetic field sink.

The coil may be activatable by applying an alternating electrical signal to the coil. Particularly, the magnetic field, or electromagnetic field, generated by the coil, may have a frequency which is adapted to be absorbable by the LC oscillator circuit.

However, the magnetic field source and the magnetic field generator may be formed as a common element. In other words, the magnetic field source may generate the magnetic field, for instance by an electric current flowing through the magnetic field source. If such a magnetic field source is realized as a coil, this coil may also be used as a magnetic field generator. In other words, the magnetic field detected by such a coil may be used as a detection signal. Such a configuration may allow to manufacture the washing machine and particularly the sensor portion thereof, with low effort.

The magnetic field source may comprise a plurality of magnetic field source units each adapted to generate an individual magnetic field. For instance, two or more magnetic field generating coils may be arranged so as to generate a magnetic field with a defined spatial dependence.

The magnetic field detector may comprise a plurality of magnetic field detector units each adapted to detect an individual magnetic field signal. By providing a plurality of magnetic field detectors, the accuracy of the position sensing may be further improved.

The position determining unit may be adapted to determine the position of the rotatable drum based on the individual magnetic field signals. Therefore, the evaluation circuit may be adapted to be capable of processing a plurality of magnetic field signals together. This may improve the accuracy and reliability of the calculated position.

In the following, exemplary embodiments of the sensor arrangement will be described. However, these embodiments also hold for the position sensor device, the position sensor array, the method for determining a position of a movable object, and for the washing machine according to the other independent aspects of the invention.

The sensor arrangement may be adapted to detect a spatial pattern of a pressure and/or bending load applied to the plurality of position sensor devices being arranged on the substrate. Thus, a spatial dependent pressure and/or bending force can be detected and can be spatially resolved.

Particularly, the sensor arrangement may be adapted as a crash test sensor arrangement.

The above and other aspects, objects, features and advantages of the present invention will become apparent from the following description and the appended claim, taken in conjunction with the accompanying drawings in which like parts or elements are denoted by like reference numbers.

### BRIEF DESCRIPTION OF THE DRAWINGS

The accompanying drawings, which are included to provide a further understanding of the invention and constitute a part of the specification illustrate embodiments of the invention.

In the drawings:

FIG. 1 shows a torque sensor with a sensor element according to an exemplary embodiment of the present invention for explaining a method of manufacturing a torque sensor according to an exemplary embodiment of the present invention.

FIG. 2a shows an exemplary embodiment of a sensor element of a torque sensor according to the present invention for further explaining a principle of the present invention and an aspect of an exemplary embodiment of a manufacturing method of the present invention.

FIG. 2b shows a cross-sectional view along AA′ of FIG. 2a.

FIG. 3a shows another exemplary embodiment of a sensor element of a torque sensor according to the present invention for further explaining a principle of the present invention and an exemplary embodiment of a method of manufacturing a torque sensor according to the present invention.

FIG. 3b shows a cross-sectional representation along BB′ of FIG. 3a.

FIG. 4 shows a cross-sectional representation of the sensor element of the torque sensor of FIGS. 2a and 3a manufactured in accordance with a method according to an exemplary embodiment of the present invention.

FIG. 5 shows another exemplary embodiment of a sensor element of a torque sensor according to the present invention for further explaining an exemplary embodiment of a manufacturing method of manufacturing a torque sensor according to the present invention.

FIG. 6 shows another exemplary embodiment of a sensor element of a torque sensor according to the present invention for further explaining an exemplary embodiment of a manufacturing method for a torque sensor according to the present invention.

FIG. 7 shows a flow-chart for further explaining an exemplary embodiment of a method of manufacturing a torque sensor according to the present invention.

FIG. 8 shows a current versus time diagram for further explaining a method according to an exemplary embodiment of the present invention.

FIG. 9 shows another exemplary embodiment of a sensor element of a torque sensor according to the present invention with an electrode system according to an exemplary embodiment of the present invention.

FIG. 10a shows another exemplary embodiment of a torque sensor according to the present invention with an electrode system according to an exemplary embodiment of the present invention.

FIG. 10b shows the sensor element of FIG. 10a after the application of current surges by means of the electrode system of FIG. 10a.

FIG. 11 shows another exemplary embodiment of a torque sensor element for a torque sensor according to the present invention.

FIG. 12 shows a schematic diagram of a sensor element of a torque sensor according to another exemplary embodiment of the present invention showing that two magnetic fields may be stored in the shaft and running in endless circles.

FIG. 13 is another schematic diagram for illustrating PCME sensing technology using two counter cycle or magnetic field loops which may be generated in accordance with a manufacturing method according to the present invention.

FIG. 14 shows another schematic diagram for illustrating that when no mechanical stress is applied to the sensor element according to an exemplary embodiment of the present invention, magnetic flux lines are running in its original paths.

FIG. 15 is another schematic diagram for further explaining a principle of an exemplary embodiment of the present invention.

FIG. 16 is another schematic diagram for further explaining the principle of an exemplary embodiment of the present invention.

FIGS. 17-22 are schematic representations for further explaining a principle of an exemplary embodiment of the present invention.

FIG. 23 is another schematic diagram for explaining a principle of an exemplary embodiment of the present invention.

FIGS. 24, 25 and 26 are schematic diagrams for further explaining a principle of an exemplary embodiment of the present invention.

FIG. 27 is a current versus time diagram for illustrating a current pulse which may be applied to a sensor element according to a manufacturing method according to an exemplary embodiment of the present invention.

FIG. 28 shows an output signal versus current pulse length diagram according to an exemplary embodiment of the present invention.

FIG. 29 shows a current versus time diagram with current pulses according to an exemplary embodiment of the present invention which may be applied to sensor elements according to a method of the present invention.

FIG. 30 shows another current versus time diagram showing an exemplary embodiment of a current pulse applied to a sensor element such as a shaft according to a method of an exemplary embodiment of the present invention.

FIG. 31 shows a signal and signal efficiency versus current diagram in accordance with an exemplary embodiment of the present invention.

FIG. 32 is a cross-sectional view of a sensor element having an exemplary PCME electrical current density according to an exemplary embodiment of the present invention.

FIG. 33 shows a cross-sectional view of a sensor element and an electrical pulse current density at different and increasing pulse current levels according to an exemplary embodiment of the present invention.

FIGS. 34a and 34b show a spacing achieved with different current pulses of magnetic flows in sensor elements according to the present invention.

FIG. 35 shows a current versus time diagram of a current pulse as it may be applied to a sensor element according to an exemplary embodiment of the present invention.

FIG. 36 shows an electrical multi-point connection to a sensor element according to an exemplary embodiment of the present invention.

FIG. 37 shows a multi-channel electrical connection fixture with spring loaded contact points to apply a current pulse to the sensor element according to an exemplary embodiment of the present invention.

FIG. 38 shows an electrode system with an increased number of electrical connection points according to an exemplary embodiment of the present invention.

FIG. 39 shows an exemplary embodiment of the electrode system of FIG. 37.

FIG. 40 shows shaft processing holding clamps used for a method according to an exemplary embodiment of the present invention.

FIG. 41 shows a dual field encoding region of a sensor element according to the present invention.

FIG. 42 shows a process step of a sequential dual field encoding according to an exemplary embodiment of the present invention.

FIG. 43 shows another process step of the dual field encoding according to another exemplary embodiment of the present invention.

FIG. 44 shows another exemplary embodiment of a sensor element with an illustration of a current pulse application according to another exemplary embodiment of the present invention.

FIG. 45 shows schematic diagrams for describing magnetic flux directions in sensor elements according to the present invention when no stress is applied.

FIG. 46 shows magnetic flux directions of the sensor element of FIG. 45 when a force is applied.

FIG. 47 shows the magnetic flux inside the PCM encoded shaft of FIG. 45 when the applied torque direction is changing.

FIG. 48 shows a 6-channel synchronized pulse current driver system according to an exemplary embodiment of the present invention.

FIG. 49 shows a simplified representation of an electrode system according to another exemplary embodiment of the present invention.

FIG. 50 is a representation of a sensor element according to an exemplary embodiment of the present invention.

FIG. 51 is another exemplary embodiment of a sensor element according to the present invention having a PCME process sensing region with two pinning field regions.

FIG. 52 is a schematic representation for explaining a manufacturing method according to an exemplary embodiment of the present invention for manufacturing a sensor element with an encoded region and pinning regions.

FIG. 53 is another schematic representation of a sensor element according to an exemplary embodiment of the present invention manufactured in accordance with a manufacturing method according to an exemplary embodiment of the present invention.

FIG. 54 is a simplified schematic representation for further explaining an exemplary embodiment of the present invention.

FIG. 55 is another simplified schematic representation for further explaining an exemplary embodiment of the present invention.

FIG. 56 shows an application of a torque sensor according to an exemplary embodiment of the present invention in a gear box of a motor.

FIG. 57 shows a torque sensor according to an exemplary embodiment of the present invention.

FIG. 58 shows a schematic illustration of components of a non-contact torque sensing device according to an exemplary embodiment of the present invention.

FIG. 59 shows components of a sensing device according to an exemplary embodiment of the present invention.

FIG. 60 shows arrangements of coils with a sensor element according to an exemplary embodiment of the present invention.

FIG. 61 shows a single channel sensor electronics according to an exemplary embodiment of the present invention.

FIG. 62 shows a dual channel, short circuit protected system according to an exemplary embodiment of the present invention.

FIG. 63 shows a sensor according to another exemplary embodiment of the present invention.

FIG. 64 illustrates an exemplary embodiment of a secondary sensor unit assembly according to an exemplary embodiment of the present invention.

FIG. 65 illustrates two configurations of a geometrical arrangement of primary sensor and secondary sensor according to an exemplary embodiment of the present invention.

FIG. 66 is a schematic representation for explaining that a spacing between the secondary sensor unit and the sensor host is preferably as small as possible.

FIG. 67 is an embodiment showing a primary sensor encoding equipment.

FIG. 68 shows a position sensor device according to an embodiment of the invention.

FIG. 69 shows a diagram illustrating the functionality of the position sensor device shown in FIG. 68.

FIG. 70 shows another schematic diagram of the position sensor illustrated in FIG. 68.

FIG. 71 shows a position sensor device according to an embodiment of the invention.

FIG. 72 shows a position sensor device according to an embodiment of the invention.

FIG. 73 shows a position sensor device according to an embodiment of the invention.

FIG. 74 shows a diagram illustrating the functionality of the position sensor device illustrated in FIG. 73.

FIG. 75 shows a schematic view of a position sensor device according to an embodiment of the invention.

FIG. 76a shows a geometry for arranging magnetic field detectors in a position sensor array according to an embodiment of the invention.

FIG. 76b shows another geometry for arranging magnetic field detectors in a position sensor array according to an embodiment of the invention.

FIG. 77 shows illustrates the functionality of a position sensor device according to the invention.

FIG. 78 to FIG. 81 show different view and operation modes of a washing machine according to an embodiment of the invention.

FIG. 82 shows an arrangement of a magnetic field source and a single magnetic field detector of a position sensor device for a washing machine according to an embodiment of the invention.

FIG. 83 shows another embodiment of a position sensor array for a washing machine.

FIG. 84 shows an embodiment of a position sensor device according to the invention.

FIG. 85 shows an embodiment of a position sensor device according to an embodiment of the invention.

FIG. 86 shows an embodiment of a position sensor device according to the invention.

FIG. 87 shows a geometry of a position sensor device according to an embodiment of the invention.

FIG. 88 shows another view of the position sensor device according to FIG. 87.

FIG. 89 shows a geometry for arranging a magnetic field source and magnetic field detecting devices according to an embodiment of a position sensor device of the invention.

FIG. 90 shows a diagram illustrating a scheme of processing of data for detecting a position according to the invention.

FIG. 91 shows a circuit array of a position sensor device according to the invention.

FIG. 92 shows a side view of an arrangement for a position sensor device according to the invention.

FIG. 93 shows a magnetic field source with a round core end according to the invention.

FIG. 94 shows a schematic circuit diagram illustrating how data measured in a position sensor device are processed according to an embodiment of the invention.

FIG. 95 shows a one-dimensional bending sensor device according to an embodiment of the invention.

FIG. 96 shows a two-dimensional bending sensor device according to an embodiment of the invention.

FIG. 97 shows a two-dimensional bending sensor device according to an embodiment of the invention.

FIG. 98 shows a bending sensor shaft according to the invention.

FIG. 99 shows another embodiment of a bending sensor device according to the invention.

FIG. 100 shows a sensor housing related to FIG. 99.

FIG. 101 shows a sensor arrangement according to an exemplary embodiment of the invention.

FIG. 102 shows a scenario in which the sensor arrangement according to FIG. 101 can be used.

FIG. 103 illustrates a position sensor device according to an exemplary embodiment of the invention which may be implemented in the context of a rotatable drum of a washing machine.

FIG. 104 illustrates a position sensor device according to an exemplary embodiment of the invention which may be implemented in the context of a rotatable drum of a washing machine.

FIG. 105 illustrates a position sensor device according to an exemplary embodiment of the invention which may be implemented in the context of a rotatable drum of a washing machine.

FIG. 106 illustrates a schematic plan view of a position sensor array according to an exemplary embodiment of the invention.

FIG. 107 illustrates electronic properties of a position sensor device according to an exemplary embodiment of the invention.

FIG. 108 schematically illustrates a position sensor array according to an exemplary embodiment of the invention.

FIG. 109 schematically illustrates a position sensor array according to an exemplary embodiment of the invention.

FIG. 110 schematically illustrates a diagram showing members of a linear position sensor technology family.

FIG. 111 illustrates an electric motor with a sensor system according to an exemplary embodiment of the invention.

FIG. 112 illustrates an moving electric motor with a sensor system according to an exemplary embodiment of the invention.

FIG. 113 illustrates a sensor arrangement according to an exemplary embodiment of the invention.

FIG. 114 illustrates a washing machine with a sensor system according to an exemplary embodiment of the invention.

FIG. 115 illustrates components of a sensor array according to an exemplary embodiment of the invention.

FIG. 116 illustrates a sensor arrangement according to an exemplary embodiment of the invention.

FIG. 117 illustrates a wireless 3D position sensor device according to an exemplary embodiment of the invention.

FIG. 118 illustrates a coordinate system definition for a wireless 3D position sensor device according to an exemplary embodiment of the invention.

FIG. 119 illustrates a schematic view of a wireless 3D position sensor array according to an exemplary embodiment of the invention.

FIG. 120 illustrates a main sensing board layout of a sensor system according to an exemplary embodiment of the invention.

FIG. 121 illustrates a geometry related to a 3D coordinates computation process according to an exemplary embodiment of the invention.

FIG. 122 illustrates a three axes measurement system of a wireless 3D position sensor device according to an exemplary embodiment of the invention.

FIG. 123 illustrates a fixed frequency load circuit of a sensor array according to an exemplary embodiment of the invention.

FIG. 124 illustrates a wide frequency band load circuit according to an exemplary embodiment of the invention.

FIG. 125 illustrates a circuit diagram of a wireless 3D sensor system according to an exemplary embodiment of the invention.

FIG. 126 illustrates a circuit diagram of a wireless 3D sensor system according to an exemplary embodiment of the invention.

FIG. 127 illustrates a sensing pad and a signal conditioning and signal processing electronics design of a sensor array according to an exemplary embodiment of the invention.

FIG. 128 illustrates another sensing pad and a signal conditioning and signal processing electronics design of a sensor array according to an exemplary embodiment of the invention.

### DETAILED DESCRIPTION OF EMBODIMENTS OF THE INVENTION

It is disclosed a sensor having a sensor element such as a shaft wherein the sensor element may be manufactured in accordance with the following manufacturing steps
applying a first current pulse to the sensor element;
wherein the first current pulse is applied such that there is a first current flow in a first direction along a longitudinal axis of the sensor element;
wherein the first current pulse is such that the application of the current pulse generates a magnetically encoded region in the sensor element.

It is disclosed that a further second current pulse may be applied to the sensor element. The second current pulse may be applied such that there is a second current flow in a direction along the longitudinal axis of the sensor element.

It is disclosed that the directions of the first and second current pulses may be opposite to each other. Also, each of the first and second current pulses may have a raising edge and a falling edge. Preferably, the raising edge is steeper than the falling edge.

It is believed that the application of a current pulse may cause a magnetic field structure in the sensor element such that in a cross-sectional view of the sensor element, there is a first circular magnetic flow having a first direction and a second magnetic flow having a second direction. The radius of the first magnetic flow may be larger than the radius of the second magnetic flow. In shafts having a non-circular cross-section, the magnetic flow is not necessarily circular but may have a form essentially corresponding to and being adapted to the cross-section of the respective sensor element.

It is believed that if no torque is applied to a sensor element, there is no magnetic field or essentially no magnetic field detectable at the outside. When a torque or force is applied to the sensor element, there is a magnetic field emanated from the sensor element which can be detected by means of suitable coils. This will be described in further detail in the following.

A torque sensor may have a circumferential surface surrounding a core region of the sensor element. The first current pulse is introduced into the sensor element at a first location at the circumferential surface such that there is a first current flow in the first direction in the core region of the sensor element. The first current pulse is discharged from the sensor element at a second location at the circumferential surface. The second location is at a distance in the first direction from the first location. The second current pulse may be introduced into the sensor element at the second location or adjacent to the second location at the circumferential surface such that there is the second current flow in the second direction in the core region or adjacent to the core region in the sensor element. The second current pulse may be discharged from the sensor element at the first location or adjacent to the first location at the circumferential surface.

As already indicated above, the sensor element may be a shaft. The core region of such shaft may extend inside the shaft along its longitudinal extension such that the core region surrounds a center of the shaft. The circumferential surface of the shaft is the outside surface of the shaft. The first and second locations are respective circumferential regions at the outside of the shaft. There may be a limited number of contact portions which constitute such regions. Preferably, real contact regions may be provided, for example, by providing electrode regions made of brass rings as electrodes. Also, a core of a conductor may be looped around the shaft to provide for a good electric contact between a conductor such as a cable without isolation and the shaft.

The first current pulse and preferably also the second current pulse may be not applied to the sensor element at an end face of the sensor element. The first current pulse may have a maximum between 40 and 1400 Ampere or between 60 and 800 Ampere or between 75 and 600 Ampere or between 80 and 500 Ampere. The current pulse may have a maximum such that an appropriate encoding is caused to the sensor element. However, due to different materials which may be used and different forms of the sensor element and different dimensions of the sensor element, a maximum of the current pulse may be adjusted in accordance with these parameters. The second pulse may have a similar maximum or may have a maximum approximately 10, 20, 30, 40 or 50% smaller than the first maximum. However, the second pulse may also have a higher maximum such as 10, 20, 40, 50, 60 or 80% higher than the first maximum.

A duration of those pulses may be the same. However, it is possible that the first pulse has a significant longer duration than the second pulse. However, it is also possible that the second pulse has a longer duration than the first pulse.

The first and/or second current pulses may have a first duration from the start of the pulse to the maximum and may have a second duration from the maximum to essentially the end of the pulse. The first duration may be significantly longer than the second duration. For example, the first duration may be smaller than 300 ms wherein the second duration may be larger than 300 ms. However, it is also possible that the first duration is smaller than 200 ms whereas the second duration is larger than 400 ms. Also, the first duration may be between 20 to 150 ms wherein the second duration may be between 180 to 700 ms.

As already indicated above, it is possible to apply a plurality of first current pulses but also a plurality of second current pulses. The sensor element may be made of steel whereas the steel may comprise nickel. The sensor material used for the primary sensor or for the sensor element may be 50NiCr13 or X4CrNi13-4 or X5CrNiCuNb16-4 or X20CrNi17-4 or X46Cr13 or X20Cr13 or 14NiCr14 or S155 as set forth in DIN 1.2721 or 1.4313 or 1.4542 or 1.2787 or 1.4034 or 1.4021 or 1.5752 or 1.6928.

The first current pulse may be applied by means of an electrode system having at least a first electrode and a second electrode. The first electrode is located at the first location or adjacent to the first location and the second electrode is located at the second location or adjacent to the second location.

Each of the first and second electrodes may have a plurality of electrode pins. The plurality of electrode pins of each of the first and second electrodes may be arranged circumferentially around the sensor element such that the sensor element is contacted by the electrode pins of the first and second electrodes at a plurality of contact points at an outer circumferential surface of the shaft at the first and second locations.

As indicated above, instead of electrode pins laminar or two-dimensional electrode surfaces may be applied. Preferably, electrode surfaces are adapted to surfaces of the shaft such that a good contact between the electrodes and the shaft material may be ensured.

At least one of the first current pulse and at least one of the second current pulse may be applied to the sensor element such that the sensor element has a magnetically encoded region such that in a direction essentially perpendicular to a surface of the sensor element, the magnetically encoded region of the sensor element has a magnetic field structure such that there is a first magnetic flow in a first direction and a second magnetic flow in a second direction. The first direction may be opposite to the second direction.

In a cross-sectional view of the sensor element, there may be a first circular magnetic flow having the first direction and a first radius and a second circular magnetic flow having the second direction and a second radius. The first radius may be larger than the second radius.

Furthermore, the sensor elements may have a first pinning zone adjacent to the first location and a second pinning zone adjacent to the second location.

The pinning zones may be manufactured in accordance with the following manufacturing method. According to this method, for forming the first pinning zone, at the first location or adjacent to the first location, a third current pulse is applied on the circumferential surface of the sensor element such that there is a third current flow in the second direction. The third current flow is discharged from the sensor element at a third location which is displaced from the first location in the second direction.

For forming the second pinning zone, at the second location or adjacent to the second location, a forth current pulse may be applied on the circumferential surface to the sensor element such that there is a forth current flow in the first direction. The forth current flow is discharged at a forth location which is displaced from the second location in the first direction.

A torque sensor may be provided comprising a first sensor element with a magnetically encoded region wherein the first sensor element has a surface. In a direction essentially perpendicular to the surface of the first sensor element, the magnetically encoded region of the first sensor element may have a magnetic field structure such that there is a first magnetic flow in a first direction and a second magnetic flow in a second direction. The first and second directions may be opposite to each other.

The torque sensor may further comprise a second sensor element with at least one magnetic field detector. The second sensor element may be adapted for detecting variations in the magnetically encoded region. More precisely, the second sensor element may be adapted for detecting variations in a magnetic field emitted from the magnetically encoded region of the first sensor element.

The magnetically encoded region may extend longitudinally along a section of the first sensor element, but does not extend from one end face of the first sensor element to the other end face of the first sensor element. In other words, the magnetically encoded region does not extend along all of the first sensor element but only along a section thereof.

The first sensor element may have variations in the material of the first sensor element caused by at least one current pulse or surge applied to the first sensor element for altering the magnetically encoded region or for generating the magnetically encoded region. Such variations in the material may be caused, for example, by differing contact resistances between electrode systems for applying the current pulses and the surface of the respective sensor element. Such variations may, for example, be burn marks or color variations or signs of an annealing.

The variations may be at an outer surface of the sensor element and not at the end faces of the first sensor element since the current pulses are applied to outer surface of the sensor element but not to the end faces thereof.

A shaft for a magnetic sensor may be provided having, in a cross-section thereof, at least two circular magnetic loops running in opposite direction. Such shaft is believed to be manufactured in accordance with the above-described manufacturing method.

Furthermore, a shaft may be provided having at least two circular magnetic loops which are arranged concentrically.

A shaft for a torque sensor may be provided which is manufactured in accordance with the following manufacturing steps where firstly a first current pulse is applied to the shaft. The first current pulse is applied to the shaft such that there is a first current flow in a first direction along a longitudinal axis of the shaft. The first current pulse is such that the application of the current pulse generates a magnetically encoded region in the shaft. This may be made by using an electrode system as described above and by applying current pulses as described above.

An electrode system may be provided for applying current surges to a sensor element for a torque sensor, the electrode system having at least a first electrode and a second electrode wherein the first electrode is adapted for location at a first location on an outer surface of the sensor element. A second electrode is adapted for location at a second location on the outer surface of the sensor element. The first and second electrodes are adapted for applying and discharging at least one current pulse at the first and second locations such that current flows within a core region of the sensor element are caused. The at least one current pulse is such that a magnetically encoded region is generated at a section of the sensor element.

The electrode system may comprise at least two groups of electrodes, each comprising a plurality of electrode pins. The electrode pins of each electrode are arranged in a circle such that the sensor element is contacted by the electrode pins of the electrode at a plurality of contact points at an outer surface of the sensor element.

The outer surface of the sensor element does not include the end faces of the sensor element.

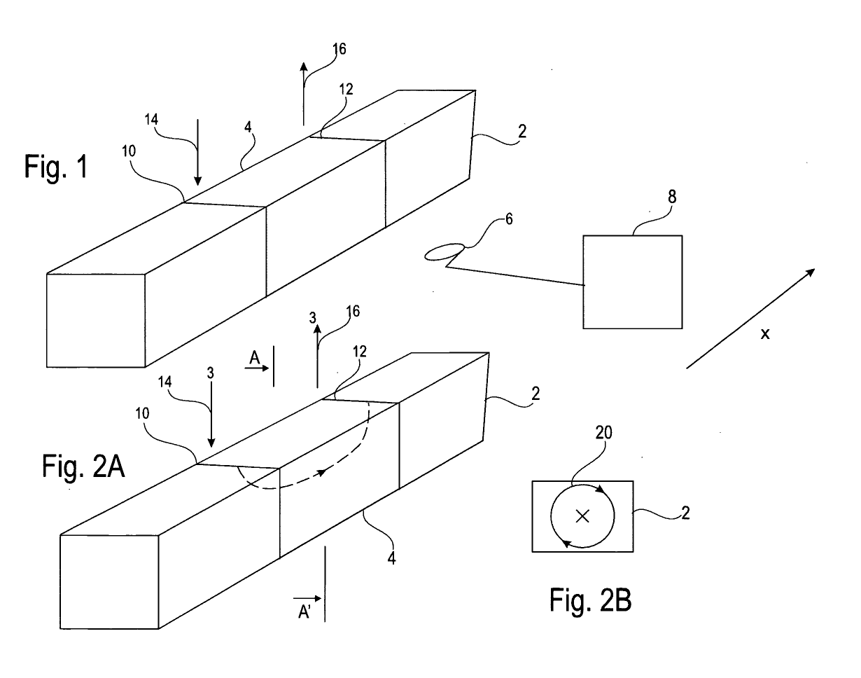

FIG. 1 shows an exemplary embodiment of a torque sensor according to the present invention. The torque sensor comprises a first sensor element or shaft 2 having a rectangular cross-section. The first sensor element 2 extends essentially along the direction indicated with X. In a middle portion of the first sensor element 2, there is the encoded region 4. The first location is indicated by reference numeral 10 and indicates one end of the encoded region and the second location is indicated by reference numeral 12 which indicates another end of the encoded region or the region to be magnetically encoded 4. Arrows 14 and 16 indicate the application of a current pulse. As indicated in FIG. 1, a first current pulse is applied to the first sensor element 2 at an outer region adjacent or close to the first location 10. Preferably, as will be described in further detail later on, the current is introduced into the first sensor element 2 at a plurality of points or regions close to the first location and preferably surrounding the outer surface of the first sensor element 2 along the first location 10. As indicated with arrow 16, the current pulse is discharged from the first sensor element 2 close or adjacent or at the second location 12 preferably at a plurality or locations along the end of the region 4 to be encoded. As already indicated before, a plurality of current pulses may be applied in succession they may have alternating directions from location 10 to location 12 or from location 12 to location 10.

Reference numeral 6 indicates a second sensor element which is preferably a coil connected to a controller electronic 8. The controller electronic 8 may be adapted to further process a signal output by the second sensor element 6 such that an output signal may output from the control circuit corresponding to a torque applied to the first sensor element 2. The control circuit 8 may be an analog or digital circuit. The second sensor element 6 is adapted to detect a magnetic field emitted by the encoded region 4 of the first sensor element.

It is believed that, as already indicated above, if there is no stress or force applied to the first sensor element 2, there is essentially no field detected by the second sensor element 6. However, in case a stress or a force is applied to the secondary sensor element 2, there is a variation in the magnetic field emitted by the encoded region such that an increase of a magnetic field from the presence of almost no field is detected by the second sensor element 6.

It has to be noted that according to other exemplary embodiments of the present invention, even if there is no stress applied to the first sensor element, it may be possible that there is a magnetic field detectable outside or adjacent to the encoded region 4 of the first sensor element 2. However, it is to be noted that a stress applied to the first sensor element 2 causes a variation of the magnetic field emitted by the encoded region 4.

In the following, with reference to FIGS. 2a, 2b, 3a, 3b and 4, a method of manufacturing a torque sensor according to an exemplary embodiment of the present invention will be described. In particular, the method relates to the magnetization of the magnetically encoded region 4 of the first sensor element 2.

As may be taken from FIG. 2a, a current I is applied to an end region of a region 4 to be magnetically encoded. This end region as already indicated above is indicated with reference numeral 10 and may be a circumferential region on the outer surface of the first sensor element 2. The current I is discharged from the first sensor element 2 at another end area of the magnetically encoded region (or of the region to be magnetically encoded) which is indicated by reference numeral 12 and also referred to a second location. The current is taken from the first sensor element at an outer surface thereof, preferably circumferentially in regions close or adjacent to location 12. As indicated by the dashed line between locations 10 and 12, the current I introduced at or along location 10 into the first sensor element flows through a core region or parallel to a core region to location 12. In other words, the current I flows through the region 4 to be encoded in the first sensor element 2.

FIG. 2b shows a cross-sectional view along AA′. In the schematic representation of FIG. 2b, the current flow is indicated into the plane of the FIG. 2b as a cross. Here, the current flow is indicated in a center portion of the cross-section of the first sensor element 2. It is believed that this introduction of a current pulse having a form as described above or in the following and having a maximum as described above or in the following causes a magnetic flow structure 20 in the cross-sectional view with a magnetic flow direction into one direction here into the clockwise direction. The magnetic flow structure 20 depicted in FIG. 2b is depicted essentially circular. However, the magnetic flow structure 20 may be adapted to the actual cross-section of the first sensor element 2 and may be, for example, more elliptical.

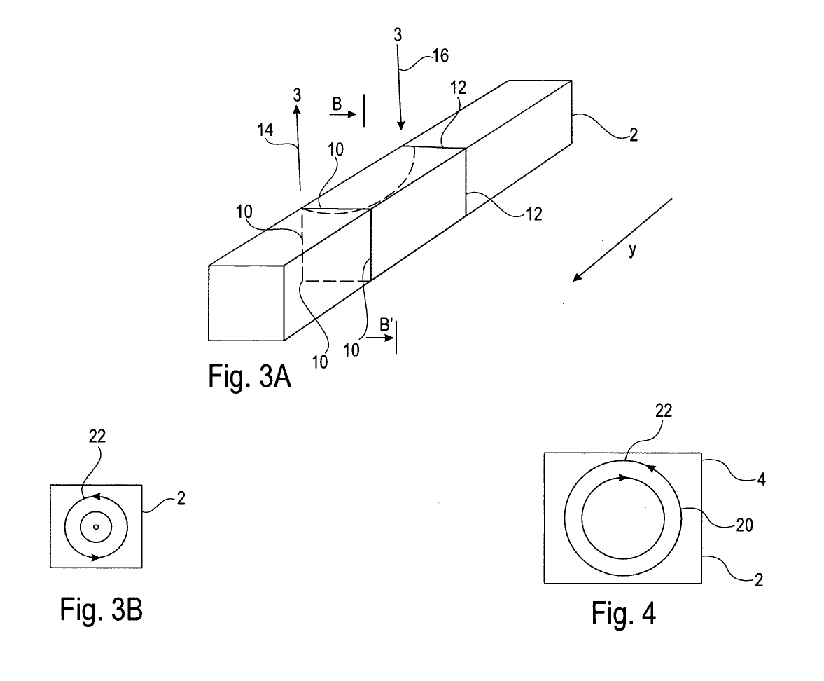

FIGS. 3a and 3b show a step of the method according to an exemplary embodiment of the present invention which may be applied after the step depicted in FIGS. 2a and 2b. FIG. 3a shows a first sensor element according to an exemplary embodiment of the present invention with the application of a second current pulse and FIG. 3b shows a cross-sectional view along BB′ of the first sensor element 2.

As may be taken from FIG. 3a, in comparison to FIG. 2a, in FIG. 3a, the current I indicated by arrow 16 is introduced into the sensor element 2 at or adjacent to location 12 and is discharged or taken from the sensor element 2 at or adjacent to the location 10. In other words, the current is discharged in FIG. 3a at a location where it was introduced in FIG. 2a and vice versa. Thus, the introduction and discharging of the current I into the first sensor element 2 in FIG. 3a may cause a current through the region 4 to be magnetically encoded opposite to the respective current flow in FIG. 2a.

The current is indicated in FIG. 3b in a core region of the sensor element 2. As may be taken from a comparison of FIGS. 2b and 3b, the magnetic flow structure 22 has a direction opposite to the current flow structure 20 in FIG. 2b.

As indicated before, the steps depicted in FIGS. 2a, 2b and 3a and 3b may be applied individually or may be applied in succession of each other. When firstly, the step depicted in FIGS. 2a and 2b is performed and then the step depicted in FIGS. 3a and 3b, a magnetic flow structure as depicted in the cross-sectional view through the encoded region 4 depicted in FIG. 4 may be caused. As may be taken from FIG. 4, the two current flow structures 20 and 22 are encoded into the encoded region together. Thus, in a direction essentially perpendicular to a surface of the first sensor element 2, in a direction to the core of the sensor element 2, there is a first magnetic flow having a first direction and then underlying there is a second magnetic flow having a second direction. As indicated in FIG. 4, the flow directions may be opposite to each other.

Thus, if there is no torque applied to the first torque sensor element 2, the two magnetic flow structures 20 and 22 may cancel each other such that there is essentially no magnetic field at the outside of the encoded region. However, in case a stress or force is applied to the first sensor element 2, the magnetic field structures 20 and 22 cease to cancel each other such that there is a magnetic field occurring at the outside of the encoded region which may then be detected by means of the secondary sensor element 6. This will be described in further detail in the following.

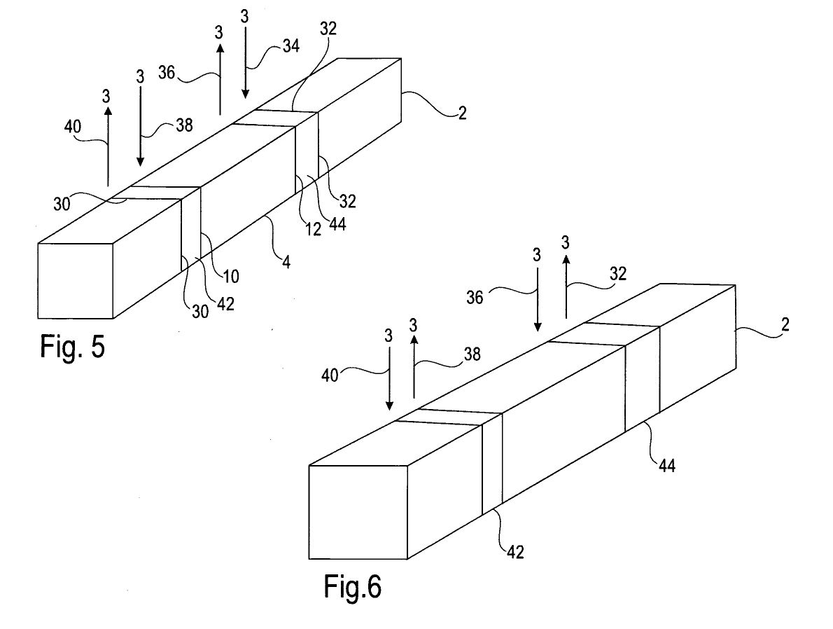

FIG. 5 shows another exemplary of a first sensor element 2 according to an exemplary embodiment of the present invention as may be used in a torque sensor according to an exemplary embodiment which is manufactured according to a manufacturing method according to an exemplary embodiment of the present invention. As may be taken from FIG. 5, the first sensor element 2 has an encoded region 4 which is preferably encoded in accordance with the steps and arrangements depicted in FIGS. 2a, 2b, 3a, 3b and 4.

Adjacent to locations 10 and 12, there are provided pinning regions 42 and 44. These regions 42 and 44 are provided for avoiding a fraying of the encoded region 4. In other words, the pinning regions 42 and 44 may allow for a more definite beginning and end of the encoded region 4.

In short, the first pinning region 42 may be adapted by introducing a current 38 close or adjacent to the first location 10 into the first sensor element 2 in the same manner as described, for example, with reference to FIG. 2a. However, the current I is discharged from the first sensor element 2 at a first location 30 which is at a distance from the end of the encoded region close or at location 10. This further location is indicated by reference numeral 30. The introduction of this further current pulse I is indicated by arrow 38 and the discharging thereof is indicated by arrow 40. The current pulses may have the same form shaping maximum as described above.

For generating the second pinning region 44, a current is introduced into the first sensor element 2 at a location 32 which is at a distance from the end of the encoded region 4 close or adjacent to location 12. The current is then discharged from the first sensor element 2 at or close to the location 12. The introduction of the current pulse I is indicated by arrows 34 and 36.

The pinning regions 42 and 44 preferably are such that the magnetic flow structures of these pinning regions 42 and 44 are opposite to the respective adjacent magnetic flow structures in the adjacent encoded region 4. As may be taken from FIG. 5, the pinning regions can be coded to the first sensor element 2 after the coding or the complete coding of the encoded region 4.

FIG. 6 shows another exemplary embodiment of the present invention where there is no encoding region 4. In other words, according to an exemplary embodiment of the present invention, the pinning regions may be coded into the first sensor element 2 before the actual coding of the magnetically encoded region 4.

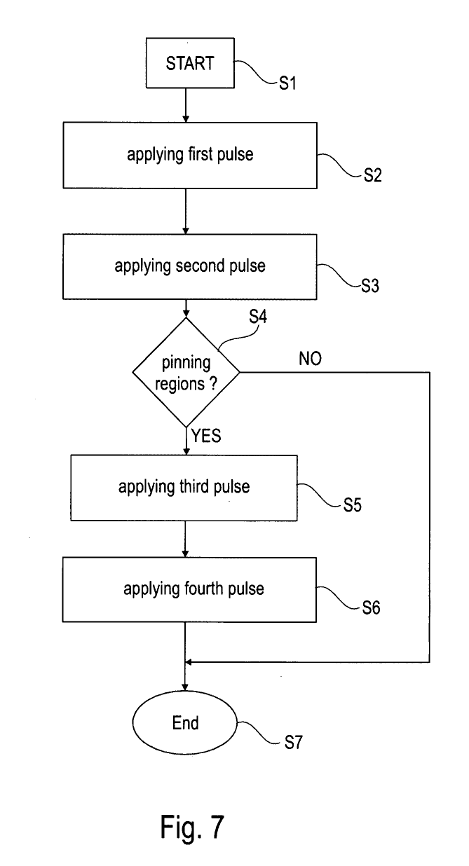

FIG. 7 shows a simplified flow-chart of a method of manufacturing a first sensor element 2 for a torque sensor according to an exemplary embodiment of the present invention.

After the start in step S1, the method continues to step S2 where a first pulse is applied as described as reference to FIGS. 2a and 2b. Then, after step S2, the method continues to step S3 where a second pulse is applied as described with reference to FIGS. 3a and 3b.

Then, the method continues to step S4 where it is decided whether the pinning regions are to be coded to the first sensor element 2 or not. If it is decided in step S4 that there will be no pinning regions, the method continues directly to step S7 where it ends.

If it is decided in step S4 that the pinning regions are to be coded to the first sensor element 2, the method continues to step S5 where a third pulse is applied to the pinning region 42 in the direction indicated by arrows 38 and 40 and to pinning region 44 indicated by the arrows 34 and 36. Then, the method continues to step S6 where force pulses applied to the respective pinning regions 42 and 44. To the pinning region 42, a force pulse is applied having a direction opposite to the direction indicated by arrows 38 and 40. Also, to the pinning region 44, a force pulse is applied to the pinning region having a direction opposite to the arrows 34 and 36. Then, the method continues to step S7 where it ends.

In other words, preferably two pulses are applied for encoding of the magnetically encoded region 4. Those current pulses preferably have an opposite direction. Furthermore, two pulses respectively having respective directions are applied to the pinning region 42 and to the pinning region 44.

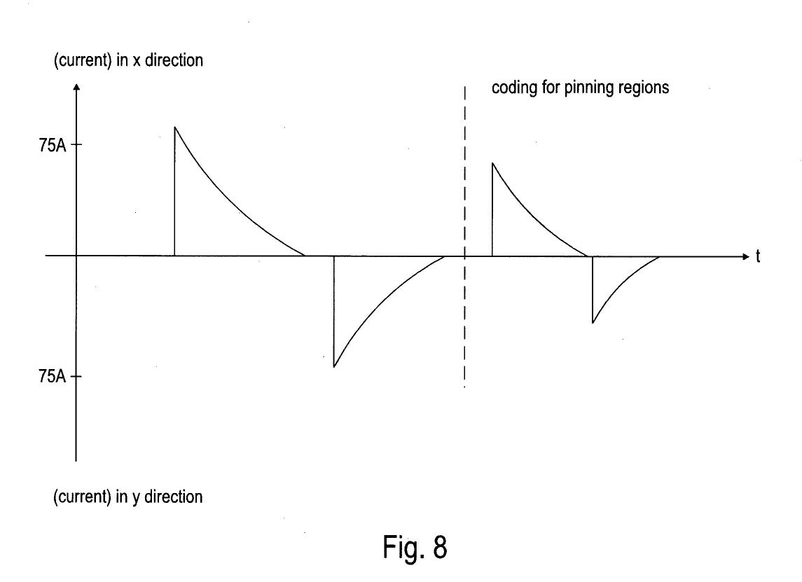

FIG. 8 shows a current versus time diagram of the pulses applied to the magnetically encoded region 4 and to the pinning regions. The positive direction of the y-axis of the diagram in FIG. 8 indicates a current flow into the x-direction and the negative direction of the y-axis of FIG. 8 indicates a current flow in the y-direction.

As may be taken from FIG. 8 for coding the magnetically encoded region 4, firstly a current pulse is applied having a direction into the x-direction. As may be taken from FIG. 8, the raising edge of the pulse is very sharp whereas the falling edge has a relatively long direction in comparison to the direction of the raising edge. As depicted in FIG. 8, the pulse may have a maximum of approximately 75 Ampere. In other applications, the pulse may be not as sharp as depicted in FIG. 8. However, the raising edge should be steeper or should have a shorter duration than the falling edge.

Then, a second pulse is applied to the encoded region 4 having an opposite direction. The pulse may have the same form as the first pulse. However, a maximum of the second pulse may also differ from the maximum of the first pulse. Although the immediate shape of the pulse may be different.

Then, for coding the pinning regions, pulses similar to the first and second pulse may be applied to the pinning regions as described with reference to FIGS. 5 and 6. Such pulses may be applied to the pinning regions simultaneously but also successfully for each pinning region. As depicted in FIG. 8, the pulses may have essentially the same form as the first and second pulses. However, a maximum may be smaller.

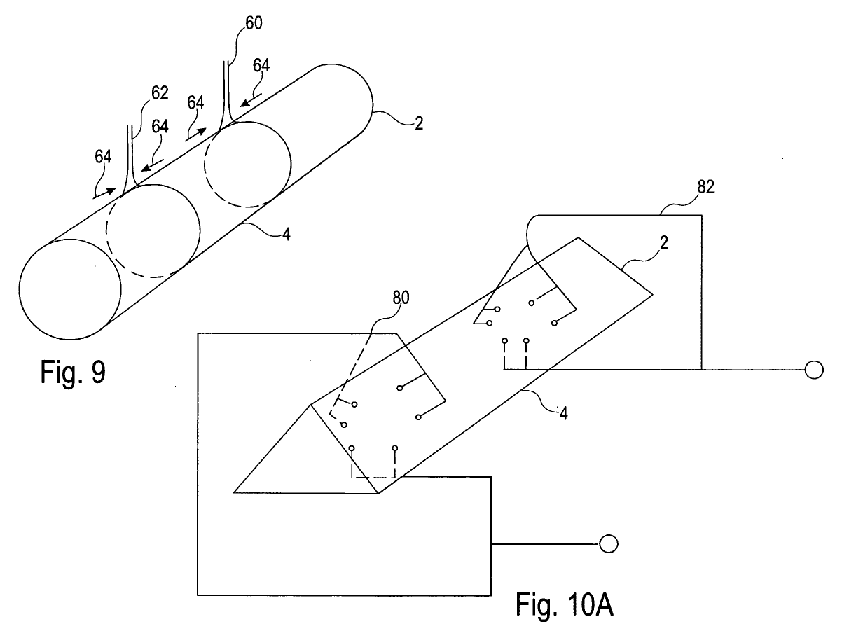

FIG. 9 shows another exemplary embodiment of a first sensor element of a torque sensor according to an exemplary embodiment of the present invention showing an electrode arrangement for applying the current pulses for coding the magnetically encoded region 4. As may be taken from FIG. 9, a conductor without an isolation may be looped around the first sensor element 2 which is may be taken from FIG. 9 may be a circular shaft having a circular cross-section. For ensuring a close fit of the conductor on the outer surface of the first sensor element 2, the conductor may be clamped as shown by arrows 64.

FIG. 10a shows another exemplary embodiment of a first sensor element according to an exemplary embodiment of the present invention. Furthermore, FIG. 10a shows another exemplary embodiment of an electrode system according to an exemplary embodiment of the present invention. The electrode system 80 and 82 depicted in FIG. 10a contacts the first sensor element 2 which has a triangular cross-section with two contact points at each phase of the triangular first sensor element at each side of the region 4 which is to be encoded as magnetically encoded region. Overall, there are six contact points at each side of the region 4. The individual contact points may be connected to each other and then connected to one individual contact points.

If there is only a limited number of contact points between the electrode system and the first sensor element 2 and if the current pulses applied are very high, differing contact resistances between the contacts of the electrode systems and the material of the first sensor element 2 may cause burn marks at the first sensor element 2 at contact point to the electrode systems. These burn marks 90 may be color changes, may be welding spots, may be annealed areas or may simply be burn marks. According to an exemplary embodiment of the present invention, the number of contact points is increased or even a contact surface is provided such that such burn marks 90 may be avoided.

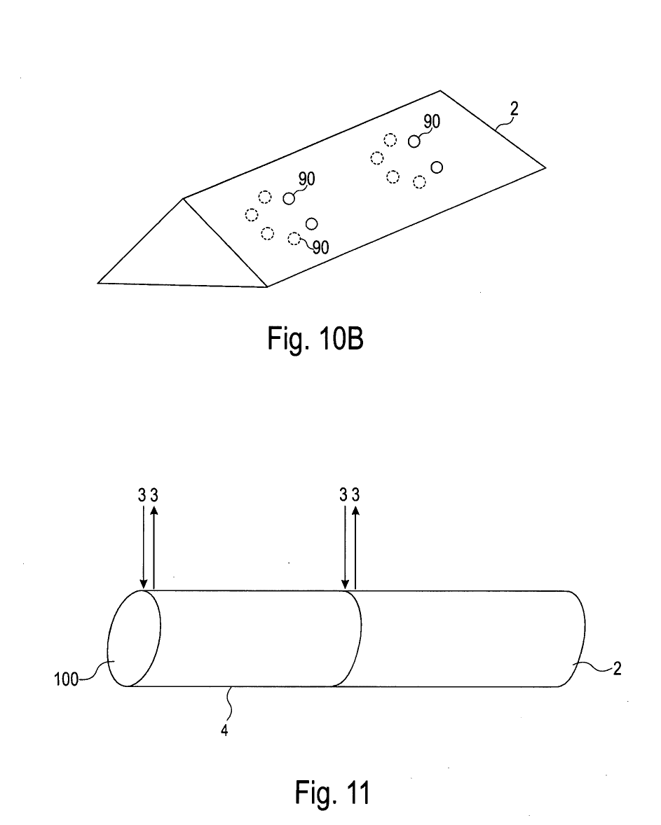

FIG. 11 shows another exemplary embodiment of a first sensor element 2 which is a shaft having a circular cross-section according to an exemplary embodiment of the present invention. As may be taken from FIG. 11, the magnetically encoded region is at an end region of the first sensor element 2. According to an exemplary embodiment of the present invention, the magnetically encoded region 4 is not extend over the full length of the first sensor element 2. As may be taken from FIG. 11, it may be located at one end thereof. However, it has to be noted that according to an exemplary embodiment of the present invention, the current pulses are applied from an outer circumferential surface of the first sensor element 2 and not from the end face 100 of the first sensor element 2.

In the following, the so-called PCME (“Pulse-Current-Modulated Encoding”) Sensing Technology will be described in detail, which can, according to an exemplary embodiment of the invention, be implemented to magnetize a magnetizable object which is then partially demagnetized according to the invention. In the following, the PCME technology will partly described in the context of torque sensing. However, this concept may implemented in the context of position sensing as well.

In this description, there are a number of acronyms used as otherwise some explanations and descriptions may be difficult to read. While the acronyms “ASIC”, “IC”, and “PCB” are already market standard definitions, there are many terms that are particularly related to the magnetostriction based NCT sensing technology. It should be noted that in this description, when there is a reference to NCT technology or to PCME, it is referred to exemplary embodiments of the present invention.

Table 1 shows a list of abbreviations used in the following description of the PCME technology.

TABLE 1
List of abbreviations

| Acronym | Description | Category |
|---|---|---|
| ASIC | Application Specific IC | Electronics |
| DF | Dual Field | Primary Sensor |
| EMF | Earth Magnetic Field | Test Criteria |
| FS | Full Scale | Test Criteria |
| Hot-Spotting | Sensitivity to nearby Ferro | Specification |
| | magnetic material | |
| IC | Integrated Circuit | Electronics |
| MFS | Magnetic Field Sensor | Sensor |
| | | Component |
| NCT | Non Contact Torque | Technology |
| PCB | Printed Circuit Board | Electronics |
| PCME | Pulse Current Modulated Encoding | Technology |
| POC | Proof-of-Concept | |
| RSU | Rotational Signal Uniformity | Specification |
| SCSP | Signal Conditioning & | Electronics |
| | Signal Processing | |
| SF | Single Field | Primary Sensor |
| SH | Sensor Host | Primary Sensor |
| SPHC | Shaft Processing Holding Clamp | Processing Tool |
| SSU | Secondary Sensor Unit | Sensor Component |

The magnetic principle based mechanical-stress sensing technology allows to design and to produce a wide range of “physical-parameter-sensors” (like Force Sensing, Torque Sensing, and Material Diagnostic Analysis) that can be applied where Ferro-Magnetic materials are used. The most common technologies used to build “magnetic-principle-based” sensors are: Inductive differential displacement measurement (requires torsion shaft), measuring the changes of the materials permeability, and measuring the magnetostriction effects.

Over the last 20 years a number of different companies have developed their own and very specific solution in how to design and how to produce a magnetic principle based torque sensor (i.e. ABB, FAST, Frauenhofer Institute, FT, Kubota, MDI, NCTE, RM, Siemens, and others). These technologies are at various development stages and differ in “how-it-works”, the achievable performance, the systems reliability, and the manufacturing/system cost.

Some of these technologies require that mechanical changes are made to the shaft where torque should be measured (chevrons), or rely on the mechanical torsion effect (require a long shaft that twists under torque), or that something will be attached to the shaft itself (press-fitting a ring of certain properties to the shaft surface), or coating of the shaft surface with a special substance. No-one has yet mastered a high-volume manufacturing process that can be applied to (almost) any shaft size, achieving tight performance tolerances, and is not based on already existing technology patents.

In the following, a magnetostriction principle based Non-Contact-Torque (NCT) Sensing Technology is described that offers to the user a whole host of new features and improved performances, previously not available. This technology enables the realization of a fully-integrated (small in space), real-time (high signal bandwidth) torque measurement, which is reliable and can be produced at an affordable cost, at any desired quantities. This technology is called: PCME (for Pulse-Current-Modulated Encoding) or Magnetostriction Transversal Torque Sensor.

The PCME technology can be applied to the shaft without making any mechanical changes to the shaft, or without attaching anything to the shaft. Most important, the PCME technology can be applied to any shaft diameter (most other technologies have here a limitation) and does not need to rotate/spin the shaft during the encoding process (very simple and low-cost manufacturing process) which makes this technology very applicable for high-volume application.

In the following, a Magnetic Field Structure (Sensor Principle) will be described. The sensor life-time depends on a “closed-loop” magnetic field design. The PCME technology is based on two magnetic field structures, stored above each other, and running in opposite directions. When no torque stress or motion stress is applied to the shaft (also called Sensor Host, or SH) then the SH will act magnetically neutral (no magnetic field can be sensed at the outside of the SH).

FIG. 12 shows that two magnetic fields are stored in the shaft and running in endless circles. The outer field runs in one direction, while the inner field runs in the opposite direction.

FIG. 13 illustrates that the PCME sensing technology uses two Counter-Circular magnetic field loops that are stored on top of each other (Picky-Back mode).

When mechanical stress (like reciprocation motion or torque) is applied at both ends of the PCME magnetized SH (Sensor Host, or Shaft) then the magnetic flux lines of both magnetic structures (or loops) will tilt in proportion to the applied torque.

As illustrated in FIG. 14, when no mechanical stresses are applied to the SH the magnetic flux lines are running in its original path. When mechanical stresses are applied the magnetic flux lines tilt in proportion to the applied stress (like linear motion or torque).

Depending on the applied torque direction (clockwise or anti-clockwise, in relation to the SH) the magnetic flux lines will either tilt to the right or tilt to the left. Where the magnetic flux lines reach the boundary of the magnetically encoded region, the magnetic flux lines from the upper layer will join-up with the magnetic flux lines from the lower layer and visa-versa. This will then form a perfectly controlled toroidal shape.

The benefits of such a magnetic structure are:
Reduced (almost eliminated) parasitic magnetic field structures when mechanical stress is applied to the SH (this will result in better RSU performances).
Higher Sensor-Output Signal-Slope as there are two “active” layers that compliment each other when generating a mechanical stress related signal. Explanation: When using a single-layer sensor design, the “tilted” magnetic flux lines that exit at the encoding region boundary have to create a “return passage” from one boundary side to the other. This effort effects how much signal is available to be sensed and measured outside of the SH with the secondary sensor unit.
There are almost no limitations on the SH (shaft) dimensions where the PCME technology will be applied to. The dual layered magnetic field structure can be adapted to any solid or hollow shaft dimensions.
The physical dimensions and sensor performances are in a very wide range programmable and therefore can be tailored to the targeted application.
This sensor design allows to measure mechanical stresses coming from all three dimensions axis, including in-line forces applied to the shaft (applicable as a load-cell). Explanation: Earlier magnetostriction sensor designs (for example from FAST Technology) have been limited to be sensitive in 2 dimensional axis only, and could not measure in-line forces.

Referring to FIG. 15, when torque is applied to the SH, the magnetic flux lines from both Counter-Circular magnetic loops are connecting to each other at the sensor region boundaries.

When mechanical torque stress is applied to the SH then the magnetic field will no longer run around in circles but tilt slightly in proportion to the applied torque stress. This will cause the magnetic field lines from one layer to connect to the magnetic field lines in the other layer, and with this form a toroidal shape.

Referring to FIG. 16, an exaggerated presentation is shown of how the magnetic flux line will form an angled toroidal structure when high levels of torque are applied to the SH.

In the following, features and benefits of the PCM-Encoding (PCME) Process will be described.

The magnetostriction NCT sensing technology from NCTE according to the present invention offers high performance sensing features like:
No mechanical changes required on the Sensor Host (already existing shafts can be used as they are)
Nothing has to be attached to the Sensor Host (therefore nothing can fall off or change over the shaft-lifetime=high MTBF)
During measurement the SH can rotate, reciprocate or move at any desired speed (no limitations on rpm)
Very good RSU (Rotational Signal Uniformity) performances
Excellent measurement linearity (up to 0.01% of FS)
High measurement repeatability
Very high signal resolution (better than 14 bit)
Very high signal bandwidth (better than 10 kHz)

Depending on the chosen type of magnetostriction sensing technology, and the chosen physical sensor design, the mechanical power transmitting shaft (also called “Sensor Host” or in short “SH”) can be used “as is” without making any mechanical changes to it or without attaching anything to the shaft. This is then called a “true” Non-Contact-Torque measurement principle allowing the shaft to rotate freely at any desired speed in both directions.

The here described PCM-Encoding (PCME) manufacturing process according to an exemplary embodiment of the present invention provides additional features no other magnetostriction technology can offer (Uniqueness of this technology):
More then three times signal strength in comparison to alternative magnetostriction encoding processes (like the “RS” process from FAST).
Easy and simple shaft loading process (high manufacturing through-putt).
No moving components during magnetic encoding process (low complexity manufacturing equipment=high MTBF, and lower cost).
Process allows NCT sensor to be “fine-tuning” to achieve target accuracy of a fraction of one percent.
Manufacturing process allows shaft “pre-processing” and “post-processing” in the same process cycle (high manufacturing through-putt).
Sensing technology and manufacturing process is ratio-metric and therefore is applicable to all shaft or tube diameters.
The PCM-Encoding process can be applied while the SH is already assembled (depending on accessibility) (maintenance friendly).
Final sensor is insensitive to axial shaft movements (the actual allowable axial shaft movement depends on the physical “length” of the magnetically encoded region).
Magnetically encoded SH remains neutral and has little to non magnetic field when no forces (like torque) are applied to the SH.
Sensitive to mechanical forces in all three dimensional axis.

In the following, the Magnetic Flux Distribution in the SH will be described.

The PCME processing technology is based on using electrical currents, passing through the SH (Sensor Host or Shaft) to achieve the desired, permanent magnetic encoding of the Ferro-magnetic material. To achieve the desired sensor performance and features a very specific and well controlled electrical current is required. Early experiments that used DC currents failed because of luck of understanding how small amounts and large amounts of DC electric current are travelling through a conductor (in this case the “conductor” is the mechanical power transmitting shaft, also called Sensor Host or in short “SH”).

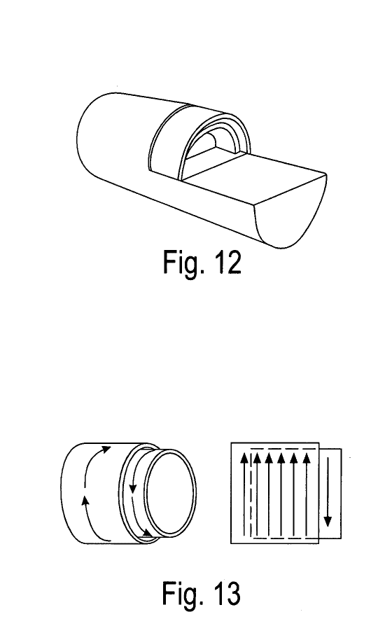

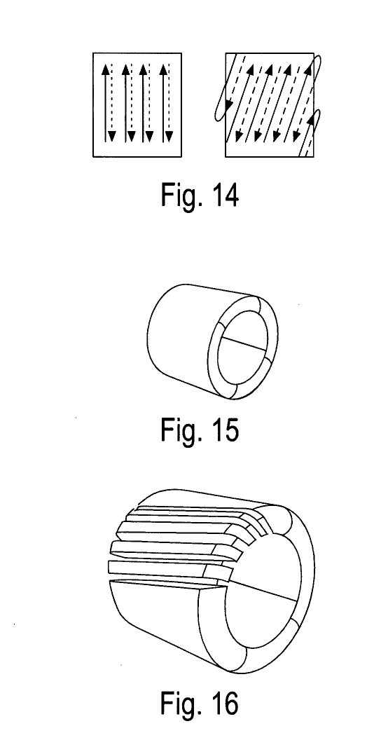

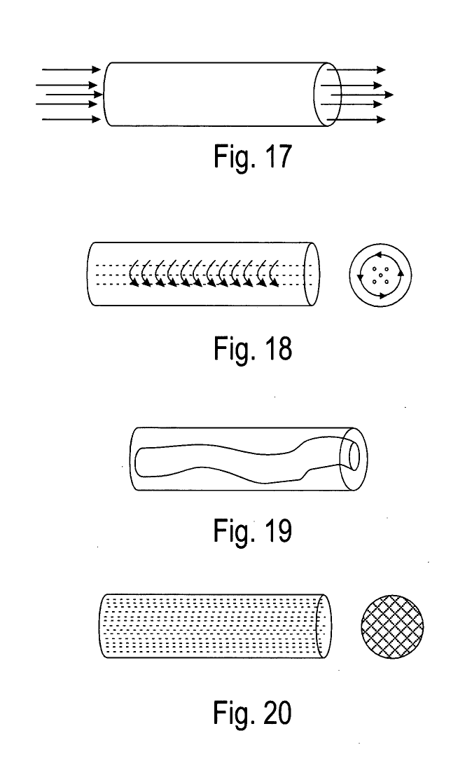

Referring to FIG. 17, an assumed electrical current density in a conductor is illustrated.

It is widely assumed that the electric current density in a conductor is evenly distributed over the entire cross-section of the conductor when an electric current (DC) passes through the conductor.

Referring to FIG. 18, a small electrical current forming magnetic field that ties current path in a conductor is shown.

It is our experience that when a small amount of electrical current (DC) is passing through the conductor that the current density is highest at the centre of the conductor. The two main reasons for this are: The electric current passing through a conductor generates a magnetic field that is tying together the current path in the centre of the conductor, and the impedance is the lowest in the centre of the conductor.

Referring to FIG. 19, a typical flow of small electrical currents in a conductor is illustrated.

In reality, however, the electric current may not flow in a “straight” line from one connection pole to the other (similar to the shape of electric lightening in the sky).

At a certain level of electric current the generated magnetic field is large enough to cause a permanent magnetization of the Ferro-magnetic shaft material. As the electric current is flowing near or at the centre of the SH, the permanently stored magnetic field will reside at the same location: near or at the centre of the SH. When now applying mechanical torque or linear force for oscillation/reciprocation to the shaft, then shaft internally stored magnetic field will respond by tilting its magnetic flux path in accordance to the applied mechanical force. As the permanently stored magnetic field lies deep below the shaft surface the measurable effects are very small, not uniform and therefore not sufficient to build a reliable NCT sensor system.

Referring to FIG. 20, a uniform current density in a conductor at saturation level is shown.

Only at the saturation level is the electric current density (when applying DC) evenly distributed at the entire cross section of the conductor. The amount of electrical current to achieve this saturation level is extremely high and is mainly influenced by the cross section and conductivity (impedance) of the used conductor.

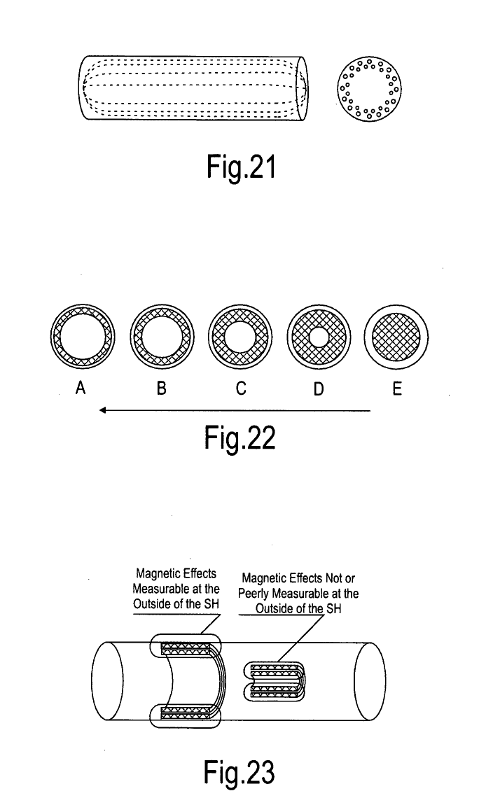

Referring to FIG. 21, electric current travelling beneath or at the surface of the conductor (Skin-Effect) is shown.

It is also widely assumed that when passing through alternating current (like a radio frequency signal) through a conductor that the signal is passing through the skin layers of the conductor, called the Skin Effect. The chosen frequency of the alternating current defines the “Location/position” and “depth” of the Skin Effect. At high frequencies the electrical current will travel right at or near the surface of the conductor (A) while at lower frequencies (in the 5 to 10 Hz regions for a 20 mm diameter SH) the electrical alternating current will penetrate more the centre of the shafts cross section (E). Also, the relative current density is higher in the current occupied regions at higher AC frequencies in comparison to the relative current density near the centre of the shaft at very low AC frequencies (as there is more space available for the current to flow through).

Referring to FIG. 22, the electrical current density of an electrical conductor (cross-section 90 deg to the current flow) when passing through the conductor an alternating current at different frequencies is illustrated.

The desired magnetic field design of the PCME sensor technology are two circular magnetic field structures, stored in two layers on top of each other (“Picky-Back”), and running in opposite direction to each other (Counter-Circular).

Again referring to FIG. 13, a desired magnetic sensor structure is shown: two endless magnetic loops placed on top of each other, running in opposite directions to each other: Counter-Circular “Picky-Back” Field Design.

To make this magnetic field design highly sensitive to mechanical stresses that will be applied to the SH (shaft), and to generate the largest sensor signal possible, the desired magnetic field structure has to be placed nearest to the shaft surface. Placing the circular magnetic fields to close to the centre of the SH will cause damping of the user available sensor-output-signal slope (most of the sensor signal will travel through the Ferro-magnetic shaft material as it has a much higher permeability in comparison to air), and increases the non-uniformity of the sensor signal (in relation to shaft rotation and to axial movements of the shaft in relation to the secondary sensor.

Referring to FIG. 23, magnetic field structures stored near the shaft surface and stored near the centre of the shaft are illustrated.

It may be difficult to achieve the desired permanent magnetic encoding of the SH when using AC (alternating current) as the polarity of the created magnetic field is constantly changing and therefore may act more as a Degaussing system.

The PCME technology requires that a strong electrical current (“uni-polar” or DC, to prevent erasing of the desired magnetic field structure) is travelling right below the shaft surface (to ensure that the sensor signal will be uniform and measurable at the outside of the shaft). In addition a Counter-Circular, “picky back” magnetic field structure needs to be formed.

It is possible to place the two Counter-Circular magnetic field structures in the shaft by storing them into the shaft one after each other. First the inner layer will be stored in the SH, and then the outer layer by using a weaker magnetic force (preventing that the inner layer will be neutralized and deleted by accident. To achieve this, the known “permanent” magnet encoding techniques can be applied as described in patents from FAST technology, or by using a combination of electrical current encoding and the “permanent” magnet encoding.

A much simpler and faster encoding process uses “only” electric current to achieve the desired Counter-Circular “Picky-Back” magnetic field structure. The most challenging part here is to generate the Counter-Circular magnetic field.

A uniform electrical current will produce a uniform magnetic field, running around the electrical conductor in a 90 deg angle, in relation to the current direction (A). When placing two conductors side-by-side (B) then the magnetic field between the two conductors seems to cancel-out the effect of each other (C). Although still present, there is no detectable (or measurable) magnetic field between the closely placed two conductors. When placing a number of electrical conductors side-by-side (D) the “measurable” magnetic field seems to go around the outside the surface of the “flat” shaped conductor.

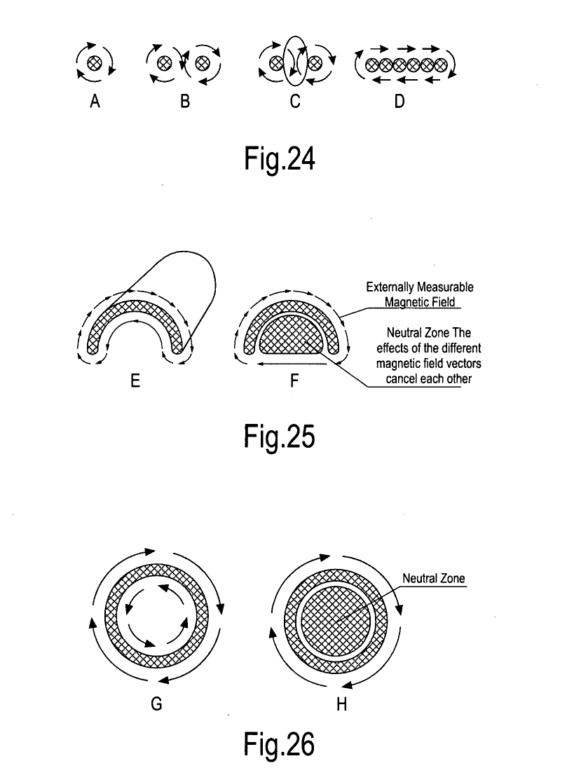

Referring to FIG. 24, the magnetic effects when looking at the cross-section of a conductor with a uniform current flowing through them are shown.

The “flat” or rectangle shaped conductor has now been bent into a “U”-shape. When passing an electrical current through the “U”-shaped conductor then the magnetic field following the outer dimensions of the “U”-shape is cancelling out the measurable effects in the inner halve of the “U”.

Referring to FIG. 25, the zone inside the “U”-shaped conductor seem to be magnetically “Neutral” when an electrical current is flowing through the conductor.

When no mechanical stress is applied to the cross-section of a “U”-shaped conductor it seems that there is no magnetic field present inside of the “U” (F). But when bending or twisting the “U”-shaped conductor the magnetic field will no longer follow its original path (90 deg angle to the current flow). Depending on the applied mechanical forces, the magnetic field begins to change slightly its path. At that time the magnetic-field-vector that is caused by the mechanical stress can be sensed and measured at the surface of the conductor, inside and outside of the “U”-shape. Note:

This phenomena is applies only at very specific electrical current levels. The same applies to the “O”-shaped conductor design. When passing a uniform electrical current through an “O”-shaped conductor (Tube) the measurable magnetic effects inside of the “O” (Tube) have cancelled-out each other (G).

Referring to FIG. 26, the zone inside the “O”-shaped conductor seem to be magnetically “Neutral” when an electrical current is flowing through the conductor.

However, when mechanical stresses are applied to the “O”-shaped conductor (Tube) it becomes evident that there has been a magnetic field present at the inner side of the “O”-shaped conductor. The inner, counter directional magnetic field (as well as the outer magnetic field) begins to tilt in relation to the applied torque stresses. This tilting field can be clearly sensed and measured.

In the following, an Encoding Pulse Design will be described.

To achieve the desired magnetic field structure (Counter-Circular, Picky-Back, Fields Design) inside the SH, according to an exemplary embodiment of a method of the present invention, unipolar electrical current pulses are passed through the Shaft (or SH). By using “pulses” the desired “Skin-Effect” can be achieved. By using a “unipolar” current direction (not changing the direction of the electrical current) the generated magnetic effect will not be erased accidentally.

The used current pulse shape is most critical to achieve the desired PCME sensor design. Each parameter has to be accurately and repeatable controlled: Current raising time, Constant current on-time, Maximal current amplitude, and Current falling time. In addition it is very critical that the current enters and exits very uniformly around the entire shaft surface.

In the following, a Rectangle Current Pulse Shape will be described.

Referring to FIG. 27, a rectangle shaped electrical current pulse is illustrated.

A rectangle shaped current pulse has a fast raising positive edge and a fast falling current edge. When passing a rectangle shaped current pulse through the SH, the raising edge is responsible for forming the targeted magnetic structure of the PCME sensor while the flat “on” time and the falling edge of the rectangle shaped current pulse are counter productive.

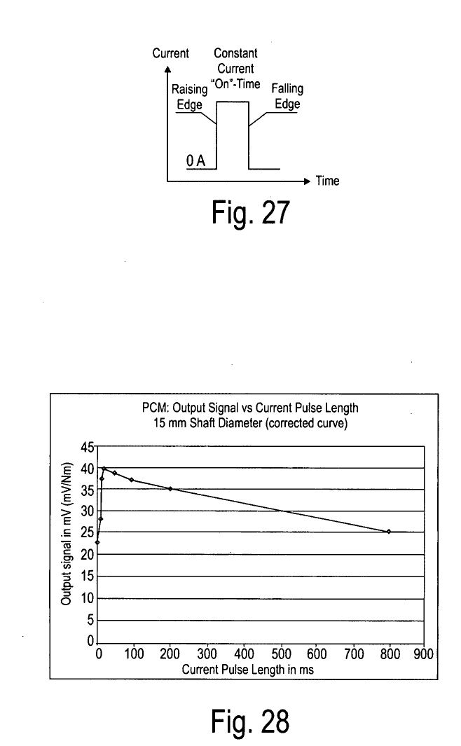

Referring to FIG. 28, a relationship between rectangles shaped Current Encoding Pulse-Width (Constant Current On-Time) and Sensor Output Signal Slope is shown.

In the following example a rectangle shaped current pulse has been used to generate and store the Couter-Circilar “Picky-Back” field in a 15 mm diameter, 14CrNi14 shaft. The pulsed electric current had its maximum at around 270 Ampere. The pulse “on-time” has been electronically controlled. Because of the high frequency component in the rising and falling edge of the encoding pulse, this experiment can not truly represent the effects of a true DC encoding SH. Therefore the Sensor-Output-Signal Slope-curve eventually flattens-out at above 20 mV/Nm when passing the Constant-Current On-Time of 1000 ms.

Without using a fast raising current-pulse edge (like using a controlled ramping slope) the sensor output signal slope would have been very poor (below 10 mV/Nm). Note: In this experiment (using 14CrNi14) the signal hysteresis was around 0.95% of the FS signal (FS=75 Nm torque).

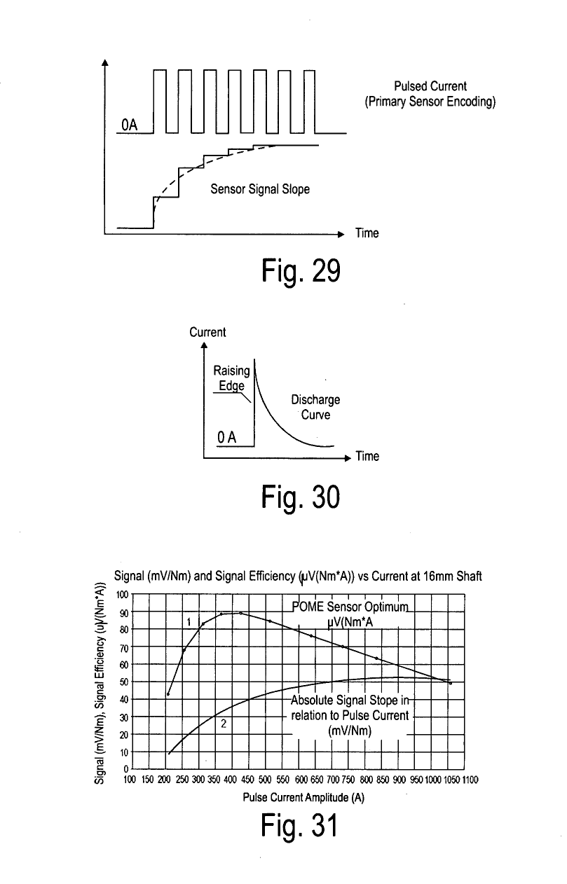

Referring to FIG. 29, increasing the Sensor-Output Signal-Slope by using several rectangle shaped current pulses in succession is shown.

The Sensor-Output-Signal slope can be improved when using several rectangle shaped current-encoding-pulses in successions. In comparisons to other encoding-pulse-shapes the fast falling current-pulse signal slope of the rectangle shaped current pulse will prevent that the Sensor-Output-Signal slope may ever reach an optimal performance level. Meaning that after only a few current pulses (2 to 10) have been applied to the SH (or Shaft) the Sensor-Output Signal-Slope will no longer rise.

In the following, a Discharge Current Pulse Shape is described.

The Discharge-Current-Pulse has no Constant-Current ON-Time and has no fast falling edge. Therefore the primary and most felt effect in the magnetic encoding of the SH is the fast raising edge of this current pulse type.

As shown in FIG. 30, a sharp raising current edge and a typical discharging curve provides best results when creating a PCME sensor.

Referring to FIG. 31, a PCME Sensor-Output Signal-Slope optimization by identifying the right pulse current is illustrated.

At the very low end of the pulse current scale (0 to 75 A for a 15 mm diameter shaft, 14CrNi14 shaft material) the “Discharge-Current-Pulse type is not powerful enough to cross the magnetic threshold needed to create a lasting magnetic field inside the Ferro magnetic shaft. When increasing the pulse current amplitude the double circular magnetic field structure begins to form below the shaft surface. As the pulse current amplitude increases so does the achievable torque sensor-output signal-amplitude of the secondary sensor system. At around 400 A to 425 A the optimal PCME sensor design has been achieved (the two counter flowing magnetic regions have reached their most optimal distance to each other and the correct flux density for best sensor performances.

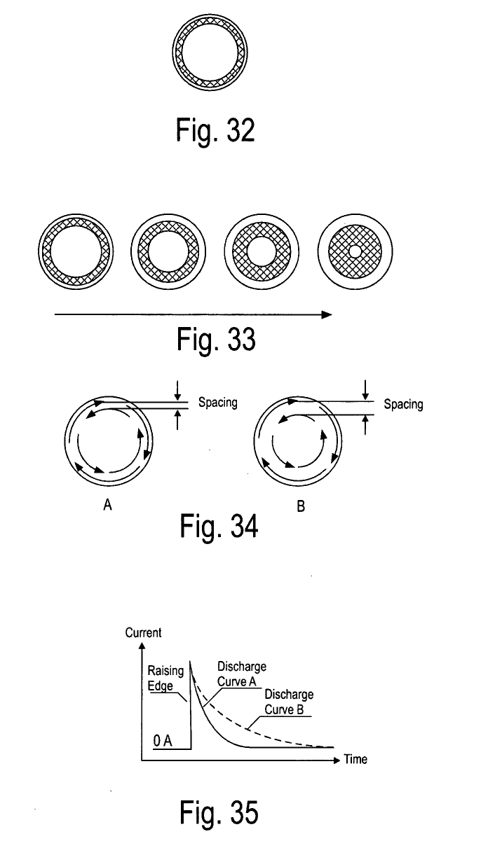

Referring to FIG. 32, Sensor Host (SH) cross section with the optimal PCME electrical current density and location during the encoding pulse is illustrated.

When increasing further the pulse current amplitude the absolute, torque force related, sensor signal amplitude will further increase (curve 2) for some time while the overall PCME-typical sensor performances will decrease (curve 1). When passing 900 A Pulse Current Amplitude (for a 15 mm diameter shaft) the absolute, torque force related, sensor signal amplitude will begin to drop as well (curve 2) while the PCME sensor performances are now very poor (curve 1).

Referring to FIG. 33, Sensor Host (SH) cross sections and the electrical pulse current density at different and increasing pulse current levels is shown.

As the electrical current occupies a larger cross section in the SH the spacing between the inner circular region and the outer (near the shaft surface) circular region becomes larger.

Referring to FIG. 34, better PCME sensor performances will be achieved when the spacing between the Counter-Circular “Picky-Back” Field design is narrow (A).

The desired double, counter flow, circular magnetic field structure will be less able to create a close loop structure under torque forces which results in a decreasing secondary sensor signal amplitude.

Referring to FIG. 35, flattening-out the current-discharge curve will also increase the Sensor-Output Signal-Slope.

When increasing the Current-Pulse discharge time (making the current pulse wider) (B) the Sensor-Output Signal-Slope will increase. However the required amount of current is very high to reduce the slope of the falling edge of the current pulse. It might be more practical to use a combination of a high current amplitude (with the optimal value) and the slowest possible discharge time to achieve the highest possible Sensor-Output Signal Slope.

In the following, Electrical Connection Devices in the frame of Primary Sensor Processing will be described.

The PCME technology (it has to be noted that the term ‘PCME’ technology is used to refer to exemplary embodiments of the present invention) relies on passing through the shaft very high amounts of pulse-modulated electrical current at the location where the Primary Sensor should be produced. When the surface of the shaft is very clean and highly conductive a multi-point Copper or Gold connection may be sufficient to achieve the desired sensor signal uniformity. Important is that the Impedance is identical of each connection point to the shaft surface. This can be best achieved when assuring the cable length (L) is identical before it joins the main current connection point (I).

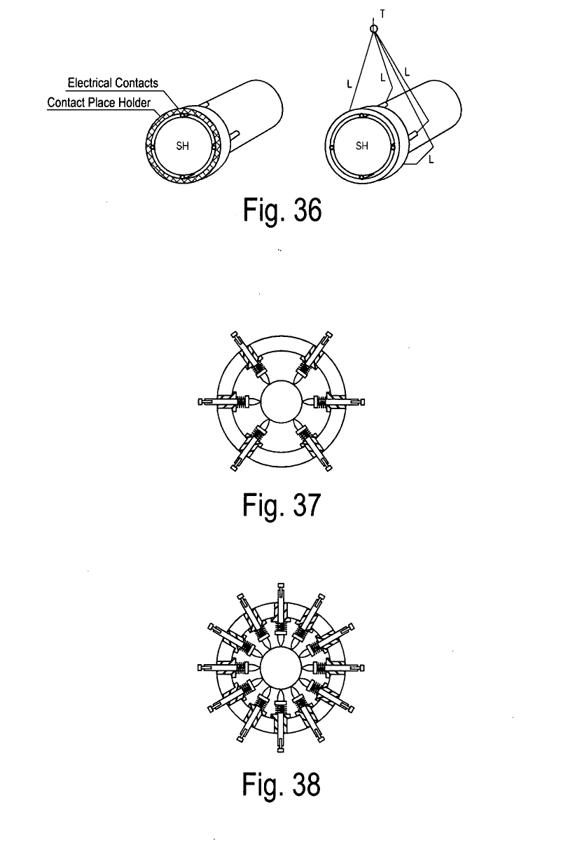

Referring to FIG. 36, a simple electrical multi-point connection to the shaft surface is illustrated.

However, in most cases a reliable and repeatable multi-point electrical connection can be only achieved by ensuring that the impedance at each connection point is identical and constant. Using a spring pushed, sharpened connector will penetrate possible oxidation or isolation layers (maybe caused by finger prints) at the shaft surface.

Referring to FIG. 37, a multi channel, electrical connecting fixture, with spring loaded contact points is illustrated.

When processing the shaft it is most important that the electrical current is injected and extracted from the shaft in the most uniform way possible. The above drawing shows several electrical, from each other insulated, connectors that are held by a fixture around the shaft. This device is called a Shaft-Processing-Holding-Clamp (or SPHC). The number of electrical connectors required in a SPHC depends on the shafts outer diameter. The larger the outer diameter, the more connectors are required. The spacing between the electrical conductors has to be identical from one connecting point to the next connecting point. This method is called Symmetrical-“Spot”-Contacts.

Referring to FIG. 38, it is illustrated that increasing the number of electrical connection points will assist the efforts of entering and exiting the Pulse-Modulated electrical current. It will also increase the complexity of the required electronic control system.

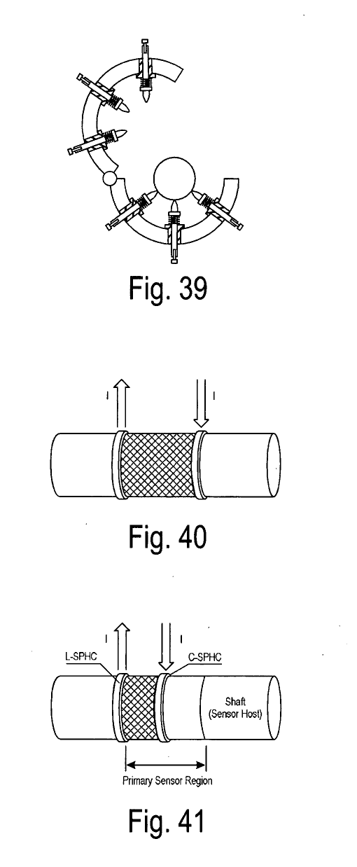

Referring to FIG. 39, an example of how to open the SPHC for easy shaft loading is shown.

In the following, an encoding scheme in the frame of Primary Sensor Processing will be described.

The encoding of the primary shaft can be done by using permanent magnets applied at a rotating shaft or using electric currents passing through the desired section of the shaft. When using permanent magnets a very complex, sequential procedure is necessary to put the two layers of closed loop magnetic fields, on top of each other, in the shaft. When using the PCME procedure the electric current has to enter the shaft and exit the shaft in the most symmetrical way possible to achieve the desired performances.

Referring to FIG. 40, two SPHCs (Shaft Processing Holding Clamps) are placed at the borders of the planned sensing encoding region. Through one SPHC the pulsed electrical current (I) will enter the shaft, while at the second SPHC the pulsed electrical current (I) will exit the shaft. The region between the two SPHCs will then turn into the primary sensor.

This particular sensor process will produce a Single Field (SF) encoded region. One benefit of this design (in comparison to those that are described below) is that this design is insensitive to any axial shaft movements in relation to the location of the secondary sensor devices. The disadvantage of this design is that when using axial (or in-line) placed MFS coils the system will be sensitive to magnetic stray fields (like the earth magnetic field).

Referring to FIG. 41, a Dual Field (DF) encoded region (meaning two independent functioning sensor regions with opposite polarity, side-by-side) allows cancelling the effects of uniform magnetic stray fields when using axial (or in-line) placed MFS coils. However, this primary sensor design also shortens the tolerable range of shaft movement in axial direction (in relation to the location of the MFS coils). There are two ways to produce a Dual Field (DF) encoded region with the PCME technology. The sequential process, where the magnetic encoded sections are produced one after each other, and the parallel process, where both magnetic encoded sections are produced at the same time.

The first process step of the sequential dual field design is to magnetically encode one sensor section (identically to the Single Field procedure), whereby the spacing between the two SPHC has to be halve of the desired final length of the Primary Sensor region. To simplify the explanations of this process we call the SPHC that is placed in the centre of the final Primary Sensor Region the Centre SPHC (C-SPHC), and the SPHC that is located at the left side of the Centre SPHC: L-SPHC.

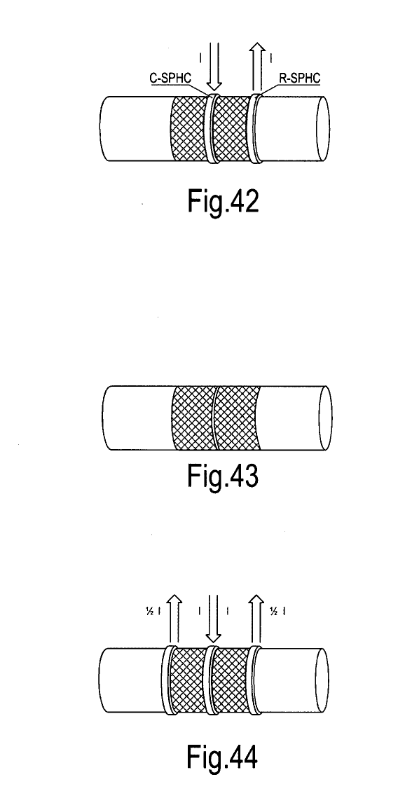

Referring to FIG. 42, the second process step of the sequential Dual Field encoding will use the SPHC that is located in the centre of the Primary Sensor region (called C-SPHC) and a second SPHC that is placed at the other side (the right side) of the centre SPHC, called R-SPHC. Important is that the current flow direction in the centre SPHC (C-SPHC) is identical at both process steps.

Referring to FIG. 43, the performance of the final Primary Sensor Region depends on how close the two encoded regions can be placed in relation to each other. And this is dependent on the design of the used centre SPHC. The narrower the in-line space contact dimensions are of the C-SPHC, the better are the performances of the Dual Field PCME sensor.

FIG. 44 shows the pulse application according to another exemplary embodiment of the present invention. As my be taken from the above drawing, the pulse is applied to three locations of the shaft. Due to the current distribution to both sides of the middle electrode where the current I is entered into the shaft, the current leaving the shaft at the lateral electrodes is only half the current entered at the middle electrode, namely ½ I. The electrodes are depicted as rings which dimensions are adapted to the dimensions of the outer surface of the shaft. However, it has to be noted that other electrodes may be used, such as the electrodes comprising a plurality of pin electrodes described later in this text.

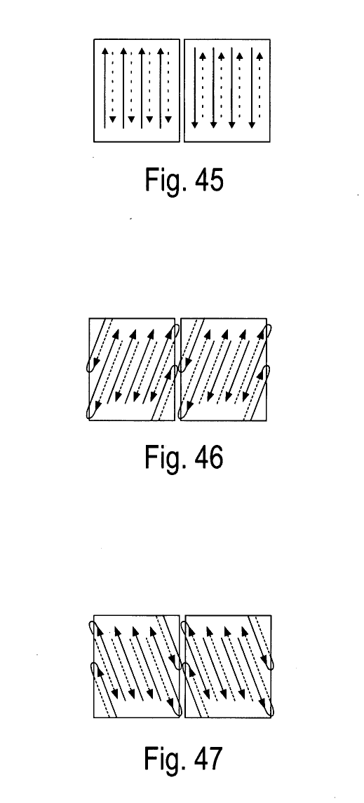

Referring to FIG. 45, magnetic flux directions of the two sensor sections of a Dual Field PCME sensor design are shown when no torque or linear motion stress is applied to the shaft. The counter flow magnetic flux loops do not interact with each other.

Referring to FIG. 46, when torque forces or linear stress forces are applied in a particular direction then the magnetic flux loops begin to run with an increasing tilting angle inside the shaft. When the tilted magnetic flux reaches the PCME segment boundary then the flux line interacts with the counterflowing magnetic flux lines, as shown.

Referring to FIG. 47, when the applied torque direction is changing (for example from clock-wise to counter-clock-wise) so will change the tilting angle of the counterflow magnetic flux structures inside the PCM Encoded shaft.

In the following, a Multi Channel Current Driver for Shaft Processing will be described.

In cases where an absolute identical impedance of the current path to the shaft surface can not be guaranteed, then electric current controlled driver stages can be used to overcome this problem.

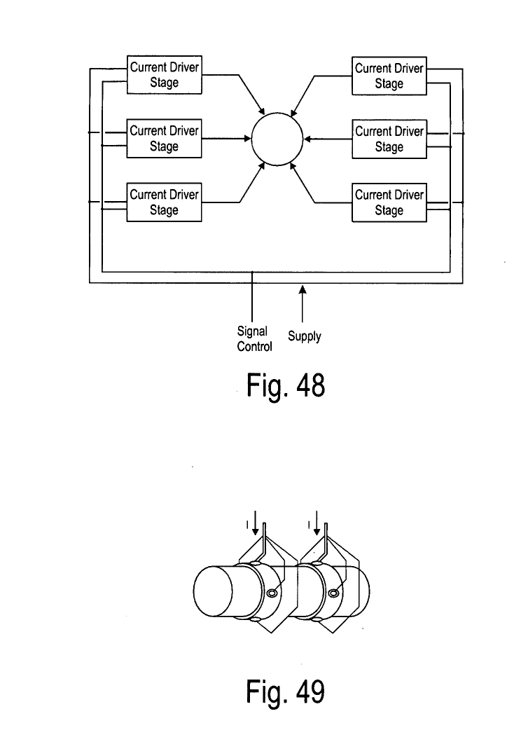

Referring to FIG. 48, a six-channel synchronized Pulse current driver system for small diameter Sensor Hosts (SH) is shown. As the shaft diameter increases so will the number of current driver channels.

In the following, Brass Ring Contacts and Symmetrical “Spot” Contacts will be described.

When the shaft diameter is relative small and the shaft surface is clean and free from any oxidations at the desired Sensing Region, then a simple “Brass”-ring (or Copper-ring) contact method can be chosen to process the Primary Sensor.

Referring to FIG. 49, brass-rings (or Copper-rings) tightly fitted to the shaft surface may be used, with solder connections for the electrical wires. The area between the two Brass-rings (Copper-rings) is the encoded region.

However, it is very likely that the achievable RSU performances are much lower then when using the Symmetrical “Spot” Contact method.

In the following, a Hot-Spotting concept will be described.

A standard single field (SF) PCME sensor has very poor Hot-Spotting performances. The external magnetic flux profile of the SF PCME sensor segment (when torque is applied) is very sensitive to possible changes (in relation to Ferro magnetic material) in the nearby environment. As the magnetic boundaries of the SF encoded sensor segment are not well defined (not “Pinned Down”) they can “extend” towards the direction where Ferro magnet material is placed near the PCME sensing region.

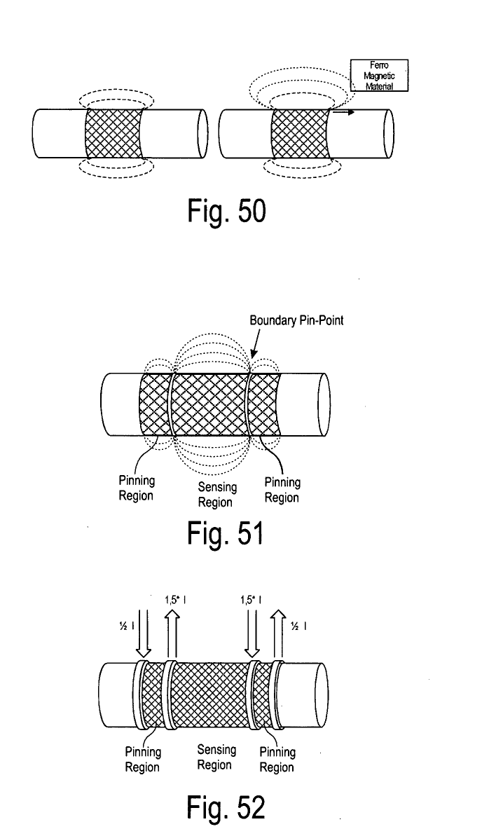

Referring to FIG. 50, a PCME process magnetized sensing region is very sensitive to Ferro magnetic materials that may come close to the boundaries of the sensing regions.

To reduce the Hot-Spotting sensor sensitivity the PCME sensor segment boundaries have to be better defined by pinning them down (they can no longer move).

Referring to FIG. 51, a PCME processed Sensing region with two “Pinning Field Regions” is shown, one on each side of the Sensing Region.

By placing Pinning Regions closely on either side the Sensing Region, the Sensing Region Boundary has been pinned down to a very specific location. When Ferro magnetic material is coming close to the Sensing Region, it may have an effect on the outer boundaries of the Pinning Regions, but it will have very limited effects on the Sensing Region Boundaries.

There are a number of different ways, according to exemplary embodiments of the present invention how the SH (Sensor Host) can be processed to get a Single Field (SF) Sensing Region and two Pinning Regions, one on each side of the Sensing Region. Either each region is processed after each other (Sequential Processing) or two or three regions are processed simultaneously (Parallel Processing). The Parallel Processing provides a more uniform sensor (reduced parasitic fields) but requires much higher levels of electrical current to get to the targeted sensor signal slope.

Referring to FIG. 52, a parallel processing example for a Single Field (SF) PCME sensor with Pinning Regions on either side of the main sensing region is illustrated, in order to reduce (or even eliminate) Hot-Spotting.

A Dual Field PCME Sensor is less sensitive to the effects of Hot-Spotting as the sensor centre region is already Pinned-Down. However, the remaining Hot-Spotting sensitivity can be further reduced by placing Pinning Regions on either side of the Dual-Field Sensor Region.

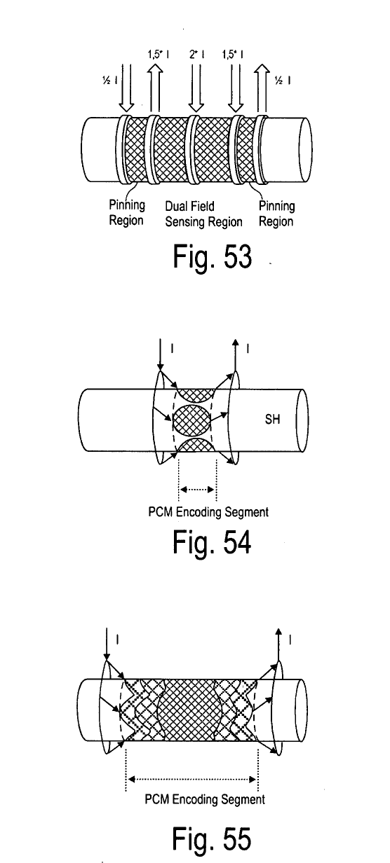

Referring to FIG. 53, a Dual Field (DF) PCME sensor with Pinning Regions either side is shown.

When Pinning Regions are not allowed or possible (example: limited axial spacing available) then the Sensing Region has to be magnetically shielded from the influences of external Ferro Magnetic Materials.

In the following, the Rotational Signal Uniformity (RSU) will be explained.

The RSU sensor performance are, according to current understanding, mainly depending on how circumferentially uniform the electrical current entered and exited the SH surface, and the physical space between the electrical current entry and exit points. The larger the spacing between the current entry and exit points, the better is the RSU performance.

Referring to FIG. 54, when the spacings between the individual circumferential placed current entry points are relatively large in relation to the shaft diameter (and equally large are the spacings between the circumferentially placed current exit points) then this will result in very poor RSU performances. In such a case the length of the PCM Encoding Segment has to be as large as possible as otherwise the created magnetic field will be circumferentially non-uniform.

Referring to FIG. 55, by widening the PCM Encoding Segment the circumferentially magnetic field distribution will become more uniform (and eventually almost perfect) at the halve distance between the current entry and current exit points. Therefore the RSU performance of the PCME sensor is best at the halve way-point between of the current-entry/current-exit points.

Next, the basic design issues of a NCT sensor system will be described.

Without going into the specific details of the PCM-Encoding technology, the end-user of this sensing technology need to now some design details that will allow him to apply and to use this sensing concept in his application. The following pages describe the basic elements of a magnetostriction based NCT sensor (like the primary sensor, secondary sensor, and the SCSP electronics), what the individual components look like, and what choices need to be made when integrating this technology into an already existing product.

In principle the PCME sensing technology can be used to produce a stand-alone sensor product. However, in already existing industrial applications there is little to none space available for a “stand-alone” product. The PCME technology can be applied in an existing product without the need of redesigning the final product.

In case a stand-alone torque sensor device or position detecting sensor device will be applied to a motor-transmission system it may require that the entire system need to undergo a major design change.

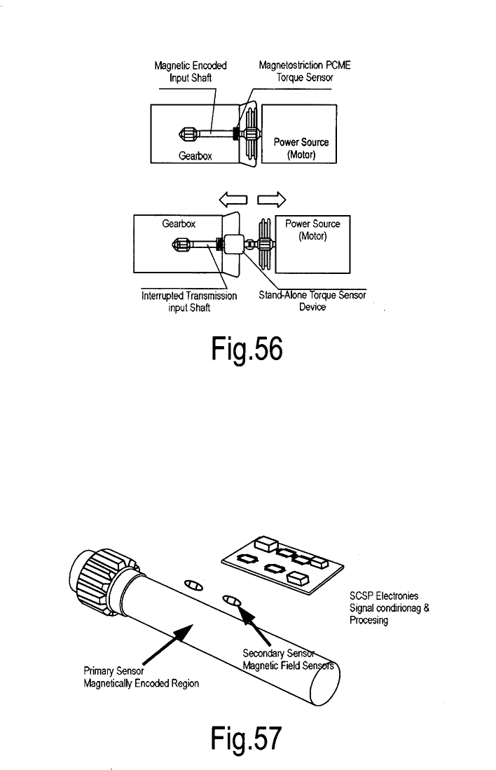

In the following, referring to FIG. 56, a possible location of a PCME sensor at the shaft of an engine is illustrated.

FIG. 56 shows possible arrangement locations for the torque sensor according to an exemplary embodiment of the present invention, for example, in a gear box of a motorcar. The upper portion of FIG. 56 shows the arrangement of the PCME torque sensor according to an exemplary embodiment of the present invention. The lower portion of the FIG. 56 shows the arrangement of a stand alone sensor device which is not integrated in the input shaft of the gear box as is in the exemplary embodiment of the present invention.

As may be taken from the upper portion of FIG. 56, the torque sensor according to an exemplary embodiment of the present invention may be integrated into the input shaft of the gear box. In other words, the primary sensor may be a portion of the input shaft. In other words, the input shaft may be magnetically encoded such that it becomes the primary sensor or sensor element itself. The secondary sensors, i.e. the coils, may, for example, be accommodated in a bearing portion close to the encoded region of the input shaft. Due to this, for providing the torque sensor between the power source and the gear box, it is not necessary to interrupt the input shaft and to provide a separate torque sensor in between a shaft going to the motor and another shaft going to the gear box as shown in the lower portion of FIG. 56.

Due to the integration of the encoded region in the input shaft it is possible to provide for a torque sensor without making any alterations to the input shaft, for example, for a car. This becomes very important, for example, in parts for an aircraft where each part has to undergo extensive tests before being allowed for use in the aircraft. Such torque sensor according to the present invention may be perhaps even without such extensive testing being corporated in shafts in aircraft or turbine since, the immediate shaft is not altered. Also, no material effects are caused to the material of the shaft.

Furthermore, as may be taken from FIG. 56, the torque sensor according to an exemplary embodiment of the present invention may allow to reduce a distance between a gear box and a power source since the provision of a separate stand alone torque sensor between the shaft exiting the power source and the input shaft to the gear box becomes obvious.

Next, Sensor Components will be explained.

A non-contact magnetostriction sensor (NCT-Sensor), as shown in FIG. 57, may consist, according to an exemplary embodiment of the present invention, of three main functional elements: The Primary Sensor, the Secondary Sensor, and the Signal Conditioning & Signal Processing (SCSP) electronics.

Depending on the application type (volume and quality demands, targeted manufacturing cost, manufacturing process flow) the customer can chose to purchase either the individual components to build the sensor system under his own management, or can subcontract the production of the individual modules.

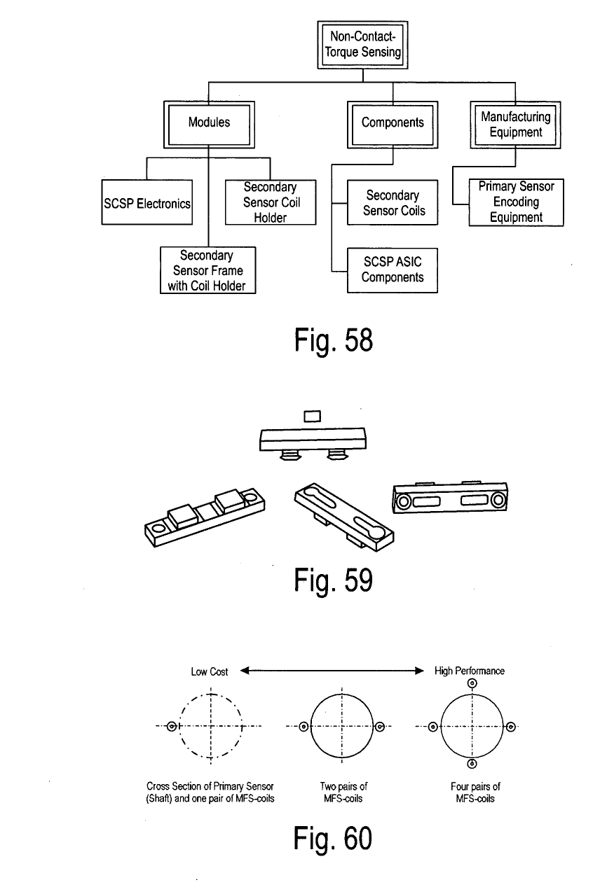

FIG. 58 shows a schematic illustration of components of a non-contact torque sensing device. However, these components can also be implemented in a non-contact position sensing device.

In cases where the annual production target is in the thousands of units it may be more efficient to integrate the “primary-sensor magnetic-encoding-process” into the customers manufacturing process. In such a case the customer needs to purchase application specific “magnetic encoding equipment”.

In high volume applications, where cost and the integrity of the manufacturing process are critical, it is typical that NCTE supplies only the individual basic components and equipment necessary to build a non-contact sensor:
ICs (surface mount packaged, Application-Specific Electronic Circuits)
MFS-Coils (as part of the Secondary Sensor)
Sensor Host Encoding Equipment (to apply the magnetic encoding on the shaft=Primary Sensor)

Depending on the required volume, the MFS-Coils can be supplied already assembled on a frame, and if desired, electrically attached to a wire harness with connector. Equally the SCSP (Signal Conditioning & Signal Processing) electronics can be supplied fully functional in PCB format, with or without the MFS-Coils embedded in the PCB.

FIG. 59 shows components of a sensing device.

As can be seen from FIG. 60, the number of required MFS-coils is dependent on the expected sensor performance and the mechanical tolerances of the physical sensor design. In a well designed sensor system with perfect Sensor Host (SH or magnetically encoded shaft) and minimal interferences from unwanted magnetic stray fields, only 2 MFS-coils are needed. However, if the SH is moving radial or axial in relation to the secondary sensor position by more than a few tenths of a millimeter, then the number of MFS-coils need to be increased to achieve the desired sensor performance.

In the following, a control and/or evaluation circuitry will be explained.

The SCSP electronics, according to an exemplary embodiment of the present invention, consist of the NCTE specific ICs, a number of external passive and active electronic circuits, the printed circuit board (PCB), and the SCSP housing or casing. Depending on the environment where the SCSP unit will be used the casing has to be sealed appropriately.

Depending on the application specific requirements NCTE (according to an exemplary embodiment of the present invention) offers a number of different application specific circuits:
Basic Circuit
Basic Circuit with integrated Voltage Regulator
High Signal Bandwidth Circuit
Optional High Voltage and Short Circuit Protection Device
Optional Fault Detection Circuit

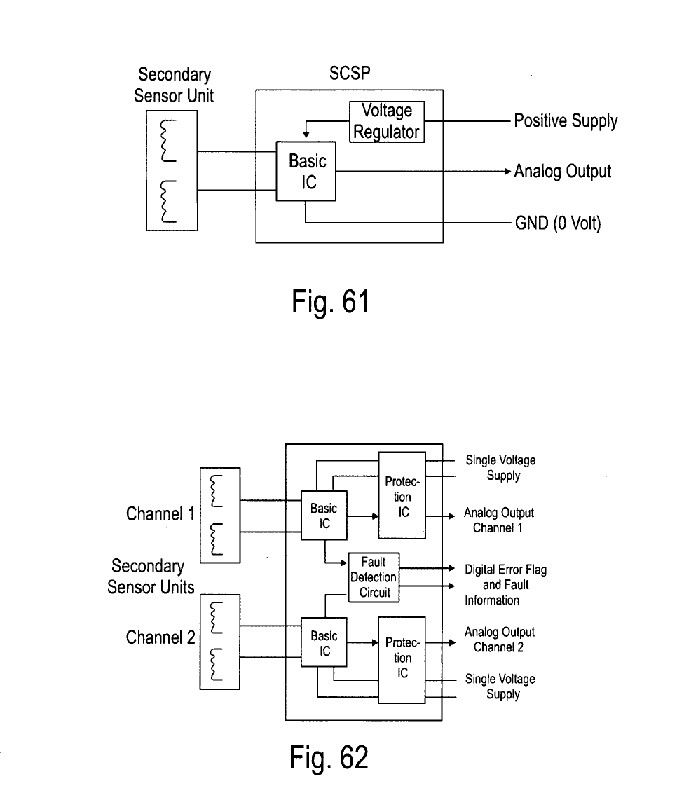

FIG. 61 shows a single channel, low cost sensor electronics solution.

As may be taken from FIG. 61, there may be provided a secondary sensor unit which comprises, for example, coils. These coils are arranged as, for example, shown in FIG. 60 for sensing variations in a magnetic field emitted from the primary sensor unit, i.e. the sensor shaft or sensor element when torque is applied thereto. The secondary sensor unit is connected to a basis IC in a SCST. The basic IC is connected via a voltage regulator to a positive supply voltage. The basic IC is also connected to ground. The basic IC is adapted to provide an analog output to the outside of the SCST which output corresponds to the variation of the magnetic field caused by the stress applied to the sensor element.

FIG. 62 shows a dual channel, short circuit protected system design with integrated fault detection. This design consists of 5 ASIC devices and provides a high degree of system safety. The Fault-Detection IC identifies when there is a wire breakage anywhere in the sensor system, a fault with the MFS coils, or a fault in the electronic driver stages of the “Basic IC”.

Next, the Secondary Sensor Unit will be explained.

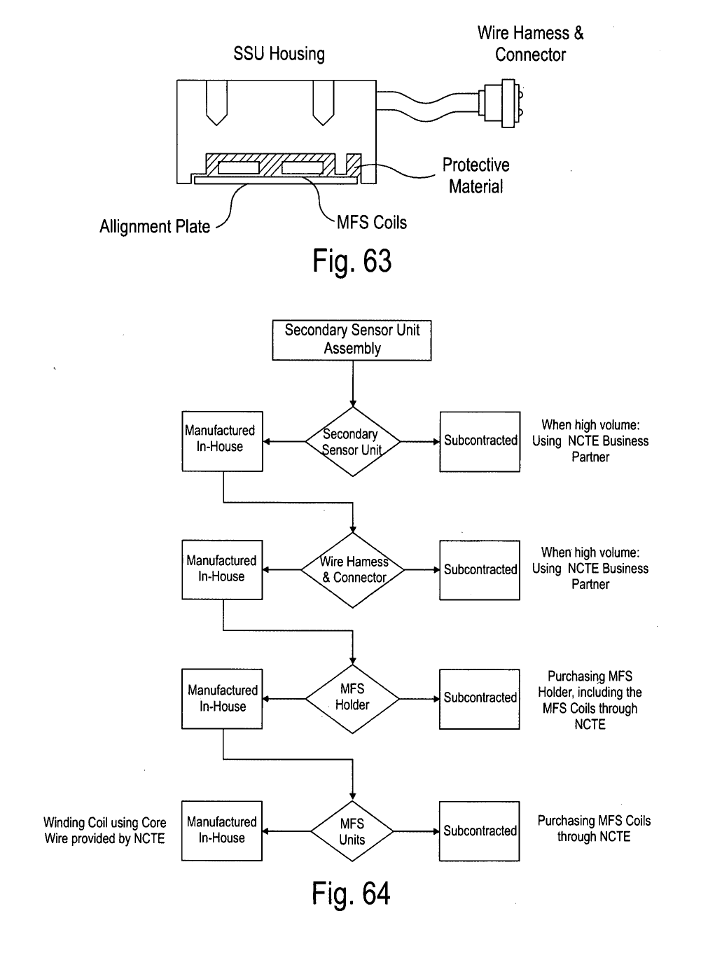

The Secondary Sensor may, according to one embodiment shown in FIG. 63, consist of the elements: One to eight MFS (Magnetic Field Sensor) Coils, the Alignment- & Connection-Plate, the wire harness with connector, and the Secondary-Sensor-Housing.

The MFS-coils may be mounted onto the Alignment-Plate. Usually the Alignment-Plate allows that the two connection wires of each MFS-Coil are soldered/connected in the appropriate way. The wire harness is connected to the alignment plate. This, completely assembled with the MFS-Coils and wire harness, is then embedded or held by the Secondary-Sensor-Housing.

The main element of the MFS-Coil is the core wire, which has to be made out of an amorphous-like material.

Depending on the environment where the Secondary-Sensor-Unit will be used, the assembled Alignment Plate has to be covered by protective material. This material can not cause mechanical stress or pressure on the MFS-coils when the ambient temperature is changing.

In applications where the operating temperature will not exceed +110 deg C. the customer has the option to place the SCSP electronics (ASIC) inside the secondary sensor unit (SSU). While the ASIC devices can operated at temperatures above +125 deg C. it will become increasingly more difficult to compensate the temperature related signal-offset and signal-gain changes.

The recommended maximal cable length between the MFS-coils and the SCSP electronics is 2 meters. When using the appropriate connecting cable, distances of up to 10 meters are achievable. To avoid signal-cross-talk in multi-channel applications (two independent SSUs operating at the same Primary Sensor location=Redundant Sensor Function), specially shielded cable between the SSUs and the SCSP Electronics should be considered.

When planning to produce the Secondary-Sensor-Unit (SSU) the producer has to decide which part/parts of the SSU have to be purchased through subcontracting and which manufacturing steps will be made in-house.

In the following, Secondary Sensor Unit Manufacturing Options will be described.

When integrating the NCT-Sensor into a customized tool or standard transmission system then the systems manufacturer has several options to choose from:
custom made SSU (including the wire harness and connector)
selected modules or components; the final SSU assembly and system test may be done under the customer's management.
only the essential components (MFS-coils or MFS-core-wire, Application specific ICs) and will produce the SSU in-house.

FIG. 64 illustrates an exemplary embodiment of a Secondary Sensor Unit Assembly.

Next, a Primary Sensor Design is explained.

The SSU (Secondary Sensor Units) can be placed outside the magnetically encoded SH (Sensor Host) or, in case the SH is hollow, inside the SH. The achievable sensor signal amplitude is of equal strength but has a much better signal-to-noise performance when placed inside the hollow shaft.

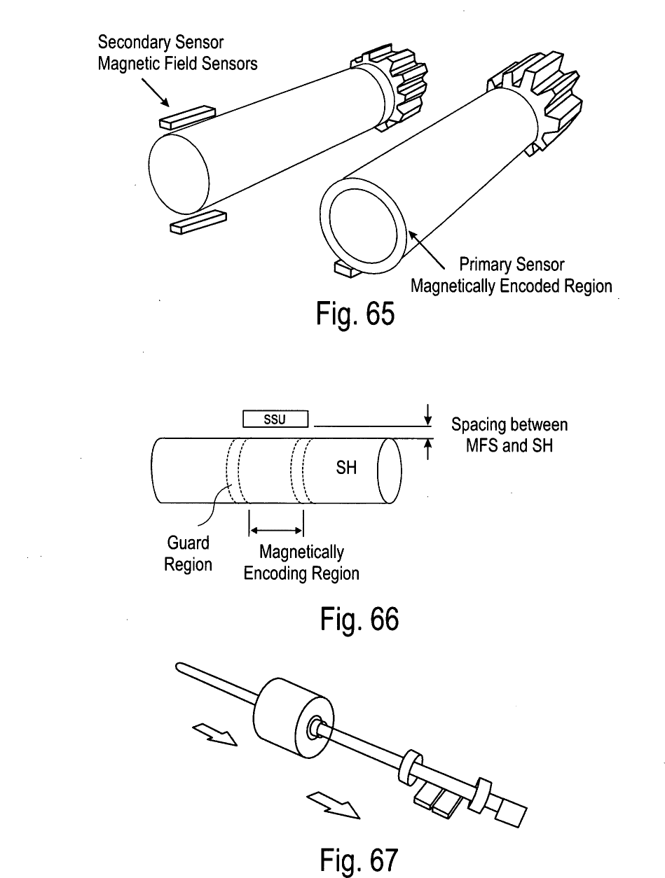

FIG. 65 illustrates two configurations of the geometrical arrangement of Primary Sensor and Secondary Sensor.

Improved sensor performances may be achieved when the magnetic encoding process is applied to a straight and parallel section of the SH (shaft). For a shaft with 15 mm to 25 mm diameter the optimal minimum length of the Magnetically Encoded Region is 25 mm. The sensor performances will further improve if the region can be made as long as 45 mm (adding Guard Regions). In complex and highly integrated transmission (gearbox) systems it will be difficult to find such space. Under more ideal circumstances, the Magnetically Encoding Region can be as short as 14 mm, but this bears the risk that not all of the desired sensor performances can be achieved.

As illustrated in FIG. 66, the spacing between the SSU (Secondary Sensor Unit) and the Sensor Host surface, according to an exemplary embodiment of the present invention, should be held as small as possible to achieve the best possible signal quality.

Next, the Primary Sensor Encoding Equipment will be described.

An example is shown in FIG. 67.

Depending on which magnetostriction sensing technology will be chosen, the Sensor Host (SH) needs to be processed and treated accordingly. The technologies vary by a great deal from each other (ABB, FAST, FT, Kubota, MDI, NCTE, RM, Siemens, . . . ) and so does the processing equipment required. Some of the available magnetostriction sensing technologies do not need any physical changes to be made on the SH and rely only on magnetic processing (MDI, FAST, NCTE).

While the MDI technology is a two phase process, the FAST technology is a three phase process, and the NCTE technology a one phase process, called PCM Encoding.

One should be aware that after the magnetic processing, the Sensor Host (SH or Shaft), has become a “precision measurement” device and has to be treated accordingly. The magnetic processing should be the very last step before the treated SH is carefully placed in its final location.

The magnetic processing should be an integral part of the customer's production process (in-house magnetic processing) under the following circumstances:
High production quantities (like in the thousands)
Heavy or difficult to handle SH (e.g. high shipping costs)
Very specific quality and inspection demands (e.g. defense applications)

In all other cases it may be more cost effective to get the SH magnetically treated by a qualified and authorized subcontractor, such as NCTE. For the “in-house” magnetic processing dedicated manufacturing equipment is required. Such equipment can be operated fully manually, semi-automated, and fully automated. Depending on the complexity and automation level the equipment can cost anywhere from EUR 20 k to above EUR 500 k.

Each of the aspects mentioned in the above description of FIG. 1 to FIG. 67 can be implemented in a position sensor device or in a position sensor array or in a washing machine or a method according to the invention.

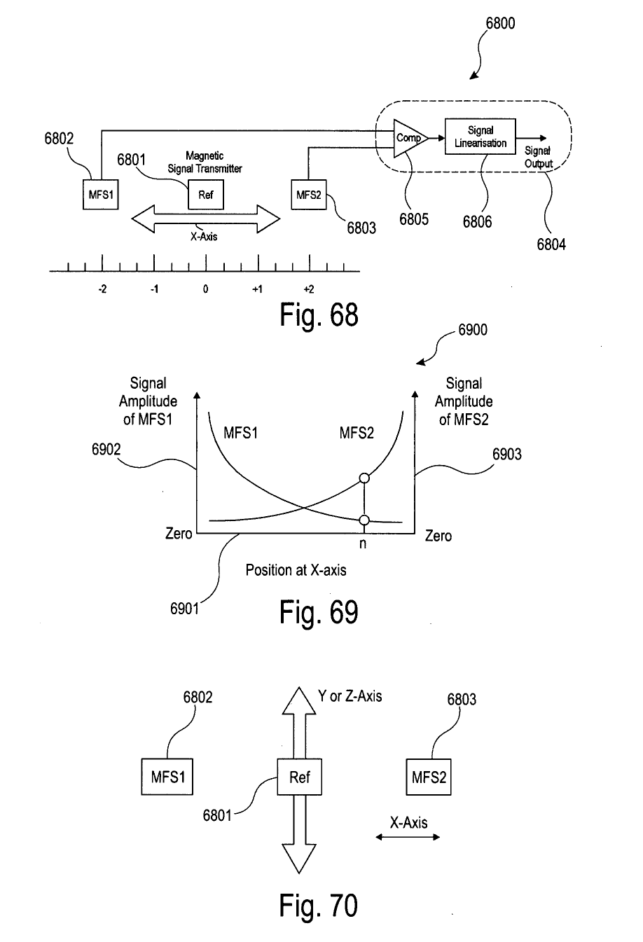

In the following, referring to FIG. 68, a position sensor device 6800 according to an embodiment of the invention will be described.

The position sensor device 6800 is adapted for determining a position of a movable object (not shown). The position sensor device 6800 comprises a magnetic field generating coil 6801 which is fixed on a movable object (not shown). A movable object can be, for instance, a reciprocating shaft of a concrete processing apparatus, a linearly moving shaft, or a rotating element, like a drum of a washing machine or a shaft of an engine.

The position sensor device 6800 further comprises a first magnetic field detector coil 6802 located at a first position and adapted to detect a first magnetic field signal characteristic for a magnetic field generated by the magnetic field generating coil 6801 at the first position. Further, the position sensor device 6800 comprises a second magnetic field detecting coil 6803 which is located at a second position (which differs from the first position) and which is adapted to detect a second magnetic field signal characteristic for a magnetic field generated by the magnetic field generating coil 6801 at the second position.

A position determining unit 6804 is adapted to determine the position of the magnetic field generating coil 6801 and thus of the movable object to which the magnetic field generating coil 6801 is fixed, based on a comparison of the first magnetic field signal and the second magnetic field signal. The position determining unit 6804 comprises a comparator 6805 which compares the first and the second magnetic field signal and provides at its output a difference signal. This difference signal is provided to a signal linearization unit 6806 which is adapted to generate a linear signal being characteristic for the position of the movable object based on the difference between the first magnetic field signal and the second magnetic field signal. This output signal is provided at an output of the position determining unit 6804 and encodes the current position of the magnetic field source 6801.

The non-contact position sensor device 6800 is based on the differential measurement of a magnetic signal emitted by the inductor 6801. When comparing the signals provided by the two receivers 6802, 6803, the difference of the signal amplitude allows to determine accurately the position of the signal transmitter 6801 along the x-axis in relation to the two receiver devices 6802, 6803.

As shown in FIG. 68, a one-dimensional, non-contact, linear position sensor 6800 is provided having implemented the two magnetic field sensors 6802, 6803 and the magnetic signal transmitter 6801. As the signal transmitter 6801 (which may also be denoted as a reference device) is moving closer to the second magnetic field detector 6803 on the right side of FIG. 68, so will the signal increase which signal is generated by the second magnetic field detector coil 6803. At the same time, a signal decrease is generated at the first magnetic field detector coil 6802. The comparator 6805 (which may also be a differential operating circuit) and the linearization circuit 6806 generate a linear output signal relating to the current position of the reference device 6801. The differential operating linear positioning sensor 6800, as shown in FIG. 68, provides accurate and useful signals, particularly when the signal transmitter 6801 remains in a range between the two receiver devices 6802, 6803.

In the following, referring to FIG. 69, a diagram 6900 will be described for illustrating the functionality of the position sensor device 6800.

The diagram 6900 comprises an abscissa 6901 along which a position of the magnetic field generating coil 6801 along the x-axis shown in FIG. 68 is plotted. Along a first ordinate 6902, the signal amplitude of the first magnetic field detector 6802 is plotted. Along a second ordinate 6903, the signal amplitude of the second magnetic field detector coil 6803 is plotted.

As can be derived from the diagram 6900, the signal ratio of the signals of the two magnetic field detection coils 6802, 6803 is unique at any given position “n”, and will only occur at ones at a specific location. Using a differential measurement method makes this solution insensitive to the absolute signal value of the signal transmitter 6801. For an accurate linear position measurement, it is sufficient to use only the signal ratio between the signals provided by the two magnetic field detector coils 6802, 6803.

As can be seen in FIG. 70, the position sensor device 6800 is not in each scenario very sensitive to movements of the signal transmitter 6801 in a direction perpendicular to the x-axis. However, since a motion along the y-axis or along the z-axis reduces the amplitude of both signals measured by the magnetic field detector coil 6802 and 6803, it is possible to determine a motion even along the y-axis or z-axis by evaluating the absolute values of the signals measured by the magnetic field detector coils 6802, 6803.

However, if the reference module 6801 is moving too far away from the magnetic field detector coil 6802, 6803, the signal-to-noise ratio will become smaller. The ideal x-axis line for the reference module 681 is what defines a shortest connection between the two magnetic field detector coils 6802, 6803.

The position sensor device 6800 works properly when the signal transmitter 6801 can either be a constant magnetic field source or an alternating magnetic field source. The advantage using an alternating magnetic field source is that such a solution is insensitive to other (constant) magnetic interferences, like the earth magnet field or magnetic fields created by an electric motor. Since such static influences can be separated from time varying influences of an alternating magnetic field source, the accuracy is improved, even when ferromagnetic objects come in closer proximity to the sensor system 6800.

Thus, by using an alternating magnetic field source, it is possible to make this type of linear position sensing insensitive to interfering magnetic fields. Further, when using a constant permanent magnetic field source, this allows that the linear position sensor system 6800 functions with an almost unlimited signal bandwidth.

The available frequency spectrum for the system according to the invention is very wide, and may range particularly from sub-Hertz to upper radio frequency values. Assuming that a selected target application (like a washing machine weight measurement, or washing machine drum balance sensor to prevent a “hopping” of the washing machine when spinning the drum a high speed) requires a position sensor signal bandwidth from less than 100 Hz, for instance, then the transmitter frequency of the reference module 6801 is applicable to any other, also higher frequency range.

To further improve the linear position sensor performance according to the invention, the signal transmitter frequency can be generated by the sensor electronics. In such a case, the sensor signal conditioning electronics and signal processing electronics know exactly what signals to expect and to look for when monitoring the signals from the magnetic field detector coils 6802, 6803. A benefit of such a solution is that the linear position sensor according to the invention becomes insensitive to electric component tolerances or the potential effects of changing operating temperature.

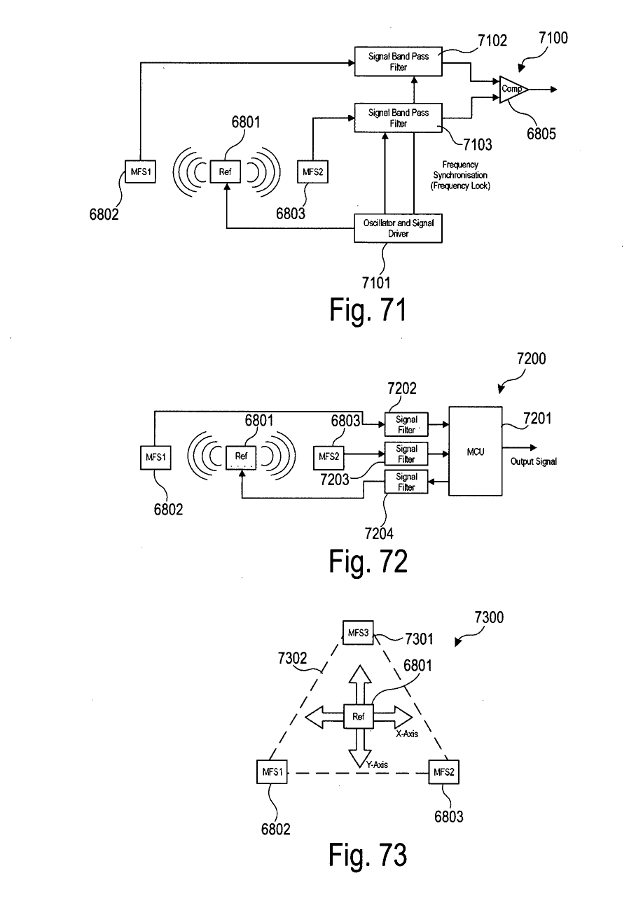

In the following, referring to FIG. 71, a position sensor device 7100 according to an embodiment of the invention will be described.

The position sensor device 7100 comprises an oscillator and signal driver unit 7101 which is adapted to provide the magnetic field generating coil 6801 with a driver signal for generating a magnetic field in accordance with the driver signal. The oscillator and signal driver unit 7101 is simultaneously adapted to filter the first magnetic field signal and the second magnetic field signal generated by the first and second magnetic field detector coils 6802, 6803 in accordance with the driver signal. In other words, the oscillator and signal driver unit 7101 generates an alternating signal supplied to the magnetic field generating coil 6801 so that the magnetic field generating coil 6801 provides an alternating magnetic field, that is a time varying magnetic field. Consequently, this time dependence results in a time dependence of the signals detected by the first and second magnetic field detector coils 6802, 6803. A frequency synchronization is achieved by control commands which the oscillator and signal driver unit 7101 provides to a first signal band pass filter 7102 and to a second signal band pass filter 7103. The signal received by the first magnetic field detector coil 6802 is band pass filtered by the first signal band pass filter 7102, and the signal detected by the second magnetic field detector coil 6803 is filtered by the second signal band pass filter 7103. The output of the two signal band pass filters 7102, 7103 are provided to inputs of the comparator 6805. This allows that, at an output of the comparator 6805, a signal is provided which accurately encodes the position of the magnetic field generating coil 6801.

The signal transmitter 6801 is powered, according to the embodiment shown in FIG. 71, by a specific or known frequency or pulse spectrum. In such a case, the signal receiver electronics can specifically look out for this frequency or pulse spectrum. The solution shown in FIG. 71 is even more resilient to interfering signals or the otherwise potential effects of changing operating temperatures.

FIG. 72 shows a position sensor device 7200 according to an embodiment of the invention, in which a microcontroller unit 7201 is provided. Further, first to third signal filter units 7202 to 7204 are provided. When using a microcontroller 7201, the synchronization between the reference module 6801 and the signals of the first and second magnetic field detecting coils 6802, 6803 and the signal filters 7202 to 7204 are easily and simply controllable by a computer programme (that means by software), allowing to construct the position sensor device 7200 in a small, simple and effective manner. However, the system can alternatively be realized as a pure analog electronic solution.

The position measurement process can also be triggered by a simple pulse signal that is generated by the microcontroller unit 7201. Since the microcontroller unit 7201 knows the exact timing when the reference module 6801 will the signal burst (electromagnetic pulse), the microcontroller 7201 knows what to look for at the two signal receiver inputs. The solution shown in FIG. 72 is very resilient to almost any type of interference from the sensor environment.

In the following, referring to FIG. 73, a position sensor device 7300 according to an exemplary embodiment of the invention will be described.

The position sensor array 7300 comprises, in addition to the first and to the second magnetic field detecting coils 6802, 6803, a third magnetic field detecting coil 7301, wherein the position sensor device 7300 is realized as a two-dimensional linear position sensor.

The position sensor device 7300 thus comprises a third magnetic field detector coil 7301 located at a third position and adapted to detect a third magnetic field signal characteristic for a magnetic field generated by the magnetic field generating coil 6801 at the third position. The position determining unit (not shown in FIG. 73) is adapted to determine the position of the magnetic field generating coil 6801 based on the first magnetic field signal, the second magnetic field signal and the third magnetic field signal. The magnetic field generating coil 6801 is arranged essentially symmetrically and essentially in the center of gravity of the three magnetic field detector coils 6802, 6803 and 7301. Further, the first magnetic field detector 6802, the second magnetic field detector 6803 and the third magnetic field detector 7301 are arranged in a plane, namely the paper plane of FIG. 73, in which also the magnetic field generating coil 6801 is positions in its equilibrium state. The three magnetic field detector coils 6802, 6803 and 7301 are arranged on corners of an equilateral triangle 7302.

As shown in FIG. 73, when adding a third magnetic field detection coil 7301 and placing it symmetrically to the first and second magnetic field detector coils 6802, 6803, it is relatively easy to compute the exact position of the signal transmitter 6801.

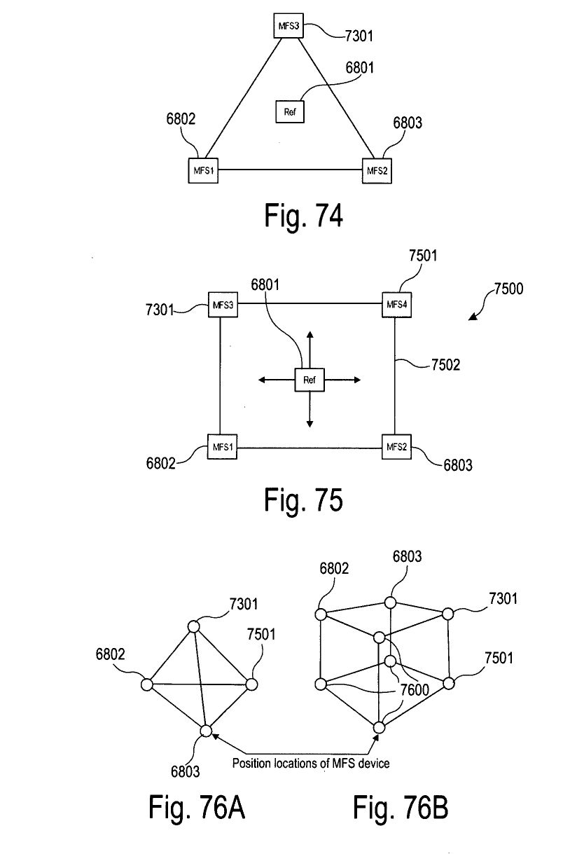

As can be seen in FIG. 74, to ensure that the signal computation of the magnetic field detector coils 6802, 6803 and 7301 results in an accurate position information, the reference module 6801 should remain preferably in the area inside of the MFS grid, that is to say within the triangle 7302.

The comparison of the signal amplitude ratio between the signals measured by the first and the second magnetic field detector coils 6802, 6803 will result in the x-axis position of the reference module 6801. The comparison of the signal amplitude ratio between the first and the third magnetic field detector coils 6802, 7301 will result in the y-axis vector position of the reference module 6801. There are also several mathematical solutions known by the persons skilled in the art which are available to calculate the exact position of the reference module 6801, for instance by triangulation.

The range of movement freedom for the reference module 6801 can be increased by either increasing the spacing between the magnetic field detector coils 6802, 6803, 7301 or by adding another magnetic field detector coil. Increasing the spacing between the magnetic field detector coils 6802, 6803, 7301 will require that the reference module 6801 transmitter signal power has to be increased as well to ensure that the signal-to-noise-ratio does not become too poor.

In the following, referring to FIG. 75, a position sensor device 7500 according to another embodiment of the invention will be described.

In addition to the position sensor device 7300 shown in FIG. 73, FIG. 74, the position sensor device 7500 comprises a forth magnetic field detector coil 7501 located at a forth position and adapted to detect a forth magnetic field signal characteristic for a magnetic field generated by the magnetic field generating coil 6801 at the forth position. The position determining unit (not shown) of the position sensor device 7500 is adapted to determine the position of the magnetic field generating coil 6800 based on the first magnetic field signal, the second magnetic field signal, the third magnetic field signal and the forth magnetic field signal. As can be seen in FIG. 75, the magnetic field generating coil 6801 is arranged essentially symmetrically and essentially in the center of gravity of the four magnetic field detector coils 6802, 6803, 7301, 7501 which are arranged in a single plane, namely in the paper plane of FIG. 75. The four magnetic field detector coils 6802, 6803, 7301, 7501 are arranged on the corners of a square 7502. Arranging the magnetic field detector coils 6802, 6803, 7301, 7501 in a quadratic grid provides a large area for the reference module 6801 to move in and simplifies the signal computation.

For a three-dimensional position sensor, it is possible to add a third measurement dimension by placing magnetic field detector coils appropriately, that is in a three-dimensional manner, or by allowing the three-dimensional sensor system to use the reference module signal amplitude as the indicator of the third axis, for instance the z-axis position.

FIG. 76a shows a geometrical architecture in which the four magnetic field detection coils 6802, 6803, 7301, 7501 are arranged on the corners of a tetrahedron. For instance, the magnetic field generating coil 6801 may be arranged in the center of gravity of the tetrahedron shown in FIG. 76a.

In FIG. 76b, an arrangement is shown, in which the magnetic field detection coils 6802, 6803, 7301, 7501, and further magnetic field detection coils 7600 are arranged on corners of a cube.

By relying fully on the method of reference module signal ratio computation, a three-dimensional linear position sensor as shown in FIG. 76a or in FIG. 76b can be built by placing magnetic field detector coils around the area of the reference module which may move within this area. FIG. 76a and FIG. 76b show two possible examples of such a configuration. According to such a configuration, the position determining unit of the position sensor device is adapted to determine the position of the magnetic field generating coil only based on the difference of the magnetic field signals, not taking into account information related to an amplitude of the signals.

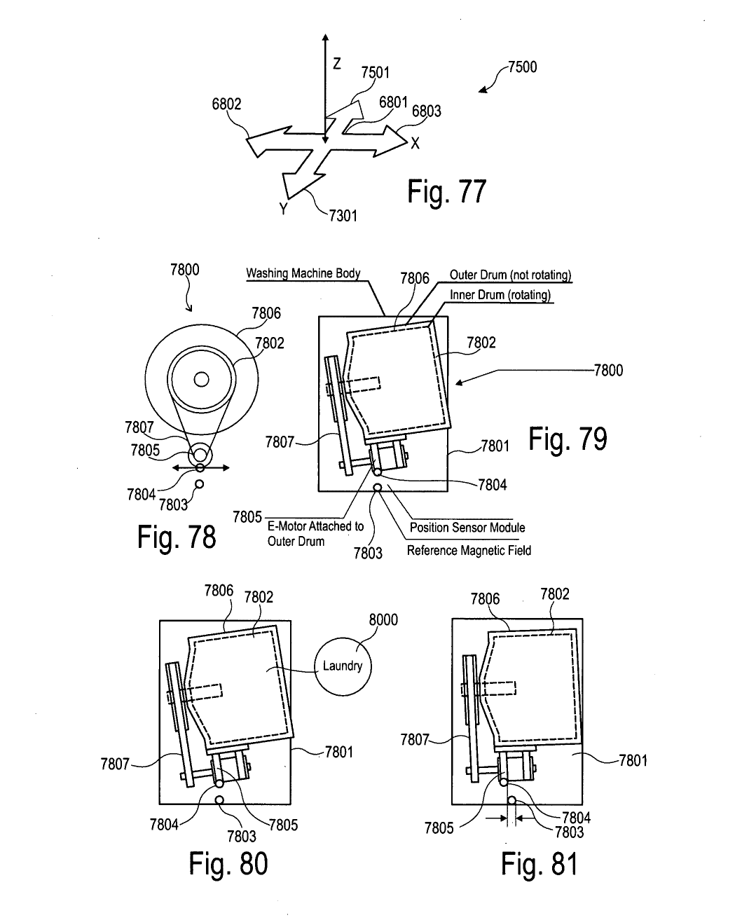

In contrast to this embodiment, referring to FIG. 77, a position sensor device 7500 will be described in which also amplitude information is used to measure the position in a three-dimensional manner with a planar array of magnetic field detection coils.

According to the position sensor device 7500, four magnetic field detector coils 6802, 6803, 7301, 7501 are provided in a planar manner in the xy-plane. The magnetic field generation coil 6801 is placed, in an equilibrium state, in the center of gravity of the magnetic field detector coils 6802, 6803, 7301, 7501 arranged on corners of a quadratic area. Further, for a motion of the magnetic field generating coil 6801 in a direction perpendicular to the xy-plane, that is along the z-axis, the position determining unit is adapted to determine a position of the magnetic field generating coil 6801 based on a difference of the magnetic field signals detected by the magnetic field detector coils 6802, 6803, 7301, 7501, and additionally based on an amplitude of these magnetic field signals.

While the movement of the reference module 6801 along the x-axis and y-axis is identified through a signal ratio measurement (comparing signals of the magnetic field detector coils 6802, 6803, 7301, 7501), the z-axis position is identified by using the signal amplitude. The signal amplitudes are strongest when the reference module 6801 is moving towards the plane in which the magnetic field detector coils 6802, 6803, 7301, 7501 are placed. The signal amplitude will weaken when the magnetic field generation coil 6801 moves away from this plane in the z-direction (either above the plane or below the plane, see FIG. 77).

In the following, referring to FIG. 78 to FIG. 81, a washing machine 7800 according to an exemplary embodiment of the invention will be described.

FIG. 78 shows a front view, and FIG. 79 shows a side view of the washing machine 7800.

The washing machine 7800 comprises a static support housing 7801. Further, the washing machine 7800 comprises a rotatable drum 7802 which is adapted to rotate with respect to the static support housing 7801 and which is adapted to receive laundry to be washed.

Further, the washing machine 7800 comprises a position sensor device for determining a position of the rotatable drum 7802. The position sensor device comprises a magnetic field generating coil 7803 which is adapted to generate a magnetic field, for instance a static magnetic field or an alternating magnetic field. A magnetic field detector coil 7804 is adapted to detect a magnetic field signal being characteristic for a magnetic field generated by the magnetic field generating coil 7803. A position determining unit (not shown in FIG. 78 to FIG. 81) is adapted to determine a position of the rotatable drum 7802 based on the magnetic field signal.

As shown in FIG. 79, the magnetic field detector coil 7804 is attached to an electromotor 7805 which is attached to an outer non-rotating drum 7806. The inner drum 7802 may be rotated by means of the electromotor 7805 via a fan belt 7807. Thus, FIG. 78 to FIG. 81 show an implementation of a 3D position sensor system according to the invention in a washing machine 7800. The position of the magnetic field generating coil 7803 and of the magnetic field detector coil 7804 can be exchanged. In other words, the magnetic field generating device 7803 may be attached to the electromotor 7805, and the magnetic field detector coil 7804 may be attached to the housing 7801. Further, more than one magnetic field detecting coils 7804 can be provided.

FIG. 80 illustrates a scenario in which laundry 8000 is filled within the inner drum 7802 of the washing machine 7800. When placing the load 8000 into the washing machine 7800 drum 7802 (like three kg of laundry), then the drum 7802 will pivot down (slightly rotate or roll forwards towards the opening) in relation to the load 8000. Therefore, the relative position between the reference module 7803 and the magnetic field detection coil 7804 will change in relation to the pivoting of the drum 7802 (see FIG. 81). Consequently, the signal measured by the magnetic field detecting coil 7804 will be modified in accordance with the position change. This allows to calculate the position of the drum 7802 in the load containing state and further allows to measure which weight has been applied to the drum 7802. This information can be taken as a basis for a decision, how the drum 7802 should be rotated, which amount of detergent is appropriate, how long the washing procedure will take, etc.

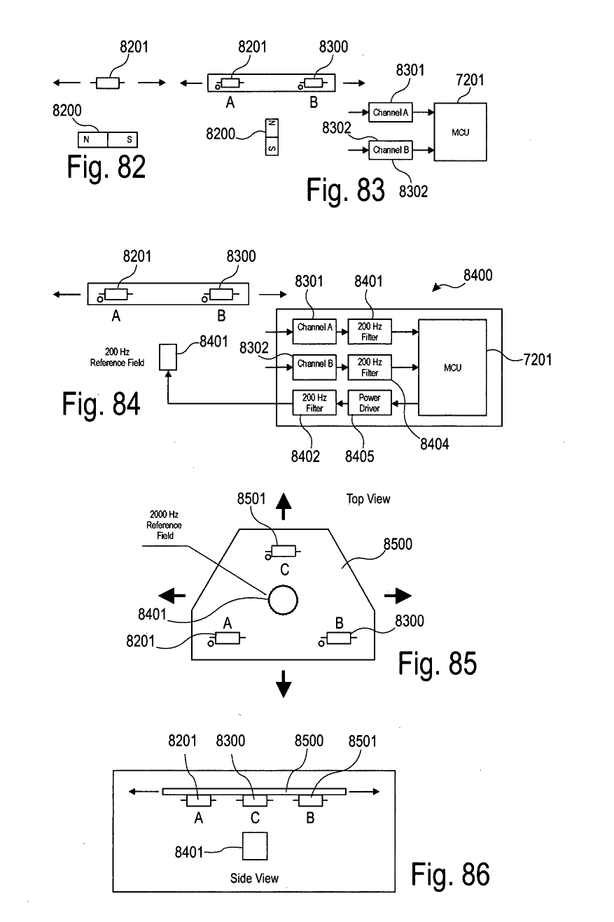

FIG. 82 shows a single channel solution of a position sensor device implementing a permanent magnet 8200 as a magnetic field generator which generates a magnetic field at the position of a single magnetic field detection coil 8201. When moving along a particular direction, as shown in FIG. 82, the magnetic field detection coil 8201 senses a different magnetic field strength, since its position with respect of the permanent magnet 8200 changes.

The position sensor device according to FIG. 82 may or may not be implemented in a washing machine.

Further, as shown in FIG. 83, the permanent magnet 8200 can also be implemented in a configuration in which a first magnetic field detection coil 8201 is supplemented by a second magnetic field detection coil 8300. Then, the signal detected by the first magnetic field detection coil 8201 is passed to a channel A electronics 8301 and from there to a microcontroller unit 7201. The signal detected by the second magnetic field detector coil 8300 is provided to a channel B electronics 8302 and from there to the microcontroller 7201.

The advantage of the configuration shown in FIG. 83 is a reduced sensitivity to interfering magnetic fields, like the earth magnet field. The configuration of FIG. 83 is not sensitive to reference signal amplitude changes (changes in the spacing between the magnetic field detection coils 8201, 8300 and the permanent magnet 8200).

FIG. 84 shows a position sensor device 8400 according to an exemplary embodiment of the invention.

In the position sensor device 8400, the permanent magnet 8200 of FIG. 83 is replaced by a magnetic field generating coil 8401. A microcontroller 8201 controls a power driver 8405 coupled with a 200 Hz filter 8402 to provide the magnetic field generating coil 8401 with corresponding command signals encoding the manner as to how the magnetic field generating coil 8401 produces the magnetic field. The generated magnetic signals are detected by the magnetic field detecting coils 8201 and 8300 and are provided to channel units 8301 and 8302, respectively. After having passed 200 Hz filters 8403, 8404, the signals are provided to the microcontroller 7201 for further processing.

Thus, FIG. 84 shows an example of using magnetic field detection coils 8201, 8300 combined with a microcontroller 7201 controlled magnetic field generating coil 8401. FIG. 84 is a more sophisticated solution compared to FIG. 83, wherein FIG. 83 is an example of using magnetic field detection coils 8201, 8300 in a permanent magnetic field source 8200 to produce a simple position sensor. The embodiment of FIG. 84 is absolutely insensitive to any interfering magnetic field sources. The embodiment shown in FIG. 84 is further insensitive to reference signal amplitude changes.

In the following, referring to FIG. 85, FIG. 86, a top view (FIG. 85) and a side view (FIG. 86) of the physical design of a position sensor device according to the invention will be described.

Particularly, FIG. 85 shows the physical design of a device holder 8500 holding the magnetic field detector coils 8201, 8300, and a third magnetic field detector coil 8501.

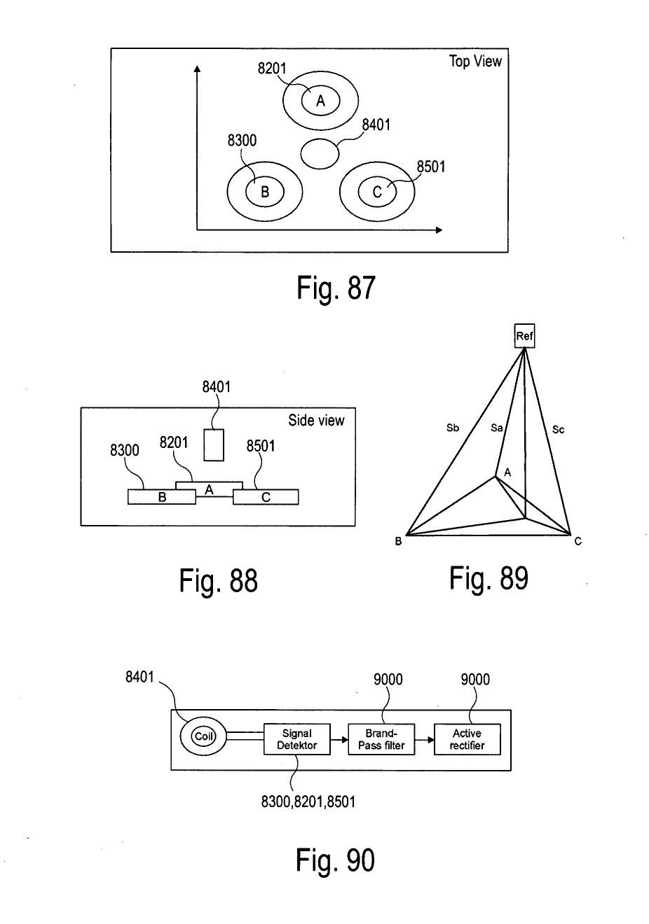

FIG. 87 and FIG. 88 show another geometry for a position sensor device according to an exemplary embodiment of the invention.

FIG. 87 and FIG. 88 are related to a sensor principle which is based on detecting and measuring the differential signal caused by a 2000 Hz sine wave from an inductor 8401. As reference device 8401, a 10 mH coil with ferromagnetic core is used, and as measurement coils 8201, 8300, 8501, coils are used which have a diameter of 40 mm.

The signal on the measurement coils 8201, 8300, 8501 is back proportional to a square of the distance between the reference device 8401 and the measurement coil center. For any position of the reference device 8401, the coordinates of the measurement coils 8201, 8300 and 8501 are known. Further, the distances between the measurement coils 8201, 8300, 8501 and the reference device 8401 is known.

In the following, a calculation according to the system shown in FIG. 87 and FIG. 88 is explained, based on the geometry shown in FIG. 89.

The distances between measurement coils are assumed to be identical and to be 42 mm. The coordinates of the coil A is (Xa, Ya, Za) (for example (21, 36.7, 0)), coil B (Xb, Yb, Zb) (for instance (0, 0, 0)) and coil C (Xc, Yc, Zc) (for instance (0, 42, 0)). The coordinate of the reference device is (Xref, Yref, Zref).

As the result of a measurement, the distances between reference device and measurement coils are known.

The mathematic formula for the distance between reference device and coil A is

Sₐ=\sqrt{(x_{ref}−xₐ)²+(y_{ref}−yₐ)²+(z_{ref}−zₐ)²},

for coil B and C

S_{b}=\sqrt{(x_{ref}−x_{b})²+(y_{ref}−y_{b})²+(z_{ref}−z_{b})²},

S_{c}=\sqrt{(x_{ref}−x_{c})²+(y_{ref}−y_{c})²+(z_{ref}−z_{c})²},

Since the coordinates of points A, B, C are known, the system of equation can be written down:

$$\begin{matrix}{S}_{a} = \sqrt{{( {x}_{ref} - 0 )}^{2} + {( {y}_{ref} - 0 )}^{2} + {( {z}_{ref} - 0 )}^{2}} \\ {S}_{b} = \sqrt{{( {x}_{ref} - 42 )}^{2} + {( {y}_{ref} - 0 )}^{2} + {( {z}_{ref} - 0 )}^{2}} \\ {S}_{a} = \sqrt{{( {x}_{ref} - 21 )}^{2} + {( {y}_{ref} - 36.7 )}^{2} + {( {z}_{ref} - 0 )}^{2}}\end{matrix} \}$$

Solving it, results in

$${S}_{a}^{2} - {S}_{b}^{2} = {x}_{ref}^{2} - {( {x}_{ref} - 42 )}^{2}$$

$${S}_{a}^{2} - {S}_{b}^{2} = 84 {x}_{ref} - 1764$$

$${x}_{ref} = \frac{{S}_{a}^{2} - {S}_{b}^{2} + 1764}{84}$$

In a similar manner, y_{ref} and z_{ref} may be calculated.

FIG. 90 illustrates an electronics scheme of a position sensor array according to an embodiment of the invention.

When the coil 8401 generates a magnetic field, this magnetic field can be detected by the signal detectors 8200, 8300, 8501. The signals received by these magnetic field detector coils 8200, 8300, 8501 are band pass filtered by a band pass filter 9000, and the result of this filtering is provided to an active rectifier unit 9001.

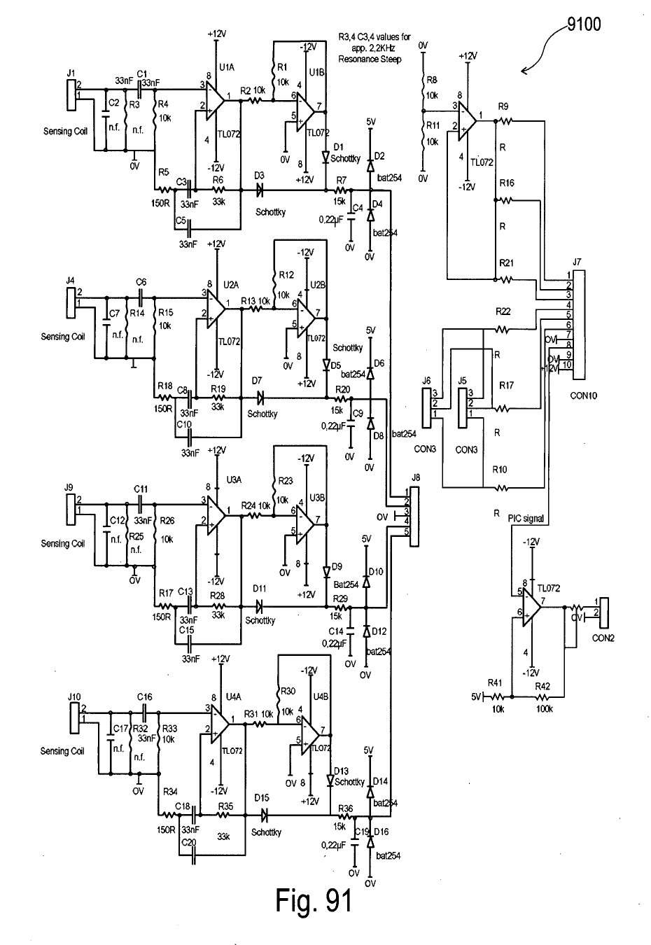

FIG. 91 illustrates a circuit array of a position sensor device according to an exemplary embodiment of the invention.

The reference device is driven by square wave from PIC. U8B is changing the signal from range 0 to 5 Volt to −12 to +12 Volt. The forth channel needs not to be used. The signal bandwidth and noise rejection is limited only by band pass filter and reference coil clock. For Germany, a frequency range of 9 to 10 kHz is appropriate.

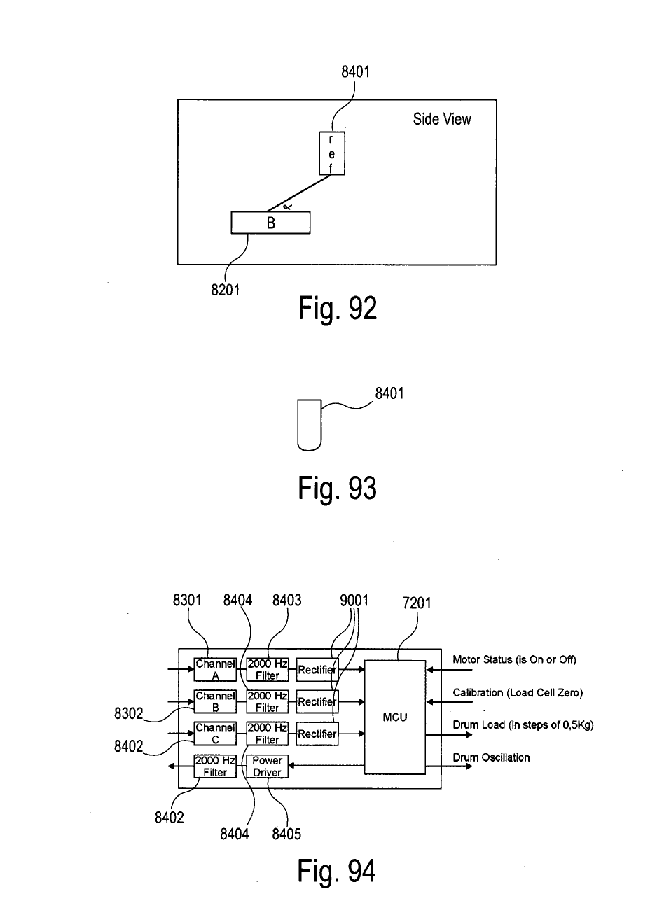

FIG. 92 illustrates that the signal is proportional not only to the distance between reference coil 8401 and measurement coil 8201, but depends on the angle α. To improve this situation, the reference coil 8401 can be provided with a round core end, as shown in FIG. 93.

FIG. 94 shows a scheme for electronics for three channels, that is for three magnetic field detecting coils.

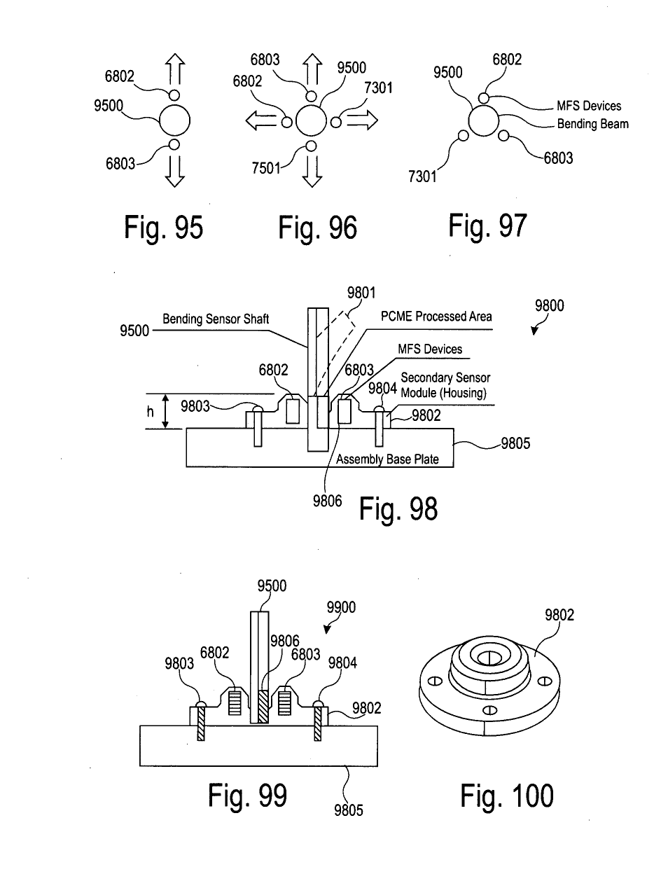

The position sensor device according to the invention can also be implemented in the frame of measuring bending forces applied to beams, wherein the position of a part of the beam is changed due to a bending force. The physical design of a bending and mechanical force sensor according to the invention will now be described referring to FIG. 95 to FIG. 100.

The non-contact force measurement technology described herein can be easily applied to already existing mechanical devices with an either permanently mounted in a fixture or into devices that rotate or move. In both cases, the sensing beam needs to be magnetically processed at a short region where the bending forces are expended to occur (in many cases this will be near of at the location where the bending shaft is mounted into an assembly base plate).

FIG. 95 to FIG. 97 show three different geometries and illustrate a bending beam 9500 which can be bended in a manner as will be described referring to FIG. 98.

FIG. 95 shows a position sensor array for detecting the position of the bending beam 9500, in which two magnetic field detection coils 6802, 6803 are arranged in a linear manner, wherein the bending beam 9500 is located between the two magnetic field detecting coils 6802, 6803. In other words, the system according to FIG. 95 is sensitive to a one-axis bending of the bending beam 9500.

In the case of FIG. 96, a two-axis sensitivity is achieved by providing two additional magnetic field detection coils 7301, 7501, so that the bending beam 9500 is located at the center of gravity of the four magnetic field detection coils 6802, 6803, 7301, 7501 arranged on the corners of a planar square.

FIG. 97 shows a configuration with three magnetic field detection coils 6802, 6803, 7301, wherein the bending beam 9500 is, in an equilibrium state, located in the center of gravity of a triangle formed by the magnetic field detection coils 6802, 6803, 7301. Thus, FIG. 96 and FIG. 97 each show a two-axis sensitivity system. The bending beam 9500 has, as will be described in the following, a magnetic field source which causes magnetic field signals in the magnetic field detecting coils 6802, 6803, 7301, 7501.

In the vicinity of the magnetically processed sensing regions of the bending beam 9500, magnetic field detecting coils are placed. When the objective is to detect bending in a one-dimensional axis only, then two magnetic field detection coils 6802, 6803 can be implemented, as shown in FIG. 95, wherein the magnetic field detecting coils 6802, 6803 are placed opposite to each other. When bending shall be measured in a two-dimensional manner, then four magnetic field detecting coils, as shown in FIG. 96, provide good results and are placed preferably every 90° around the bending shaft 9500. However, as shown in FIG. 97 alternative designs are possible, for instance using three magnetic field detecting coils to measure bending in a two-dimensional manner, depending on the expected sensor performance and the allowed complexity of the required electronics.

FIG. 98 illustrates a position sensor array 9800 according to an embodiment of the invention.

The bending sensor shaft 9500 is shown in a non-bended state and in a bended state 9801. The position sensor array 9800 has a PCME-processed area (that is a magnetically encoded region, see particularly FIG. 1 to FIG. 67 and corresponding description), that is to say a magnetic field source 9806 provided within the sensor shaft 9500. Magnetic field detection coils 6802, 6803 are provided within a housing 9802. Via screws 9803, 9804, the housing 9802 having included therein the magnetic field detection coils 6802, 6803 can be fixed with an assembly base plate 9805.

The above described PCME technology allows to process already existing shafts, as long they are made of ferromagnetic steel or other kind of magnetizable material. The PCME processed area 9806 is an area which generates a magnetic field at the position of the magnetic field detection coils 6802, 6803. The housing 9802 can be injection moulded and is the home of the magnetic field detection coils 6802, 6803. The material used for the housing 9802 should be non-magnetic. For example, the housing may be placed symmetrically nearest to the PCME processed sensing region 9806.

FIG. 99 shows an alternative geometry of a position sensor array 9900 wherein the bending sensor beam 9500 is fixed with the sensor housing 9802. In this case, the sensor beam 9500 and the sensor housing 9802 become one complete bending sensor module. If required, the sensor electronics can be integrated into the base 9805 of the sensor housing.

FIG. 100 shows a three-dimensional view of the sensor housing 9802.

The PCME technology allows manufacturing almost any type of mechanical sensing device (bending, torque and load) with very low costs. The PCME sensors can be used even under harshest conditions and functions in air/gases, in water-based liquids, and in oil. As long as the bending beam is not mechanically damaged, the sensor keeps its calibration settings and is essentially maintenance-free.

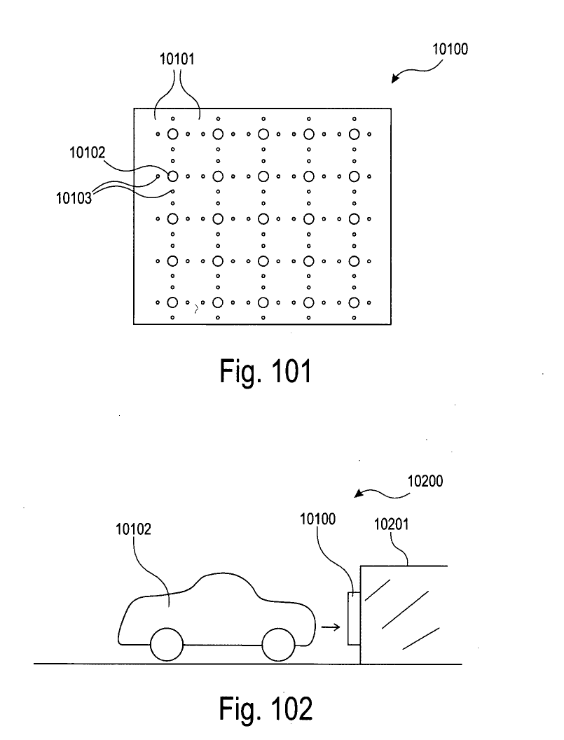

In the following, referring to FIG. 101, a sensor arrangement 10100 according to an exemplary embodiment of the invention will be described.

The two-dimensional sensor arrangement 10100 comprises a substrate 10101 and a plurality of sensor devices arranged on the substrate 10100 in a matrix-like pattern. Each of the sensor devices comprises a bending shaft 10102 (which may be similar to the bending shaft 9500 shown in FIG. 98, FIG. 99) having a magnetically encoded region (for instance a permanent magnet or a PCME encoded region) and four magnetic field detection coils 10103. The arrangement is similar to FIG. 96, but may also be similar to that of FIG. 95 or FIG. 97. The sensor arrangement 10100 is adapted to detect a spatial pattern of a pressure and/or bending load applied to the plurality of position sensor devices.

FIG. 102 shows a scenario in which the sensor arrangement 10100 according to FIG. 101 can be used.

The sensor arrangement 10100 is adapted as a crash test sensor arrangement. As can be seen in FIG. 102, the sensor arrangement 10100 is screwed onto a wall 1020. A test car 10202 is directed towards the sensor arrangement 10100 on the wall 10201. When the test car 10202 impinges on the sensor arrangement 10100 on the wall 10201 to simulate a crash, then a specific pressure force and bending force pattern acts upon each of the sensors of the sensor arrangement 10100 on the wall 10201. Thus, it is possible to spatially resolve the pressure and bending forces acting upon the sensor arrangement 10100 when the car 10202 crashes against the wall 10201.

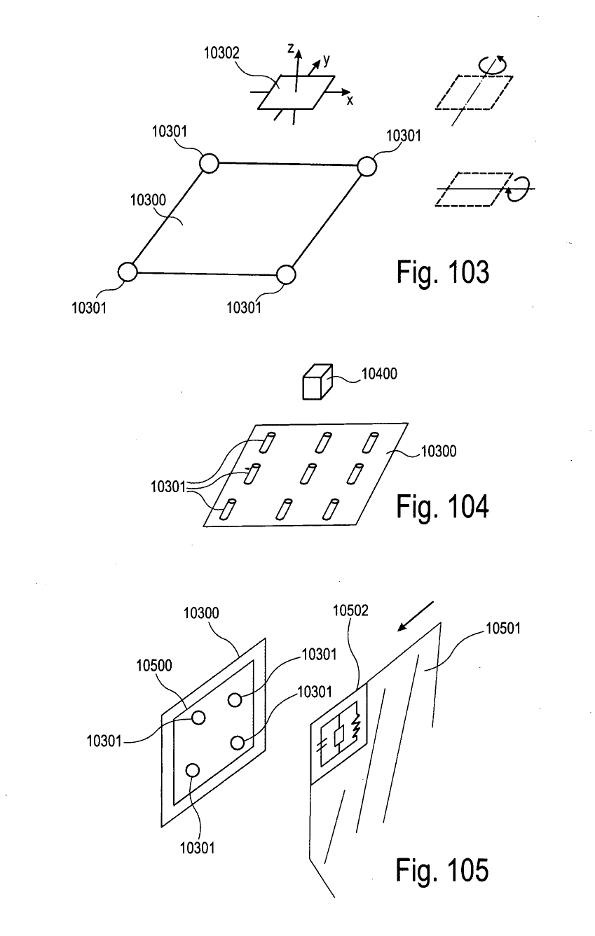

FIG. 103 shows a sensor arrangement having a base member 10300 of a rectangular shape, wherein four magnetic field detection devices 10301 are provided at the four corners of the base member 10300. The base member 10300 may be provided as a fixed support of a washing machine.

Although not shown in FIG. 103, a magnetic field generating coil 10302 is attached to a rotatable drum of the washing machine. When the drum rotates, the magnetic field generation coil 10302 moves with the rotatable drum and emits a magnetic field signal when it passes the magnetic field detectors 10301. This signal may be detected by each of the magnetic field detectors 10301 with an amplitude and a time dependence which is characteristic for the relative position of the magnetic field detectors 10301 with respect to the magnetic field generation coil 10302 and for the motion of the magnetic field generating coil 10302 attached to the rotating drum.

From a combination of the signals detected by the four detection coils 10301, it is possible to derive not only x, y and z coordinate information of the magnetic field generator 10302 attached to the rotating drum, but also tilting information or rotating information may be derived, as indicated schematically in FIG. 103 with the bent arrows.

Alternatively, it is also possible to attach the support member 10300 to the rotatable drum and to provide the magnetic field generating coil 10302 fixed in space, that is to say attached to the static support.

As already mentioned above, the detection information may be used for calculating position information, and this position information may be indicative of a washing load or an operation mode of the washing machine which can thus be controlled with high accuracy.

Thus, the sensor measures deviations of a position of the rotating drum and a difference between the actual position characteristics and desired position characteristics. By taking this measure, it may be made possible to detect when the washing machine runs into an operation state which approaches a resonance condition. In such an undesired operation mode close to a resonance state in which resonance effects may disturb the function of the washing machine, the sensor signal may be used as a control signal for controlling, driving and regulating the washing machine so that the undesired operation mode may be prevented and the washing machine may be but brought back into a desired operation mode.

The coils 10301 and 10302 may be printed circuit board (PCB) coils.

Using the configuration of FIG. 103 it is possible to measure the position with a resolution of micrometers and less.

The coordinates of x and y may be detected based on a difference of the detection signals of the coils 10301. The said coordinate values may be detected based on an amplitude of the detection signals. The rotational information may further be derived from a combination of the detection signals.

For instance, the magnetic field generating coil 10302 may be driven with an alternating current supply, for instance having a frequency of 10 kHz. This frequency value may be modified or adjusted so as to bring the washing machine into a desired operation state.

Also the amplitude of the detection coil 10301 may be used as an adjustable signal. In such a configuration, a simple and thus cheap ADC may be used.

The frequency and the current amplitude of the AC coil 10302 may be used as fit parameters to adjust the sensor array.

FIG. 104 shows a wireless solution for a magnetic field source by providing a permanent magnetic element 10400. Again, the permanent magnet 10400 may be attached to the rotating drum of the washing machine. A static support of the washing machine may be connected to the substrate 10300 and to a plurality of (for instance nine) matrix-like arranged magnetic field detection coils 10301.

Thus, FIG. 104 shows a solution without wires connected to the emission coil 10302. For this purpose, the permanent magnet 10400 may be used.

FIG. 105 shows an alternative solution for a position sensor system for determining position information of a rotatable drum of a washing machine.

The static support 10300 comprises the four detection coils 10301 and a sender coil 10500. The coils 10301 are adapted as magnetic field detection coils for detecting the local magnetic field at their respective positions. The sender coil 10500 generates an electromagnetic field by being supplied with a current flowing there through.

The rotatable (see arrow) drum 10501 shown in FIG. 105 is provided with an LC oscillator 10502. The LC oscillator is a circuit comprising a coil, a capacitor and an ohmic resistance. Thus, when the LC oscillator 10502 is brought into the magnetic field generated by the sender coils 10500 and if the frequency of this magnetic field is not too far away from the resonance frequency of the LC oscillator circuit 10502, then the LC oscillator 10502 is capable of absorbing electromagnetic energy from the time dependent magnetic field generated by the sender coil 10500. In other words, the magnetic field generated by the sender coil 10500 is at least partially eliminated in a rotation state of the drum 10501 in which the LC oscillator 10502 is in close vicinity to the sender coil 10500.

The position-dependent partial elimination of the magnetic field can be detected by the magnetic field detectors 10301 and may be recalculated into a distance or position information indicative of the present position of the LC oscillator circuit 10502, and therefore of the oscillation state of the rotatable drum 10501 of the washing machine.

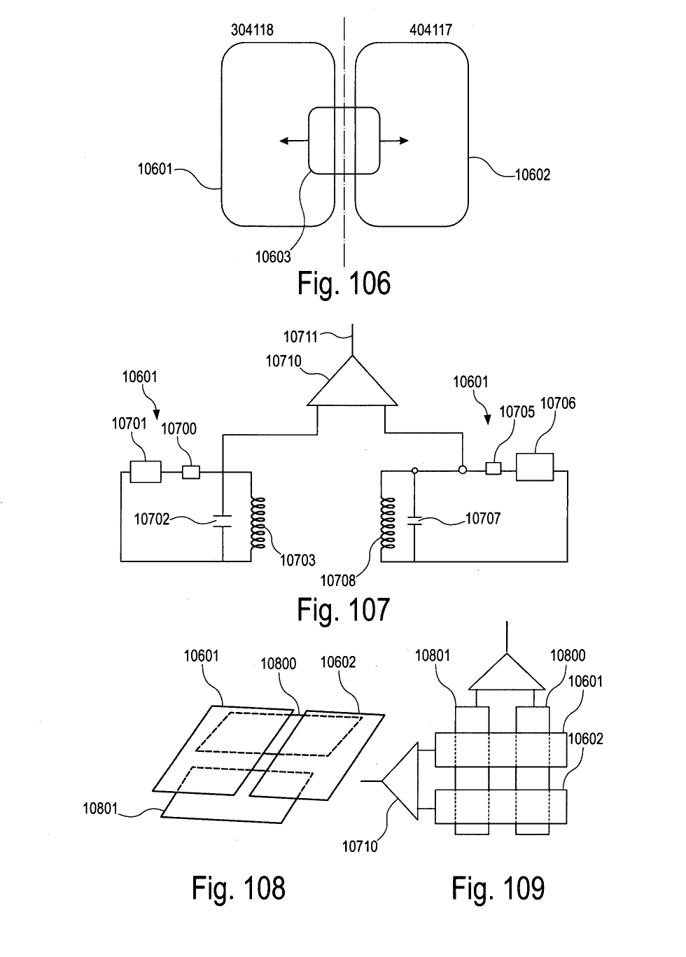

In the following, referring to FIG. 106, an alternative configuration will be explained.

In the configuration of FIG. 106, a first sender coil 10601 and a second sender coil 10602 are provided and are located close to one another. The first sender coil 10601 generates a magnetic field with a frequency of 30 kHz, and the second sender coil 10602 generates a magnetic field with a frequency of 40 kHz. The two frequencies of the coils 10601 and 10602 may thus be selected to be different.

A receiver coil 10603 as a magnetic field sink is attached to a rotatable drum of a washing machine (not shown in FIG. 106). When the rotatable drum moves which is indicated by arrows in FIG. 106, the receiver coil 10603 moves over the active magnetic fields of the coils 10601, 10602. Therefore, since the receiver coil 10603 is some kind of LC oscillator, it is capable of absorbing electromagnetic energy generated by one of the coils 10601 or 10602, and this electromagnetic energy is removed from the system which results in a modification of the magnetic field of the coils 10601, 10602, which can be detected. Therefore, by combining signals detected by the coils 10601 and 10602, the current position of the moving receiver coil 10603 may be evaluated. Thus, the coils 10601 and 10602 may also serve as detection coils.

Alternatively, separate detection coils may be implemented as well.

FIG. 107 shows a circuit diagram illustrating how a system similar to that of FIG. 106 may work.

The first sender coil 10601 comprises an ohmic resistance 10700, an oscillator 10701, a capacitor 10702 and an inductor 10703. Corresponding elements are foreseen in the second sender coil 10602. It comprises an ohmic resistor 10705, an oscillator 10706, a capacitance 10707 and an inductor 10708.

It is also possible to realize an embodiment in which both sender coils 10601 and 10602 are operated by a single common shared oscillator.

When the receiver coil 10603 (not shown in FIG. 107) passes an environment of the sender coils 10601, 10602, the receiver coil 10603 absorbs electromagnetic energy generated by the sender coils 10601 and/or 10602 which modifies the signals within the circuits 10601, 10602. These signals are compared by a comparator 10710 so that at an output of the comparator 10710 a detection signal 10711 may be provided which may be indicative of a present position of the receiver coil 10603.

Therefore, the receiver coil 10603 acts as a magnetic energy-consuming component.

FIG. 108 shows a further refinement of the described detection principle in which, in addition to the sender coils 10601 and 10602 provided in a first layer, further sender coils 10800, 10801 are arranged in a layer below the layer of components 10601, 10602. Further, the orientation of the coils 10800, 10801 is different, preferably perpendicular, to the orientation of the coils 10601, 10602.

FIG. 109 shows a plan view of such a configuration and shows that the coils 10601, 10602 and 10800, 10801 of a common plane provide signals which are compared by respective comparators 10710 to provide additional information about the position of a receiver coil 10603 which is not shown in FIG. 109.

As an alternative to the circuitry of FIG. 109, it is also possible to use a multiplexer for all or for a part of the four coils 10601, 10602, 10800, 10801 so as to operate the system with low current and low energy consumption. It is possible to use different or the same sending frequencies for the coils 10601, 10602, 10801, 10800.

It is also possible to use a plurality of receiver coils 10603.

Next, further exemplary embodiments of linear position sensors according to exemplary embodiments of the invention will be explained.

In the following, applications for absolute position sensors will be explained.

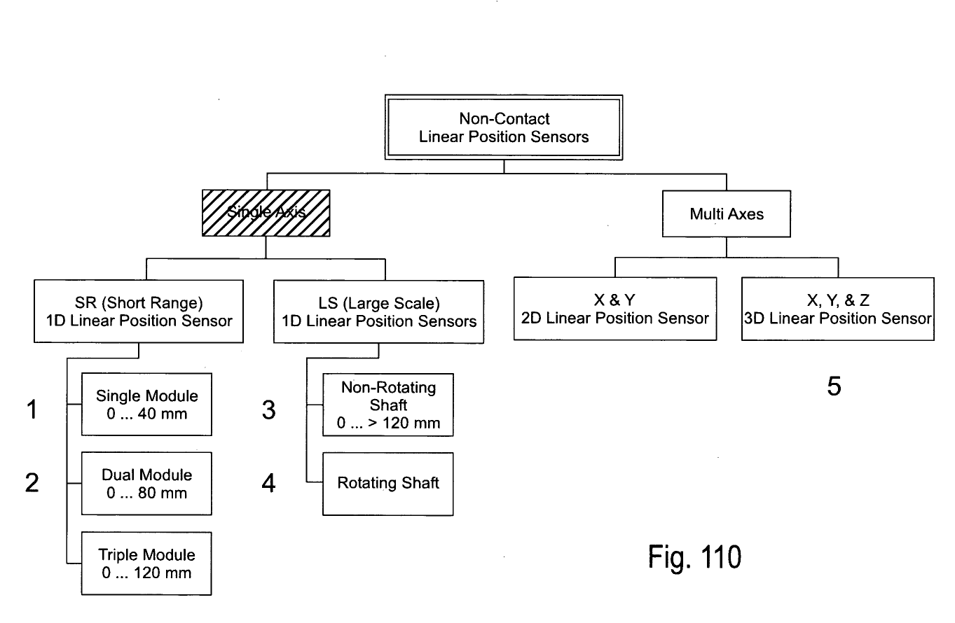

FIG. 110 illustrates different sensor types of a linear position sensor technology family.

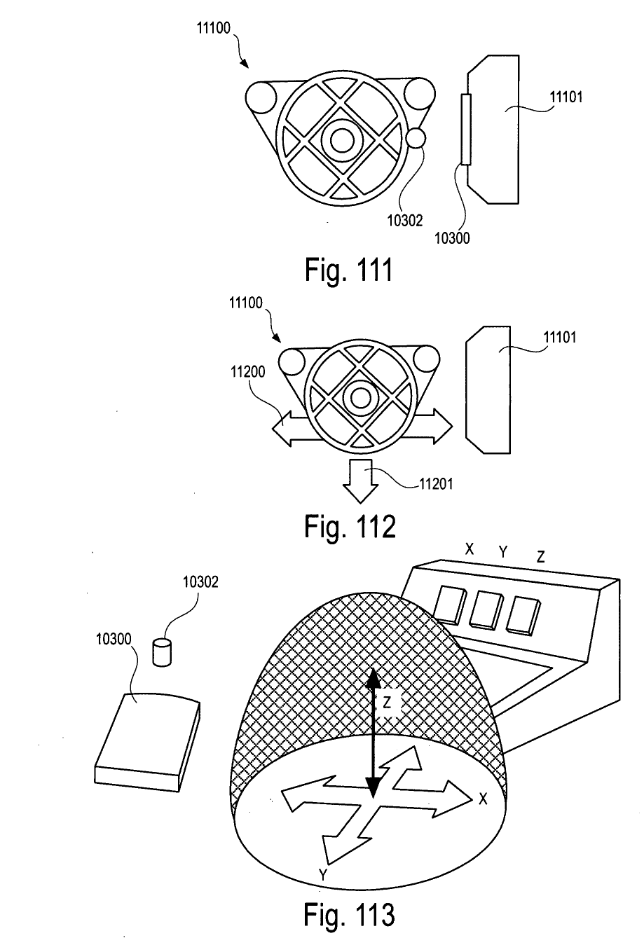

FIG. 111 to FIG. 113 illustrate a low cost 3D linear position sensor according to an exemplary embodiment of the invention.

Such a sensor device may be adapted as a non-contact 3-axis linear position sensor. The detection area may be 45×45×45 mm³. It may allow for a real time synchronous measurement. The signal resolution may be larger than 8 bits.

FIG. 111 illustrates an electric motor 11100 having a reference device 10302, and a motor control unit 11101 having a receiver pad 10300. The electric motor 11100 may be connected to a washing machine or may form a part thereof.

As can be taken from FIG. 112, movements 11200 of the electric motor 11100 may occur when the drum (of a washing machine) is spinning (that is to say an imbalance of the drum occurs), and movements 11201 of the electric motor 11100 may occur when the drum gets loaded (that is to say an increase of weight occurs).

FIG. 113 illustrates a sensor arrangement according to an exemplary embodiment of the invention.

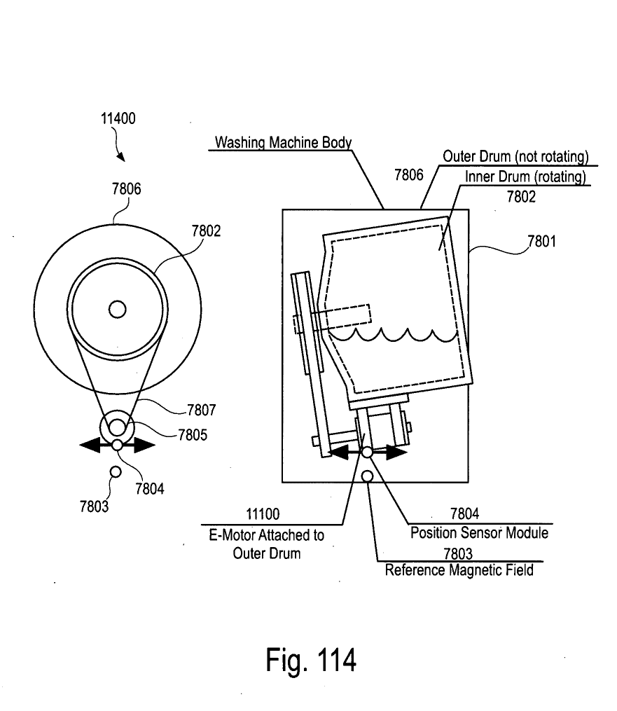

As an example for a field of application for sensor arrays according to an exemplary embodiment of the invention, a consumer washing machine 11400 is shown in FIG. 114. Reference is made to FIG. 78 and to FIG. 79.

FIG. 114 shows the electric motor 11100 attached to an outer drum 7806 (not rotating). Furthermore, an inner drum 7802 (rotating) is shown in FIG. 114. A reference magnetic field may be generated by a reference magnetic field generation unit 7803. A position sensor module 7804 may then be used to measure the position of the electric motor 1100 and/or of the drums 7806, 7802.

Such a system may be operated without real time control. Increased weight (for instance a concrete block) may be used to stabilize the mechanical process. However, increased costs for additional “non-consumer market” sensors may occur. Beyond this, increased complexity may occur through additional components.

However, the system can be operated with real time control. This may include a lower overall weight (lower manufacturing and transportation costs), higher performance, and lower overall costs.

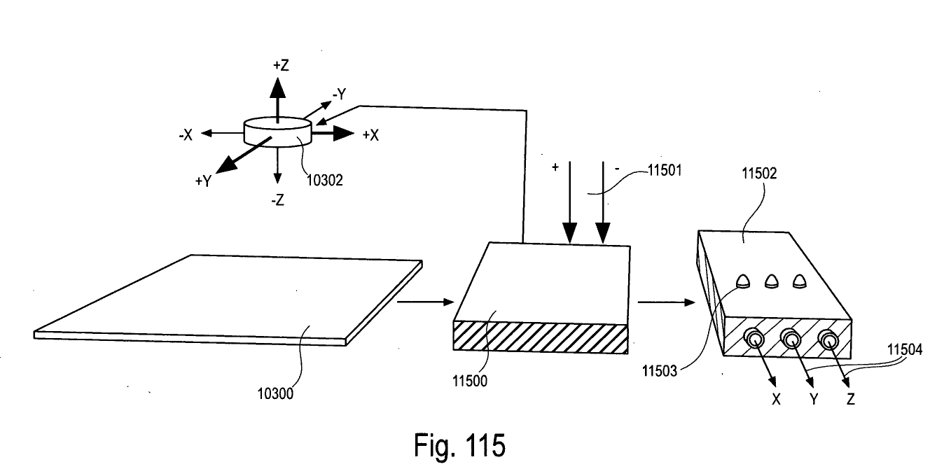

FIG. 115 illustrates system function modules.

Such modules include the reference device 10302, the receiver pad 10300, the SCSP electronics 11500, a single supply voltage 11501 and the user interface 11502. It is also possible that the receiver pad 10300, the electronics 11500, and the user interface 11502 are realized as one shared unit.

The user interface 11502 may be provided with function indicators 11503, and may include a data interface 11504 at which an analog output signal may be provided.

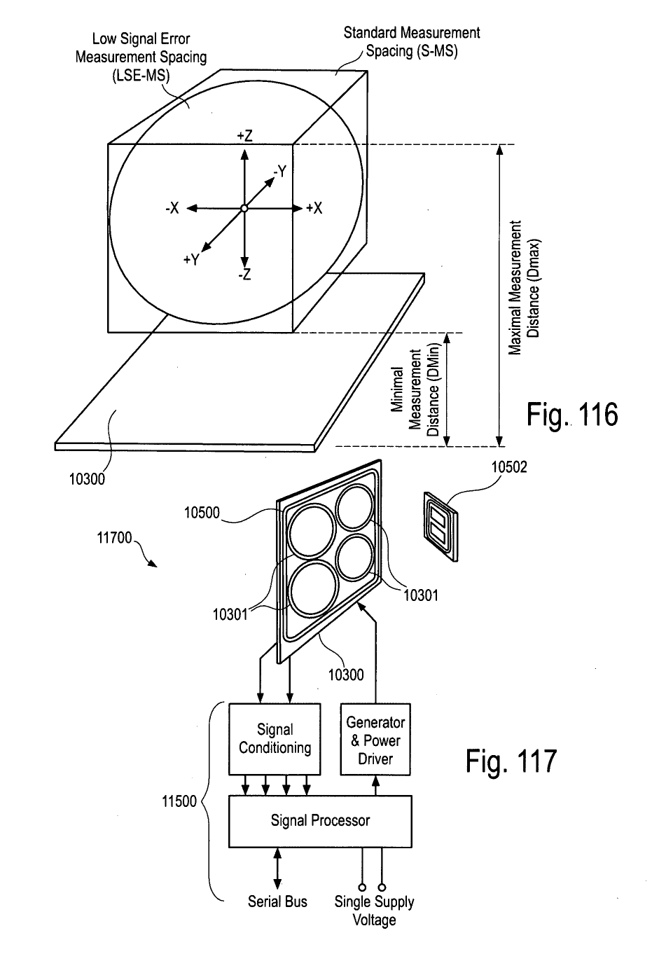

As can be taken from FIG. 116, different measurement ranges can be used. It is possible to implement the system as a standard resolution device or as a high-resolution device. The high-resolution measurement mode can be used when the washing machine is not active, so that a drum weight measurement (one axis mode) can be carried out. In a standard measurement mode when the washing machine is active, a drum position measurement (3 axis mode) can be carried out.

Next, further embodiments of a wireless absolute 3D linear position sensor according to exemplary embodiments of the invention will be explained.

FIG. 117 shows such a wireless 3D position sensor device 11700.

A transmitter and receiver pad 10300 may be positioned fixed in space and may generate, by the transmitter coil 10500, an electromagnetic field with a predetermined frequency. Detector coils 10301 may detect a magnetic signal at their respective positions. When a reference device 10502, which may be connected with a rotatable drum of the washing machine, moves and thus changes its relative position with respect to the detectors 10301 of the transmitter and receiver pad 10300, the magnetic field and thus the detected signals will be modified accordingly. The signals of the four detection coils 10301 may be used to detect the position of the reference device 10502 and thus of the rotatable drum of the washing machine with respect to the transmitter and receiver pad 10300.

An electronics 11500 may evaluate the detected signals and may derive position information from the detected signals.

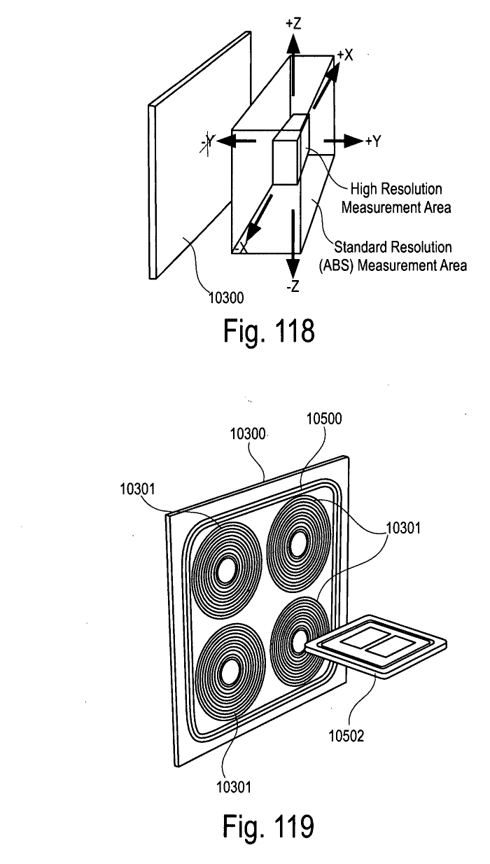

FIG. 118 shows the definition of the X, Y, Z coordinate system.

Again, two embodiments may be distinguished related to a high-resolution measurement area and to a standard resolution (ABS) measurement area.

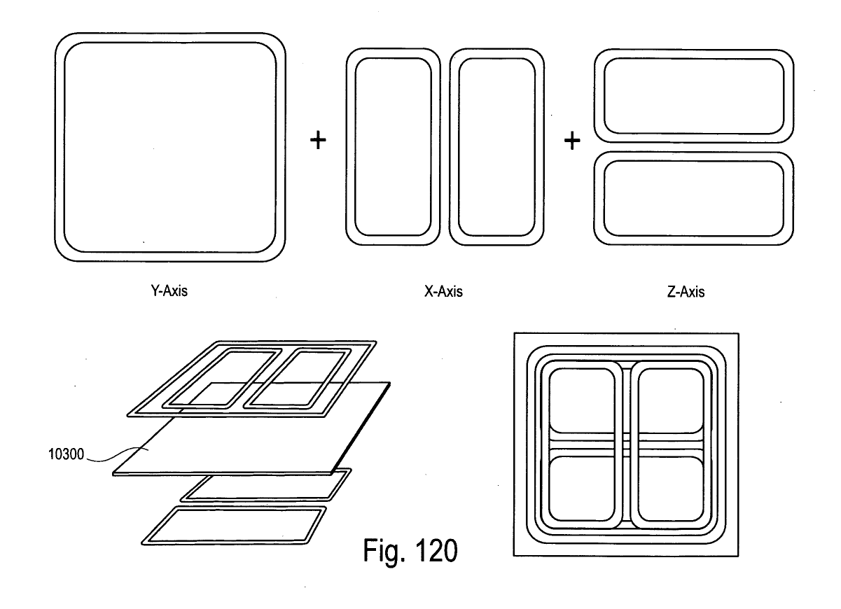

FIG. 119 again shows the main sensor of FIG. 117 having components which may be realized as printed circuit board (PCB) components.

The reference device 10502 shown in FIG. 117 and FIG. 19 is an LC oscillator circuit. This circuit may absorb the electromagnetic energy from the electromagnetic field generated by the generator coil 10500 of the transmitter and receiver pad 10300. However, particularly when high frequencies of for instance >100 kHz (more particularly in the range between 400 and 1000 kHz), are used, the LC oscillator circuit 10502 may also be substituted by a simple piece of metal (for instance made of aluminium) or may be substituted by a magnetic shielding coil. Such a configuration may allow for a cost efficient manufacture of the device, since a damping coil may be replaced by a simple metal piece or magnetic shielding foil. Such a metal piece may be a disc-like element, a ball-like element, a plate-like element, or may have any other geometry.

In the following, some advantageous features of the wireless absolute 3D sensor device according to an exemplary embodiment will be explained:

It allows for an absolute position measurement of three axis (x, y and z)
It allows for a very low component count, yielding a low design complexity
It can be used under harsh conditions (temperature range, environmental cleanness, vibration, etc.)
It has a very robust and user-friendly design: the two key measurement components may be realized as printed circuit boards
Most system features can be defined and influenced through software
A low electrical power consumption may be achieved
It is possible to have a high immunity to EMI as a closed loop, AC coupled sensing principle with differential mode signal processing may be used.

FIG. 120 illustrates a base design of a main sensing board layout.

As can be taken from FIG. 120, a multi-layer structure of electromagnetic field generation elements and electromagnetic field detection elements may be achieved.

Thus, a detection along an x-axis, a y-axis and a z-axis may be made possible with a planar device.

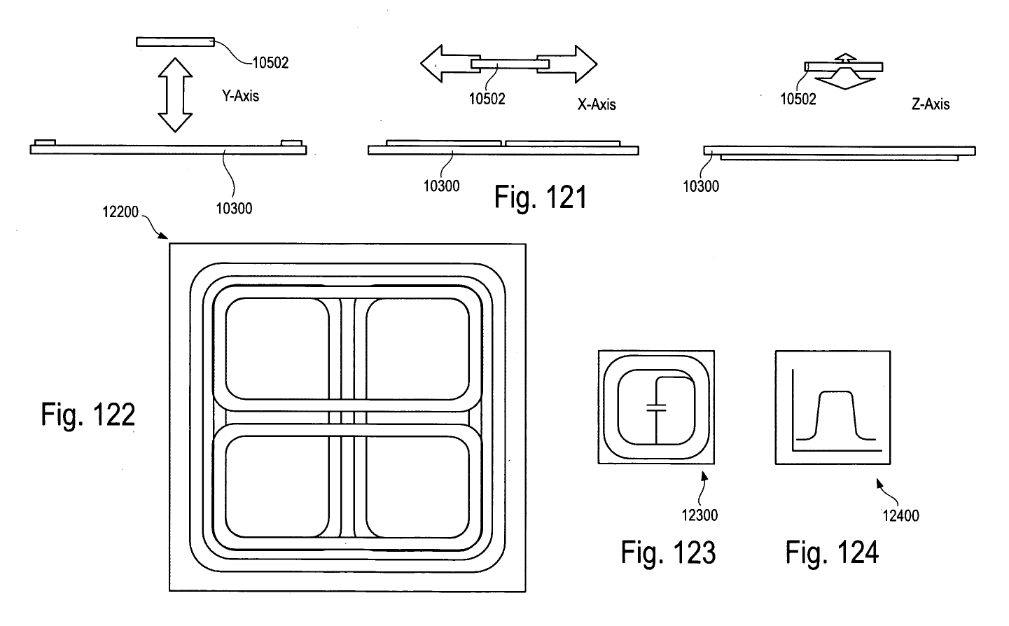

With respect to the 3D coordinates computation process, reference is made to FIG. 121.

The y-axis position may be mainly defined by signal amplitude modulation and then corrected/optimized when having finalized the computation of the x- and z-axis.

The x- and z-axis position may be defined through “differential” measurement, optimized by the y-axis value and final tuning through look-up tables (when needed).

A 3D sensor system centre position (during normal washing and spinning mode) may be defined by software (which may be denoted as a continuous self-calibration feature).

Most accurate may be the x- and z-axis measurements, referring to the coordinate system of FIG. 121.

FIG. 122 shows a fixed frequency wireless 3D position sensor device 12200 according to an exemplary embodiment of the invention.

Such a three axis measurement device 12200 may have sensing inductors as shown in FIG. 121 and which may be constructed in a similar manner as illustrated in FIG. 120.

FIG. 123 shows a fixed frequency load circuit 12300.

Thus, the embodiments of FIGS. 122 and 123 together may form a fixed frequency wireless 3D position sensor.

FIG. 124 shows a wide frequency band load circuit 12400 which may be used as well.

The embodiment of FIG. 122 and FIG. 124 together may be the basis of a frequency band wireless 3D position sensor.

With such embodiments, an improved sensor system performance may be obtained. Most measurements (x-, y- and z-axes) are essentially linear and may need a limited correction. All of the measured signals may be monotonic and repeatable.

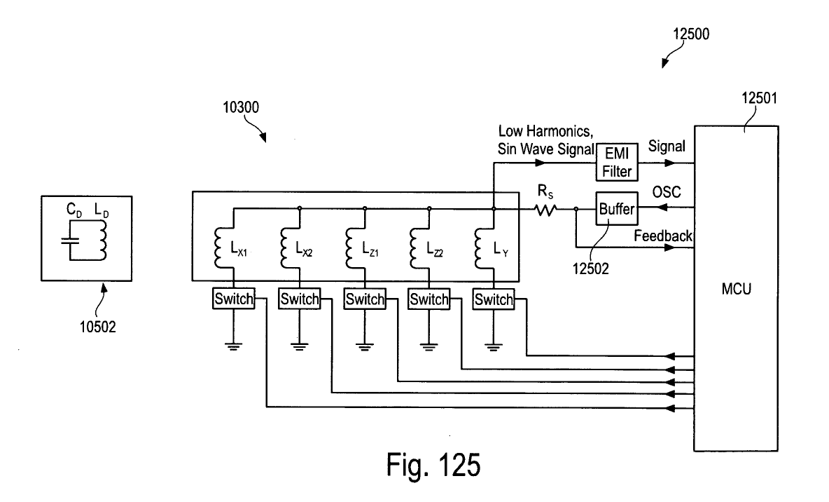

FIG. 125 shows a block diagram of a wireless 3D sensor system 12500 according to an exemplary embodiment of the invention.

The embodiment of FIG. 125 is a low signal frequency design, can be operated with a low component count, and allows for a maximum control through the implementation of software elements.

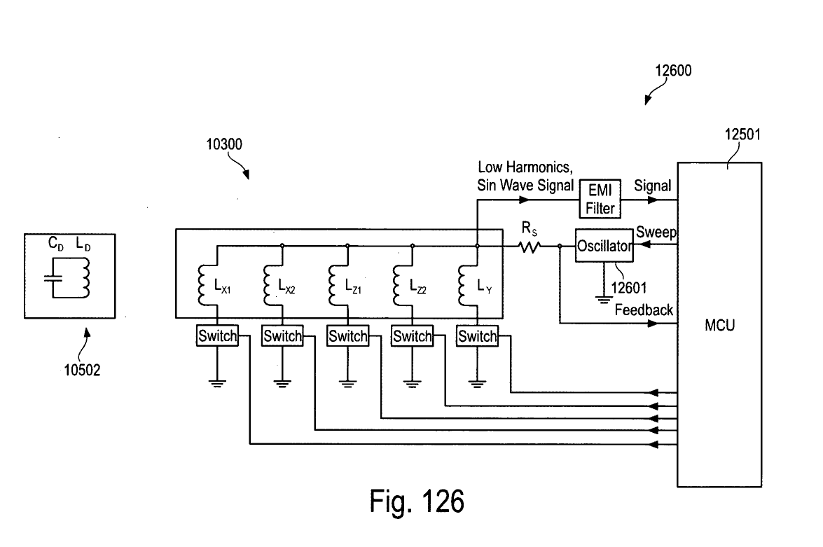

FIG. 126 shows another block diagram 12600 of a wireless 3D sensor system according to another exemplary embodiment of the invention.

The configuration of FIG. 126 is a high frequency design, and an automatic sensing pad temperature compensation is possible. It may further allow using slower MCU devices. A lower supply current consumption may be possible with the embodiment of FIG. 126.

FIG. 125 involves an oscillator signal OSC emitted by a microcontroller (MCU) 12501 and provided to a buffer unit 12502. An oscillator function is integrated in the MCU 12501 of FIG. 125. In contrast to this, in FIG. 126, a sweep signal is supplied from a MCU 12501 to a separate oscillator unit 12601 which then emits an oscillator signal.

It may happen that the temperature is modified during a measurement. In such a scenario, it may be advantageous to provide some kind of temperature compensation so as to further improve the accuracy and the robustness of the sensor system.

For instance, the software of the microcontroller unit 12501 of FIG. 125 or FIG. 126 may adapt the working frequency of the system in order to compensate for temperature effects (“frequency sweep”). For this purpose, referring to FIG. 125, the output signal OSC may be measured (for instance the amplitude thereof may be measured), and may be compared with a detection signal. Such a comparison may be taken as a basis for compensating temperature effects.

In FIG. 125, Rs is a measurement resistance and should be realized as an essentially temperature independent resistance.

FIG. 126 shows that the MCU 12501 emits a sweep signal and provides the latter to a separate oscillator unit 12601. In this case, the oscillator 12601 may be a voltage to frequency converter, that is to say the voltage value of the sweep signal may be taken as a basis to adjust the frequency of the system.

In the following, an output signal option will be explained.

Individual analog signals (x, y, z) are possible. Furthermore, multiplexed analog signals (x-y-z-x-y-z . . . ) are possible. A digital serial data stream is possible. A digital bus system (standard protocol) may be implemented. A digital bus system (custom protocol) may be implemented. Single digital movement threshold signals may be used. Furthermore, multi level digital movement threshold signals may be used.

Next, temperature stability control mechanisms will be explained.

With respect to a sensing pad, the signal gain (y-axis) may be considered. In this context, a frequency sweep at regular intervals for system self calibration may be performed. Furthermore, a signal gain (x- and z-axes) may be assumed, and a differential measurement may be carried out. Furthermore, the signal offset (x-, y- and z-axes) may be considered, and a software compensation may be implemented in such a context.

With regard to the reference device, it can be operated in a fixed frequency operation mode. This may be achieved through choosing the correct components. The reference device may also be operated in a frequency band type.

Referring to the microcontroller, a closed loop signal control design (allowing for software calibration) may be possible.

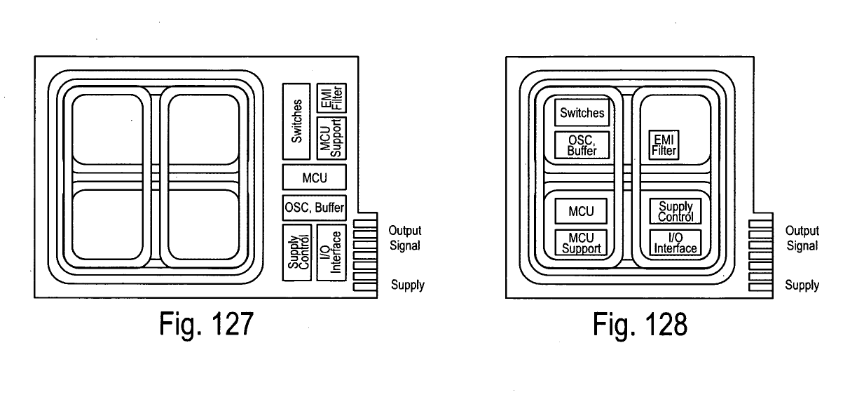

FIG. 127 and FIG. 128 show embodiments of the sensing pad and signal conditioning and signal processing electronics designs.

FIG. 127 shows an embodiment with a larger PCB board space, but improved signal-to-noise ratio.

The embodiment of FIG. 128 has a reduced PCB board space, but a potential need for additional amplification and filter components.

In the following, further aspects of reference device sensibility will be discussed.

The reference device may be provided as a fixed frequency reference device. It may operate at a low frequency, so that it is not sensitive to other metallic objects. It may also be operated at higher frequencies, which may allow for a reduced power consumption, a reduced board space, increased signal gain, and increased sensitivity to selective metallic materials.

It is also possible to implement the reference device as a frequency band reference device. In a high-frequency implementation, an increased sensitivity to selective metallic materials, very low cost design for a reference device, and an extreme robust design with very low failure rate may be possible.

Such a wireless absolute 3D sensor system can operate at frequencies ranging from audio frequencies up to >1 MHz. In a low frequency range, frequencies between 10 kHz and 100 kHz may be possible. A corresponding design can be optimized so that this sensor is completely insensitive to metallic objects near the 3D sensor. However, it should be prevented that there are metallic objects between the sensing pad and the reference device.

In the low frequency application, reference and sensing coils become larger and so the cost of the selected components as well.

In a high-frequency operation mode, with frequencies of 300 kHz and more, many system features may improve, including cost and required spacing. Furthermore, an increased sensitivity to metallic objects (static and dynamic) may occur.

A preferred range of operation frequencies is between 300 and 400 kHz.

It should be noted that the term “comprising” does not exclude other elements or steps and the “a” or “an” does not exclude a plurality. Also elements described in association with different embodiments may be combined.

1-34. (canceled)

35. A position sensor device for determining a position of a movable object, comprising:
a magnetic field source fixed on a movable object;
a first magnetic field detector located at a first position and detecting a first magnetic field signal characteristic for a magnetic field generated by the magnetic field source at the first position;
a second magnetic field detector located at a second position and detecting a second magnetic field signal characteristic for a magnetic field generated by the magnetic field source at the second position; and
a position determining unit determining a position of the magnetic field source based on a comparison of the first magnetic field signal and the second magnetic field signal.

36. The position sensor device according to claim 35, wherein the magnetic field source is a permanent magnetic element.

37. The position sensor device according to claim 35, wherein the magnetic field source is a coil being activatable by applying an electrical signal to the coil.

38. The position sensor device according to claim 37, wherein the coil is activatable by applying a continuous electrical signal to the coil.

39. The position sensor device according to claim 37, wherein the coil is activatable by applying one of an alternating and pulsed electrical signal to the coil.

40. The position sensor device according to claim 35, wherein the magnetic field source is a longitudinally magnetized region of the movable object.

41. The position sensor device according to claim 35, wherein the magnetic field source is a circumferentially magnetized region of the movable object.

42. The position sensor device according to claim 41, wherein the magnetic field source is formed by a first magnetic flow region oriented in a first direction and a second magnetic flow region oriented in a second direction, and wherein the first direction is opposite to the second direction.

43. The position sensor device according to claim 42, wherein, in a cross-sectional view of the movable object, there is (a) the first circular magnetic flow having the first direction and a first radius and (b) the second circular magnetic flow having the second direction and a second radius, and wherein the first radius is larger than the second radius.

44. The position sensor device according to claim 35, wherein the magnetic field source is manufactured in accordance with the following manufacturing steps:
applying a first current pulse to a magnetizable element in such a manner that there is a first current flow in a first direction along a longitudinal axis of the magnetizable element
wherein the first current pulse is such that the application of the current pulse generates the magnetic field source in the magnetizable element.

45. The position sensor device according to claim 44, wherein the manufacturing steps include
applying a second current pulse to the magnetizable element in such a manner that there is a second current flow in a second direction along the longitudinal axis of the magnetizable element.

46. The position sensor device according to claim 45, wherein each of the first and second current pulses has a raising edge and a falling edge and wherein the raising edge is steeper than the falling edge.

47. The position sensor device according to claim 45, wherein the first direction is opposite to the second direction.

48. The position sensor device according to claim 35, wherein at least one of the first magnetic field detector and the second magnetic field detector comprises at least one of the group consisting of: a coil; a Hall-effect probe; a Giant Magnetic Resonance magnetic field sensor; and a Magnetic Resonance magnetic field sensor.

49. The position sensor device according to claim 35, wherein the position determining unit determines a position of the magnetic field source based on a ratio of the first magnetic field signal and the second magnetic field signal.

50. The position sensor device according to claim 35, wherein the position determining unit determines a position of the magnetic field source based on a difference of the first magnetic field signal and the second magnetic field signal.

51. The position sensor device according to claim 35, wherein the magnetic field source is arranged essentially symmetrically between the first magnetic field detector and the second magnetic field detector.

52. The position sensor device according to claim 35, further comprising:
a third magnetic field detector located at a third position and detecting a third magnetic field signal characteristic for a magnetic field generated by the magnetic field source at the third position;
wherein the position determining unit determines the position of the magnetic field source based on the first magnetic field signal, the second magnetic field signal and the third magnetic field signal.

53. The position sensor device according to claim 52, wherein the magnetic field source is arranged essentially symmetrically and essentially in the center of gravity of the first magnetic field detector, the second magnetic field detector and the third magnetic field detector.

54. The position sensor device according to claim 52, wherein the first magnetic field detector, the second magnetic field detector, the third magnetic field detector and the magnetic field source are arranged in a plane.

55. The position sensor device according to claim 18, wherein the first magnetic field detector, the second magnetic field detector and the third magnetic field detector are arranged on the corners of an equilateral triangle.

56. The position sensor device according to claim 52, further comprising:
a forth magnetic field detector located at a forth position and detecting a forth magnetic field signal characteristic for a magnetic field generated by the magnetic field source at the forth position;
wherein the position determining unit determines the position of the magnetic field source based on the first magnetic field signal, the second magnetic field signal, the third magnetic field signal and the forth magnetic field signal.

57. The position sensor device according to claim 56, wherein the magnetic field source is arranged essentially symmetrically and essentially in the center of gravity of the first magnetic field detector, the second magnetic field detector, the third magnetic field detector and the forth magnetic field detector.

58. The position sensor device according to claim 56, wherein the first magnetic field detector, the second magnetic field detector, the third magnetic field detector, the forth magnetic field detector and the magnetic field source are arranged in a plane.

59. The position sensor device according to claim 56, wherein the first magnetic field detector, the second magnetic field detector, the third magnetic field detector and the forth magnetic field detector are arranged on the corners of a rectangle.

60. The position sensor device according to claim 56, wherein the magnetic field detectors and the magnetic field source are arranged in a non-planar manner.

61. The position sensor device according to claim 60, wherein the magnetic field detectors are arranged on corners of one of a tetrahedron and a cube.

62. The position sensor device according to claim 54, wherein the position determining unit determines the position of the magnetic field source based on (a) a difference of the magnetic field signals and (b) an amplitude of the magnetic field signals.

63. The position sensor device according to claim 58, wherein the position determining unit determines the position of the magnetic field source based on (a) a difference of the magnetic field signals and (b) an amplitude of the magnetic field signals.

64. The position sensor device according to claim 60, wherein the position determining unit determines the position of the magnetic field source only based on a difference of the magnetic field signals.

65. The position sensor device according to claim 35, further comprising:
a signal linearization unit generating a linear signal being characteristic for the position of the movable object based on a difference between the first magnetic field signal and the second magnetic field signal.

66. The position sensor device according to claim 35, further comprising:
a driver unit providing the magnetic field source with a driver signal for generating a magnetic field in accordance with the driver signal, the driver unit processing the first magnetic field signal and the second magnetic field signal in accordance with the driver signal.

67. The position sensor device according to claim 66, wherein the driver unit filters the first magnetic field signal and the second magnetic field signal in accordance with the driver signal.

68. The position sensor device according to claim 66, wherein the driver unit is a microprocessor.

69. The position sensor device according to claim 66, wherein the driver unit includes a computer program element.

70. The position sensor device according to claim 35, wherein the position sensor device is included in at least one of the group consisting of a washing machine, a tumble dryer, an automotive engine vibration detecting unit, an automotive suspension position detecting unit, an automotive light adjustment device, a bending measurement unit and a pressure measurement unit.

71. A position sensor array, comprising:
a movable object; and
a position sensor device determining a position of the movable object and including (a) a magnetic field source fixed on a movable object; (b) a first magnetic field detector located at a first position and detecting a first magnetic field signal characteristic for a magnetic field generated by the magnetic field source at the first position; (c) a second magnetic field detector located at a second position and detecting a second magnetic field signal characteristic for a magnetic field generated by the magnetic field source at the second position; and (d) a position determining unit determining a position of the magnetic field source based on a comparison of the first magnetic field signal and the second magnetic field signal.

72. A washing machine, comprising:
a static support;
a rotatable drum rotating with respect to the static support and receiving content to be washed; and
a position sensor device determining a position of the rotatable drum, the position sensor device including (a) a magnetic field source; (b) a magnetic field detector detecting a magnetic field signal characteristic for a magnetic field generated by the magnetic field source; (c) a position determining unit determining a position of the rotatable drum based on the magnetic field signal,
wherein one of the magnetic field source and the magnetic field detector is fixed on the static support and the other one of the magnetic field source and the magnetic field detector is fixed on the rotatable drum.

73. The washing machine according to claim 72, further comprising:
a control unit controlling an operation of the washing machine based on the position of the rotatable drum which is provided to the control unit by the position sensor device.

74. The washing machine according to claim 72, further comprising:
a processing arrangement determining, based on the determined position of the rotatable drum, a loading weight of content to be washed received by the rotatable drum.

75. The washing machine according to claim 73, wherein the magnetic field detector includes a plurality of spatially separated magnetic field detector units each adapted to detect a magnetic field signal characteristic for a magnetic field generated by the magnetic field source at a corresponding position of the respective magnetic field detector unit.

76. The washing machine according to claim 75, wherein the magnetic field detector includes four magnetic field detector units arranged at corners of a rectangle.

77. The washing machine according to claim 75, wherein the magnetic field detector comprises at least four magnetic field detector units arranged in a common plane.

78. The washing machine according to claim 75, wherein the magnetic field detector comprises nine magnetic field detector units arranged in a common plane.

79. The washing machine according to claim 73, wherein the magnetic field detector comprises at least one of the group consisting of: a coil; a Hall-effect probe; a Giant Magnetic Resonance magnetic field sensor; and a Magnetic Resonance magnetic field sensor.

80. The washing machine according to claim 73, wherein the magnetic field source is a coil being activatable by applying an electrical signal to the coil.

81. The washing machine according to claim 80, wherein the coil is activatable by applying a continuous electrical signal to the coil.

82. The washing machine according to claim 80, wherein the coil is activatable by applying one of an alternating and pulsed electrical signal to the coil.

83. The washing machine according to claim 75, wherein the magnetic field source is a permanent magnetic element.

84. A washing machine, comprising
a static support;
a rotatable drum rotating with respect to the static support and receiving content to be washed;
a position sensor device determining a position of the rotatable drum, the position sensor device including (a) a magnetic field source for generating a magnetic field; (b) a magnetic field sink; (c) a magnetic field detector detecting a magnetic field signal characteristic for a magnetic field generated by the magnetic field source and modified by the magnetic field sink; (d) a position determining unit determining a position of the rotatable drum based on the magnetic field signal;
wherein one of the magnetic field sink and the magnetic field detector is fixed on the static support and the other one of the magnetic field sink and the magnetic field detector is fixed on the rotatable drum.

85. The washing machine according to claim 84, wherein the magnetic field sink is an LC oscillator circuit.

86. The washing machine according to claim 84, wherein the magnetic field source is a coil being activatable by applying an electrical signal to the coil.

87. The washing machine according to claim 86, wherein the coil is activatable by applying an alternating electrical signal to the coil.

88. The washing machine according to claim 84, wherein the magnetic field source and the magnetic field detector are formed as a common element.

89. The washing machine according to claim 84, wherein the magnetic field source includes a plurality of magnetic field source units each adapted to generate an individual magnetic field.

90. The washing machine according to claim 84, wherein the magnetic field detector comprises a plurality of magnetic field detector units each adapted to detect an individual magnetic field signal.

91. The washing machine according to claim 90, wherein the position determining unit determines the position of the rotatable drum based on the individual magnetic field signals.

92. A method for determining a position of a movable object, comprising:
detecting a first magnetic field signal characteristic for a magnetic field at a first position generated by a magnetic field source to be fixed on the movable object;
detecting a second magnetic field signal characteristic for a magnetic field at a second position generated by the magnetic field source; and
determining a position of the magnetic field source based on a comparison of the first magnetic field signal and the second magnetic field signal.

93. A sensor arrangement, comprising:
a substrate;
a plurality of position sensor devices arranged on the substrate,
wherein each of the position sensor devices includes (a) a magnetic field source fixed on a movable object; (b) a first magnetic field detector located at a first position and detecting a first magnetic field signal characteristic for a magnetic field generated by the magnetic field source at the first position; (c) a second magnetic field detector located at a second position and detecting a second magnetic field signal characteristic for a magnetic field generated by the magnetic field source at the second position; and (c) a position determining unit determining a position of the magnetic field source based on a comparison of the first magnetic field signal and the second magnetic field signal.

94. The sensor arrangement according to claim 93, wherein the sensor detects a spatial pattern of at least one of a pressure and bending load applied to the plurality of position sensor devices.

95. The sensor arrangement according to claim 93, wherein the sensor is a crash test sensor arrangement.
